(19) United States
(12) Patent Application Publication
(10) Pub. No.: US 2021/0132519 A1
(43) Pub. Date: May 6, 2021

(54) TONER

(71) Applicant: CANON KABUSHIKI KAISHA, Tokyo (JP)

(72) Inventors: Akira Hashimoto, Tokyo (JP); Takeshi Yamamoto, Tokyo (JP); Ryuji Higashi, Tokyo (JP); Takayuki Toyoda, Tokyo (JP); Maki Okajima, Tokyo (JP); Akiko Kitao, Tokyo (JP); Koichi Suzuki, Tokyo (JP)

(21) Appl. No.: 17/139,734

(22) Filed: Dec. 31, 2020

Related U.S. Application Data
(63) Continuation of application No. PCT/JP2019/027098, filed on Jul. 9, 2019.

(30) Foreign Application Priority Data
Jul. 10, 2018 (JP) 2018-131062
Jul. 10, 2018 (JP) 2018-131063

(51) Int. Cl. G03G 9/093; G03G 9/087; G03G 9/08

(52) U.S. Cl. CPC G03G 9/09392; G03G 9/08711; G03G 9/09321; G03G 9/0819; G03G 9/09385; G03G 9/08755; G03G 9/0812; G03G 9/09342

(57) ABSTRACT

A toner includes a toner particle containing a binder resin and an inorganic infrared absorbent particle, wherein (1) in spectrometry of a fixed image obtained by fixing an unfixed image formed on a recording material by using the toner in a loading amount of 0.30 mg/cm², a maximum value of a light absorbance in a wavelength range of 400 nm or more and 800 nm or less is 10% or less, and (2) in cross section observation of the toner particle using a transmission electron microscope, when a circle having the center of gravity of a cross section image of the toner particle as the center thereof and having a radius of 2.0 μm is drawn and the circle is divided into four to form four quadrants, a coefficient of variation in number of the inorganic infrared absorbent particles observed in each quadrant is 0.50 or less.

### CROSS-REFERENCE TO RELATED APPLICATIONS

This application is a Continuation of International Patent Application No. PCT/JP2019/027098, filed Jul. 9, 2019, which claims the benefit of Japanese Patent Application No. 2018-131062, filed Jul. 10, 2018, and Japanese Patent Application No. 2018-131063, filed Jul. 10, 2018, all of which are hereby incorporated by reference herein in their entirety.

### BACKGROUND OF THE INVENTION

### Field of the Invention

The present invention relates to a toner for developing an electrostatic image used in image formation methods such as electrophotography and electrostatic printing.

### Description of the Related Art

Recently, a technology for embedding additional information as an invisible image in a visible image has been spotlighted. The invisible image does not deteriorate an appearance even when superimposed on the visible image, that is, the invisible image can be used in combination with embedded information while maintaining quality of a general printed matter. Therefore, the invisible image is expected to be applied in various fields including a security field.

Various toners are proposed as an invisible toner for forming the invisible image.

In Japanese Patent Application Laid-Open No. 2000-309736, an ink using indium tin oxide (ITO) is produced.

In Japanese Patent Application Laid-Open No. 2006-078888, an invisible toner containing an infrared absorbent and an antioxidant is disclosed, and it is described that diimmonium is used as the infrared absorbent.

In Japanese Patent Application Laid-Open No. H10-39535, a near-infrared absorption pigment-containing toner containing ITO or the like is described as a so-called flash fixing toner.

In Japanese Patent Application Laid-Open No. 2005-233990, an invisible toner containing an organic infrared absorbent and an inorganic infrared absorbent is disclosed. In Japanese Patent Application Laid-Open No. 2005-233990, an invisible toner containing a fluorinated phthalocyanine or immonium-based compound as the organic infrared absorbent, and containing ytterbium oxide or tin-doped indium oxide as the inorganic infrared absorbent is described as an Example. In addition, in Japanese Patent Application Laid-Open No. 2005-233990, an invisible toner containing only tin-doped indium oxide as the infrared absorbent is described as a Comparative Example.

In Japanese Patent Application Laid-Open No. 2009-251414, an image formation method using a fixing helping particle is disclosed, and a resin fine particle containing tin-doped indium oxide as the fixing helping particle and having a submicron-sized particle diameter is described.

In Japanese Patent Application Laid-Open No. 2003-186238, an invisible toner having an inorganic infrared absorbent of which a dispersion diameter in the toner is defined is disclosed, and it is described that copper phosphoric acid crystallized glass is used as an infrared absorbent.

In Japanese Patent Application Laid-Open No. 2006-079020, an invisible toner containing goethite as an infrared absorbent is disclosed.

In Japanese Patent Application Laid-Open No. 2010-102325, an invisible toner containing gallium-doped zinc oxide as an infrared absorbent is disclosed.

In Japanese Patent Application Laid-Open No. 2011-503274, it is disclosed that an ink toner containing tungsten oxide and/or tungstate as an infrared absorbent is used in a fixing step.

The invisible toner described in Japanese Patent Application Laid-Open No. 2006-078888 exhibits a slight green color under visible light (wavelength: 400 m to 700 nm), and an image thereof can be recognized with the naked eye. Therefore, the use of the invisible toner for security purposes is limited. In addition, the organic infrared absorbent is likely to be deteriorated, and even when the antioxidant is contained, an infrared absorption capacity may be deteriorated in a case where an image is stored for a long period of time.

The invisible toner containing the organic infrared absorbent described in Japanese Patent Application Laid-Open No. 2005-233990 as an Example is also slightly colored under visible light, and an image thereof can be recognized with the naked eye. Therefore, the use of the invisible toner for security purposes is limited. In addition, the invisible toner containing a large amount of the tin-doped indium oxide described as Comparative Example 2 has an insufficient infrared absorption capacity as described. Furthermore, the invisible toner described as Comparative Example 2 is a toner produced by a pulverization method, and is a toner in which tin-doped indium oxide particles having an average dispersion diameter of 1.0 μm are exposed to a pulverized interface, that is, a toner surface. The tin-doped indium oxide is a substance having an extremely low volume resistivity. When such tin-doped indium oxide particles having an extremely low volume resistivity are exposed to the toner surface in a wide range, it is difficult to preferably maintain charge of the toner, developability or transferability is deteriorated, and it is difficult to form a fine image.

The fixing helping particle containing the tin-doped indium oxide particles described in Japanese Patent Application Laid-Open No. 2009-251414 also has an insufficient infrared absorption capacity. According to the studies conducted by the present inventors, the cause is that dispersibility of the tin-doped indium oxide particles in the fixing helping particle is poor. In addition, the fixing helping particle described in Japanese Patent Application Laid-Open No. 2009-251414 is a particle having a surface to which the tin-doped indium oxide particles are exposed in a wide range. In a case where the fixing helping particle is used as a toner, it is difficult to preferably maintain charge, developability or transferability is deteriorated, and it is difficult to form a fine image.

The invisible toner described in Japanese Patent Application Laid-Open No. 2003-186238 or Japanese Patent Application Laid-Open No. 2006-079020 is colored under visible light, and an image thereof can thus be recognized with the naked eye. Therefore, the use of the invisible toner for security purposes is limited. In addition, a relationship between a coefficient of variation in number of inorganic infrared absorbent particles in the toner and quality of an image formed using the toner is not mentioned in these patent literatures.

The invisible toner containing the gallium-doped zinc oxide described in Japanese Patent Application Laid-Open No. 2010-102325 also has an insufficient infrared absorption capacity. In addition, a relationship between a coefficient of variation in number of inorganic infrared absorbent particles in the toner and quality of an image formed using the toner is not mentioned.

In the claims of Japanese Patent Application Laid-Open No. 2011-503274, an ink toner containing a tungsten-based infrared absorbent is described, but there is no specific description in Examples and details are unclear. Therefore, it is also unclear whether the ink toner is invisible. Furthermore, the coefficient of variation in number of the tungsten-based infrared absorbent in the ink toner is also unclear.

### SUMMARY OF THE INVENTION

Therefore, an object of the present invention is to provide a toner which is invisible under visible light and can form a high-definition image recognizable when irradiated with infrared rays.

The present invention is a toner including a toner particle containing a binder resin and an inorganic infrared absorbent particle,

in which (1) in spectrometry of an image formed by using the toner in a loading amount of 0.30 mg/cm², a maximum value of a light absorbance in a wavelength range of 400 nm or more and 800 nm or less is 10% or less, and
(2) in cross section observation of the toner particle using a transmission electron microscope, when a circle having the center of gravity of a cross section image of the toner particle as the center thereof and having a radius of 2.0 μm is drawn and the circle is divided into four to form four quadrants, a coefficient of variation in number of the inorganic infrared absorbent particles observed in each quadrant is 0.50 or less.

Further features of the present invention will become apparent from the following description of exemplary embodiments with reference to the attached drawings.

### BRIEF DESCRIPTION OF THE DRAWINGS

FIG. 1 is a schematic view illustrating a cross section image of a toner particle for describing a calculation method of a coefficient of variation in the present invention.

FIG. 2 is a schematic cross-sectional view of a heat spheroidizing treatment apparatus used in production of a toner according to the present invention.

FIG. 3 is a schematic view illustrating a status of image observation in Evaluation Example 1.

### DESCRIPTION OF THE EMBODIMENTS

Hereinafter, a toner according to the present invention will be described in detail.

The toner according to the present invention contains a binder resin and an inorganic infrared absorbent particle.

The binder resin contained in the toner according to the present invention is not particularly limited, and can be used as a binder resin as long as it is a resin that is generally used in a toner. Specifically, examples of the binder resin can include a styrene acrylic resin, a polyester resin, and an epoxy resin, and these binder resins can be used alone or as a mixture. In addition, the binder resin used in the present invention may be any one of a resin having a linear molecular structure, a resin having a branched molecular structure, and a resin having a crosslinked molecular structure, or may be a mixture thereof.

The inorganic infrared absorbent particle is a stable material having extremely small deterioration over time. In addition, the inorganic infrared absorbent particle has a high transmittance of visible light as compared to that of an organic infrared absorbent, and is a material suitable for security purposes.

The inorganic infrared absorbent particle contained in the toner according to the present invention is not particularly limited, and examples thereof can include the following: an indium-based oxide particle such as an indium oxide particle or a tin-doped indium oxide particle, a tin-based oxide particle such as a tin oxide particle, an indium-doped tin oxide particle, an aluminum-doped tin oxide particle, or an antimony-doped tin oxide particle, a tungsten-based oxide particle such as a tungsten oxide particle, a cesium-doped tungsten oxide particle, a rubidium-doped tungsten oxide particle, or a barium-doped tungsten oxide particle, a zinc-based oxide particle such as a zinc oxide particle, a tin-doped zinc oxide particle, an indium-doped zinc oxide particle, an aluminum-doped zinc oxide particle, a gallium-doped zinc oxide particle, or a silicon-doped zinc oxide particle, an antimony-based oxide particle such as an antimony oxide particle or a tin-doped antimony oxide particle, a titanium-based oxide particle such as a niobium-doped titanium oxide particle, a hafnium oxide particle, a zirconium oxide particle, a molybdenum oxide particle, an ytterbium oxide particle, a cerium oxide particle, a dysprosium oxide particle, a gadolinium oxide particle, a niobium oxide particle, an ytterbium phosphate particle, a lanthanum oxide particle, a samarium oxide particle, a lanthanum hexaboride particle, and the like. These inorganic infrared absorbent particles can be used alone or as a mixture.

Among the exemplified inorganic infrared absorbent particles, one or more particles selected from the group consisting of the indium-based oxide particle, the tin-based oxide particle, and the tungsten-based oxide particle are preferably used due to its excellent balance between visible light transparency and an infrared absorption capacity.

The tin-doped indium oxide particle (ITO) is particularly preferably used as the indium-based oxide particle. The antimony-doped tin oxide particle (ATO) is particularly preferably used as the tin-based oxide particle. The cesium-doped tungsten oxide particle is particularly preferably used as the tungsten-based oxide particle.

Tin-doped indium oxide is a mixture of indium oxide and tin oxide, and is a stable inorganic material having a high transmittance of visible light and extremely small deterioration over time. A molar ratio of indium to tin is preferably in a range of 95:5 to 70:30, indium and tin being contained in the tin-doped indium oxide particle used in the present invention. Within this range, transparency and an infrared absorption capacity are particularly preferable.

Antimony-doped tin oxide is a mixture of tin oxide and antimony oxide, and is a stable inorganic material having a high transmittance of visible light and extremely small deterioration over time. A molar ratio of tin to antimony is preferably in a range of 95:5 to 70:30, tin and antimony being contained in the antimony-doped tin oxide particle used in the present invention. Within this range, transparency and an infrared absorption capacity are particularly preferable.

Cesium-doped tungsten oxide is a mixture of cesium oxide and tungsten oxide, and is a stable inorganic material which is slightly bluish and has extremely small deterioration over time. A molar ratio of tungsten to cesium is preferably in a range of 90:10 to 60:40, tungsten and cesium being contained in the cesium-doped tungsten oxide particle used in the present invention. Within this range, transparency and an infrared absorption capacity are particularly preferable.

It is preferable that the inorganic infrared absorbent particle is subjected to a surface treatment. A copolymer having a repeating unit represented by the following Formula 1 and a repeating unit represented by the following Formula 2 or a repeating unit represented by the following Formula 3 is preferably used as a surface treatment agent. The copolymer may have a repeating unit other than the repeating units represented by the following Formulas 1 to 3.

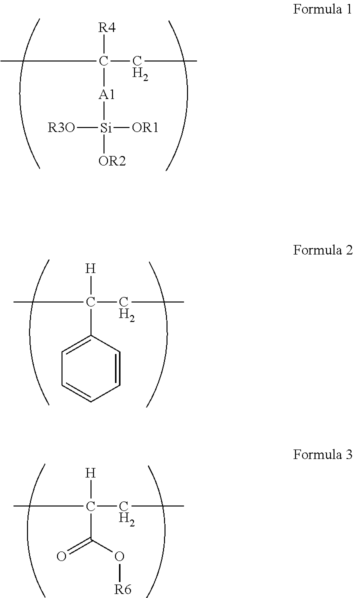

(In Formulas 1 and 3,

R1 to R3 each independently represent a hydrogen atom or an aliphatic straight chain hydrocarbon group having 1 to 4 carbon atoms,
R4 and R5 each independently represent a hydrogen atom or a methyl group,
R6 represents an aliphatic straight chain hydrocarbon group having 1 to 4 carbon atoms, and
A1 represents a structure of the following Formula 4 or 5,

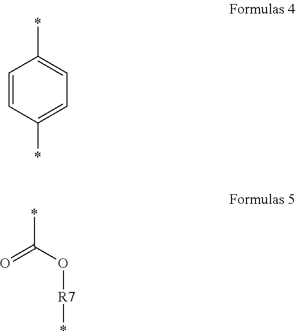

### in Formulas 4 and 5,

R7 represents an aliphatic straight chain hydrocarbon group having 1 to 4 carbon atoms, and
* represents a binding site.)

Each of R1 to R3 in Formula 1 is preferably a methyl group from the viewpoint of reactivity. In addition, in a case where A1 in Formula 1 represents the structure of Formula 4, R4 is preferably a hydrogen atom from the viewpoint of enhancing stability of a main chain structure.

In the copolymer, a composition ratio (molar ratio) of the repeating unit of Formula 1 to the repeating unit of Formula 2 or 3 is preferably 0.1:10.0 to 10.0:10.0 and more preferably 2.0:10.0 to 4.0:10.0. When the composition ratio is within the above ranges, dispersibility or hydrophilicity of the inorganic infrared absorbent particle becomes appropriate.

Specific examples of a combination of the repeating units included in the copolymer are presented below. Although two repeating units connected to each other are described, the two repeating units are only simply described, and the description of the two repeating units does not mean that the two repeating units are always repeated in a connected state.

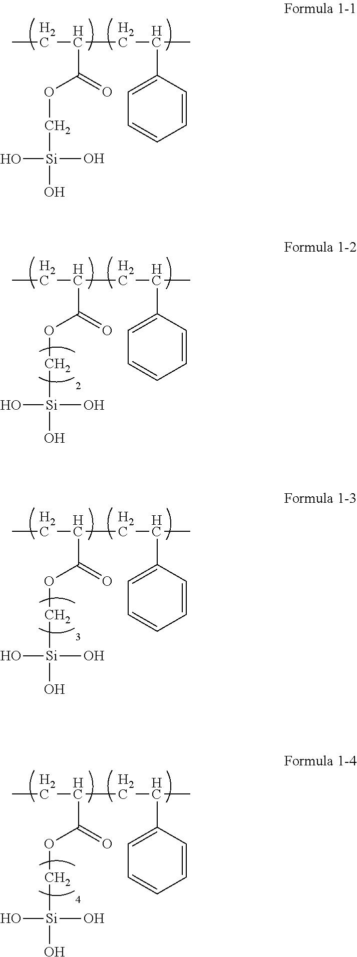

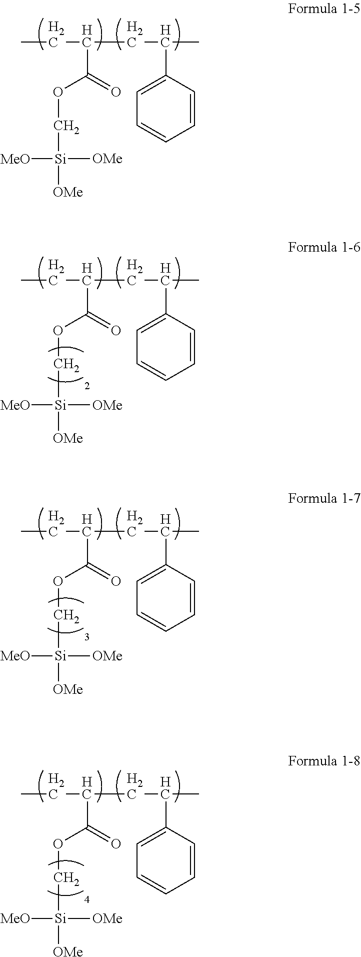

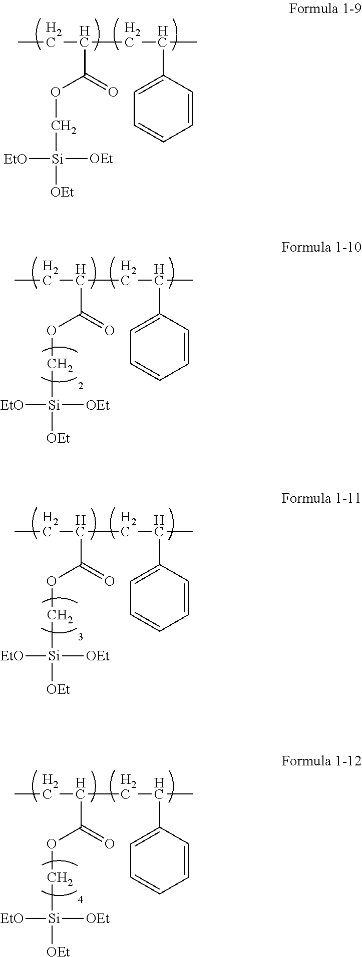

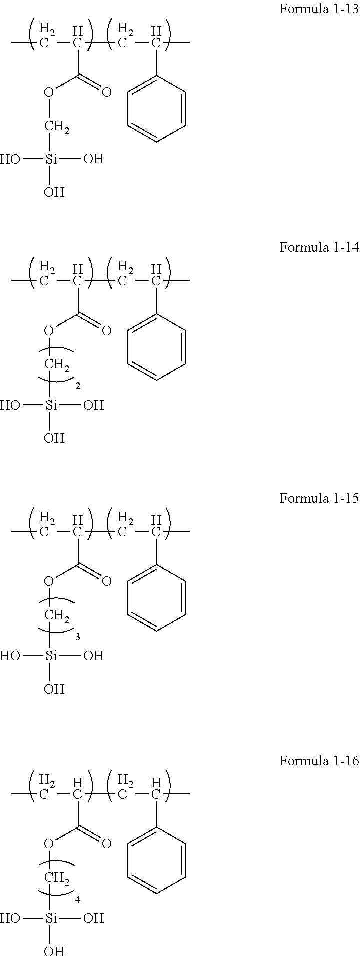

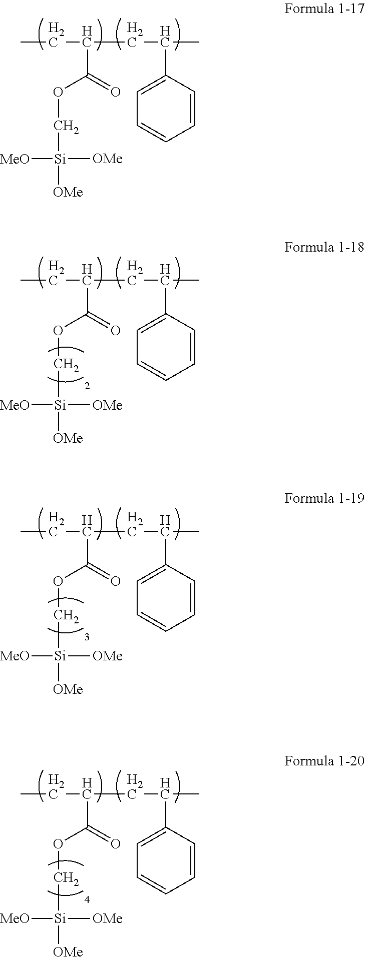

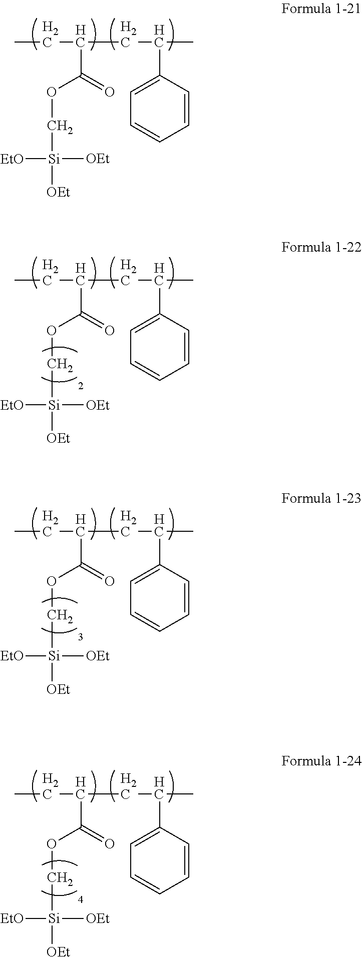

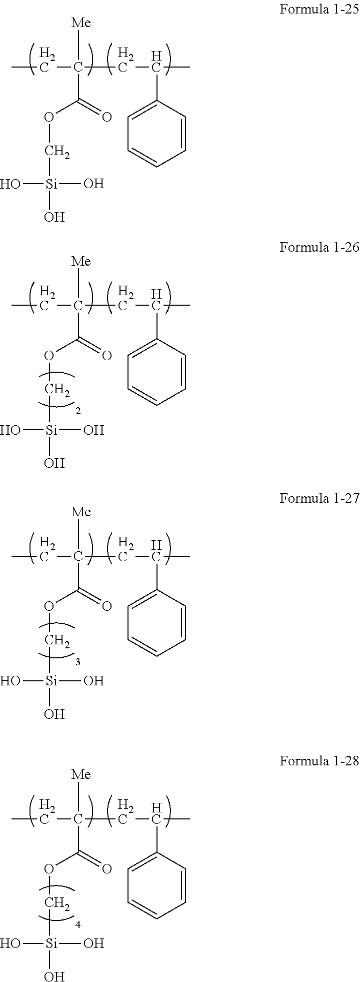

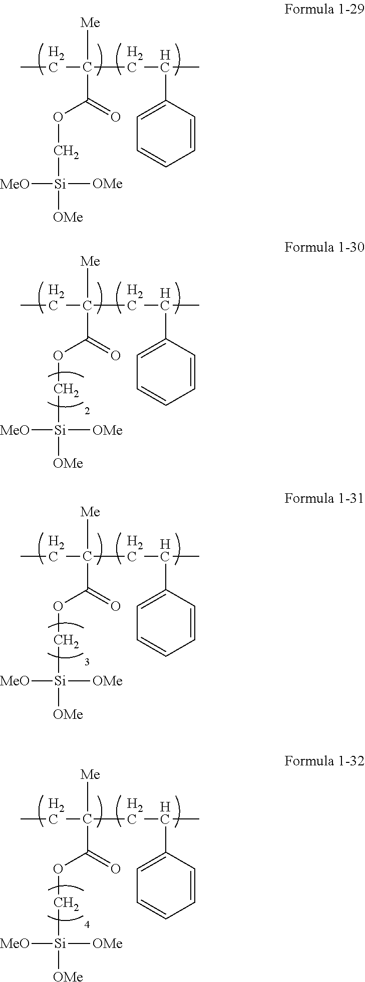

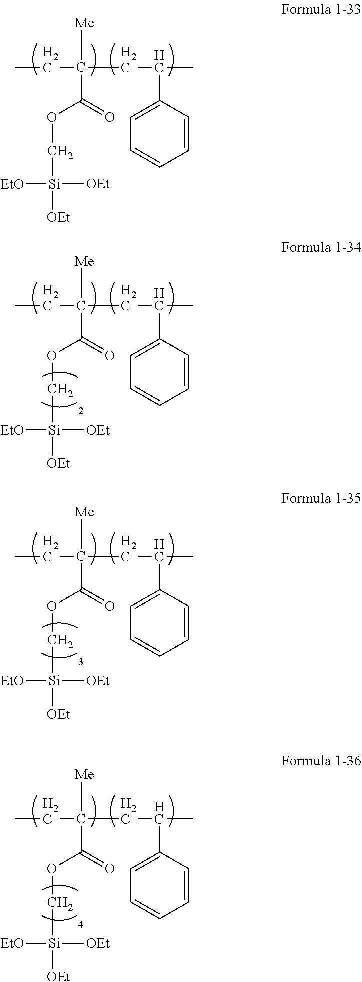

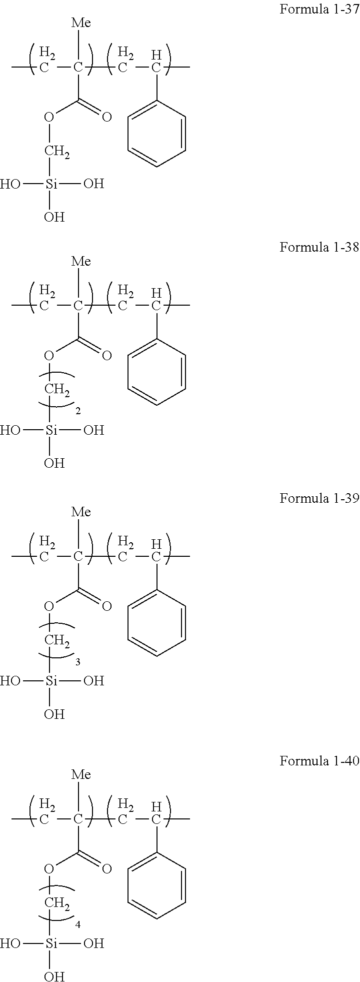

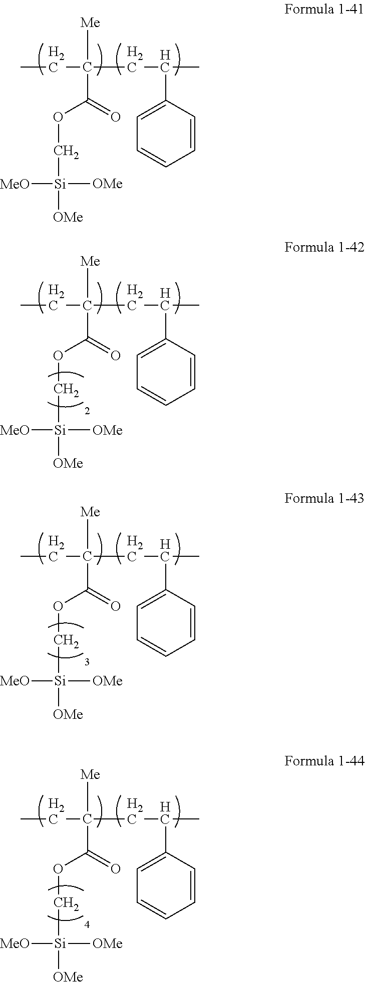

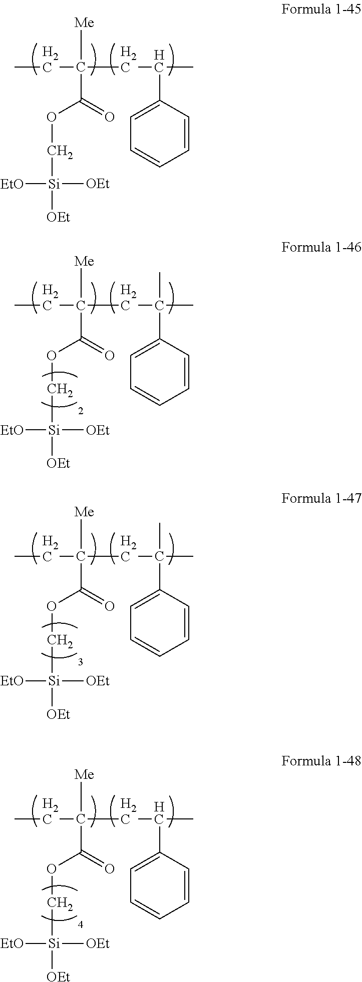

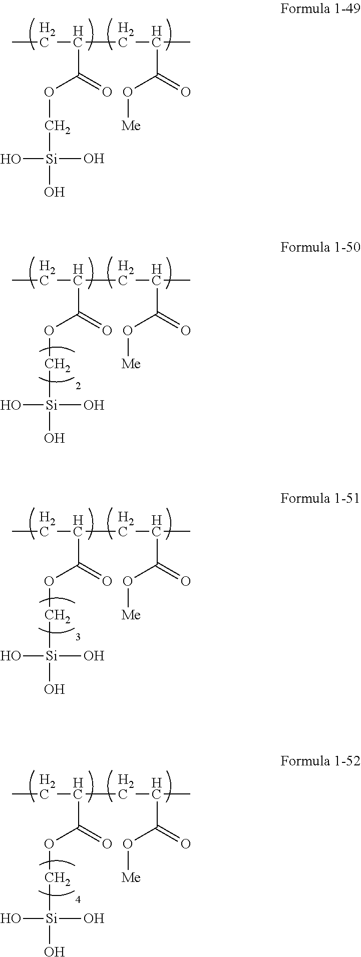

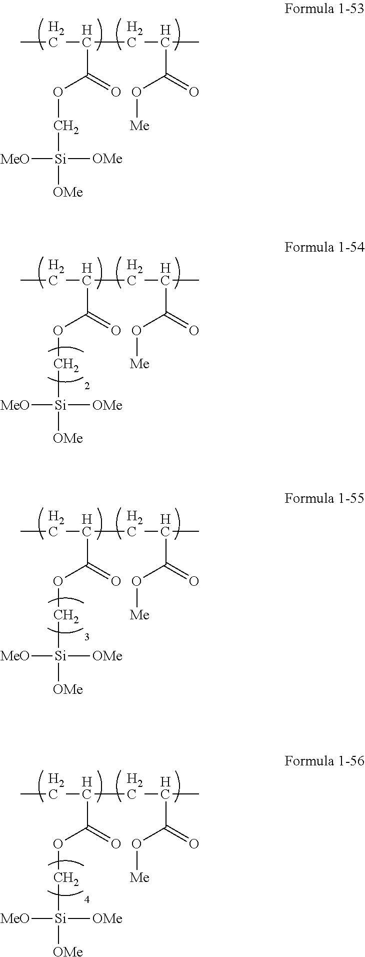

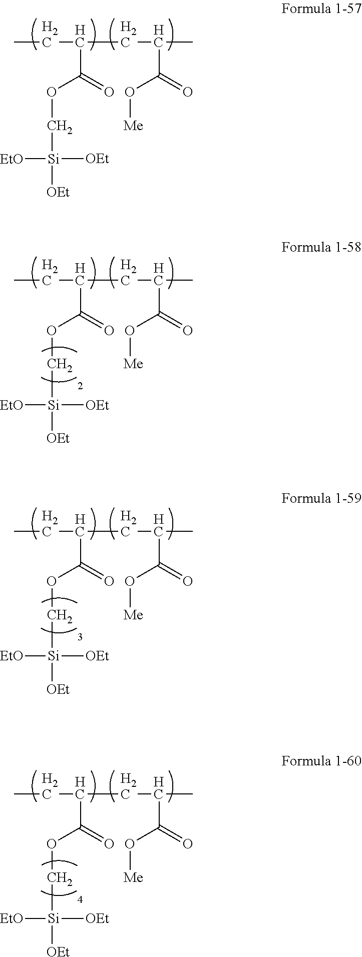

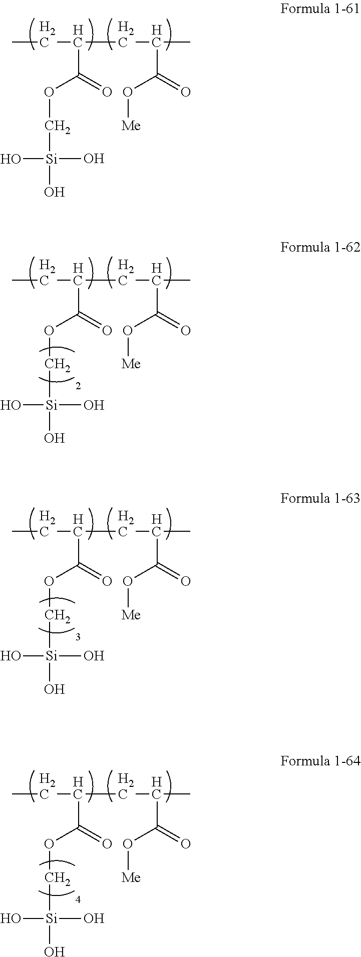

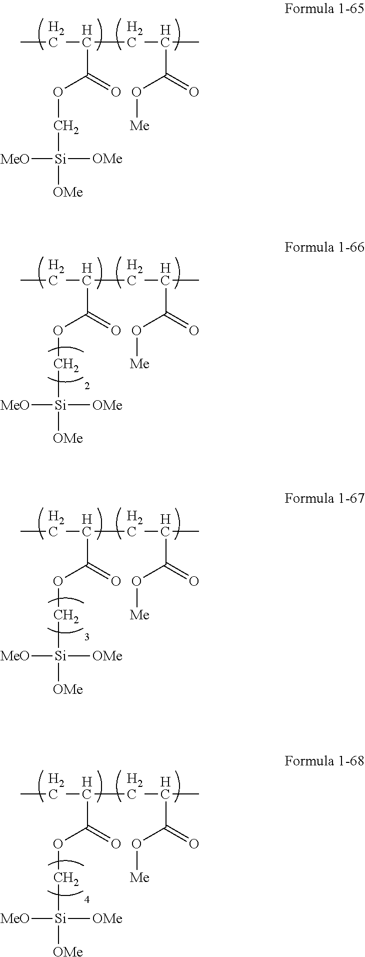

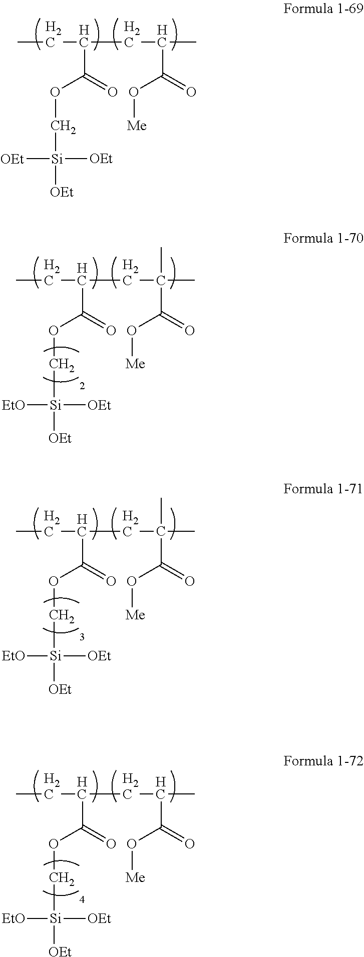

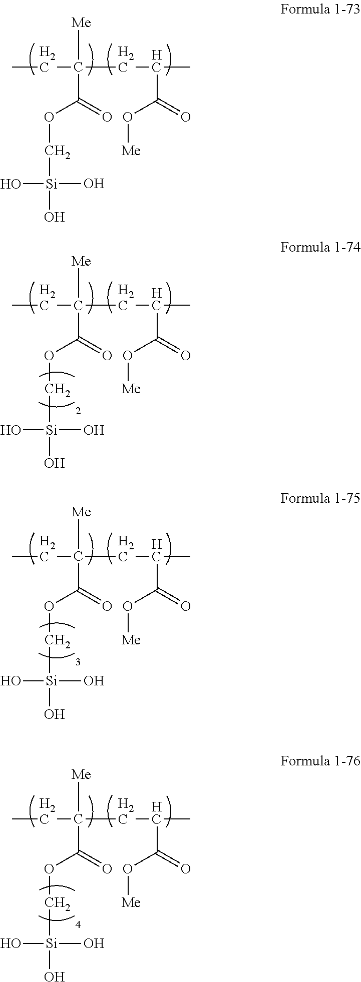

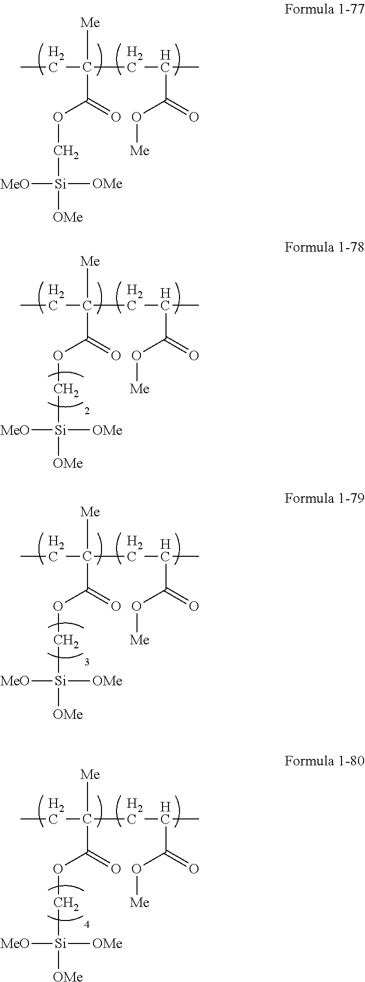

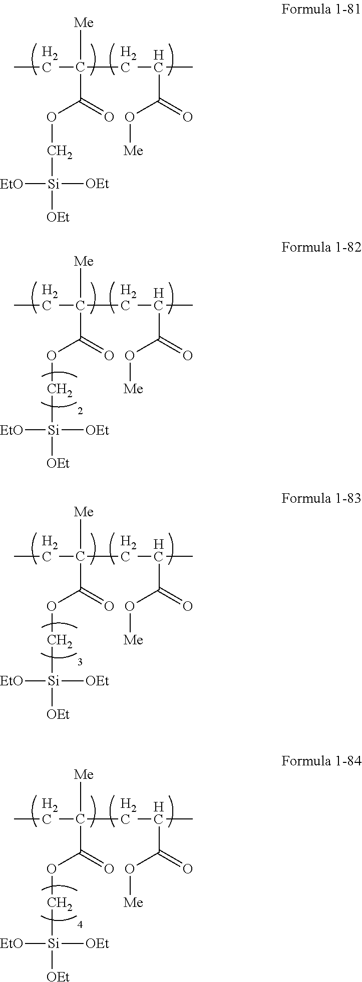

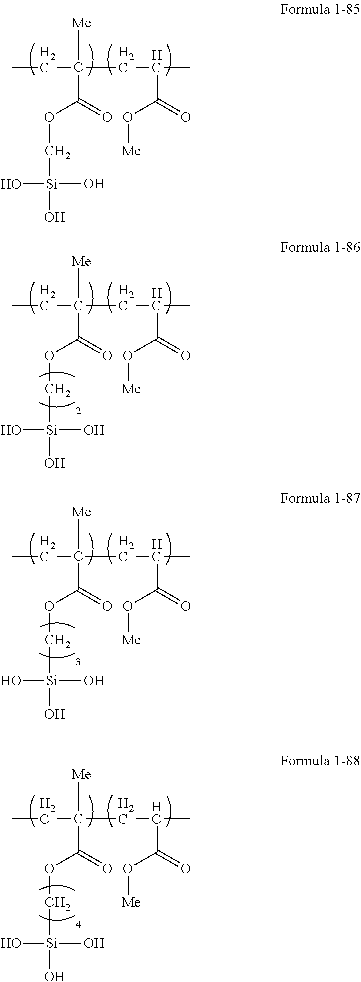

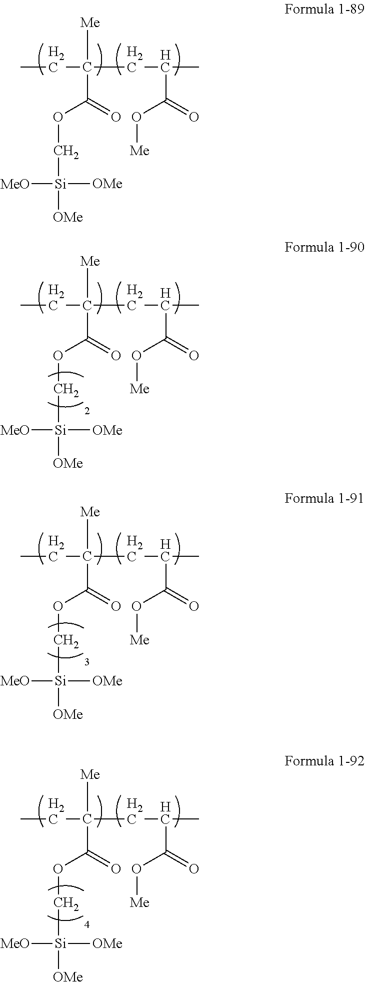

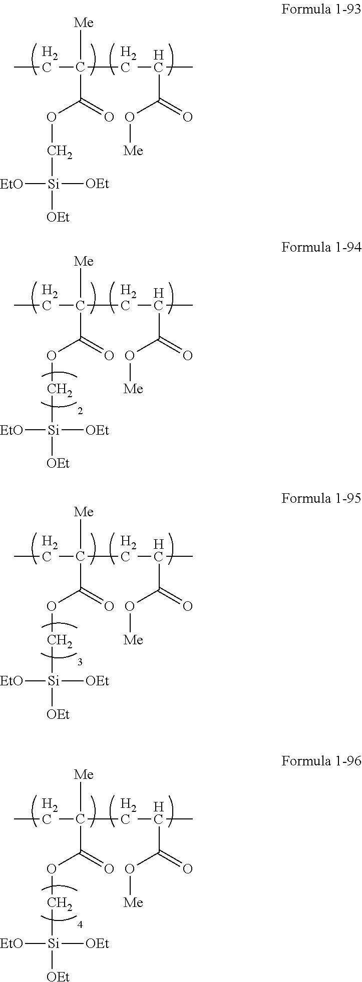

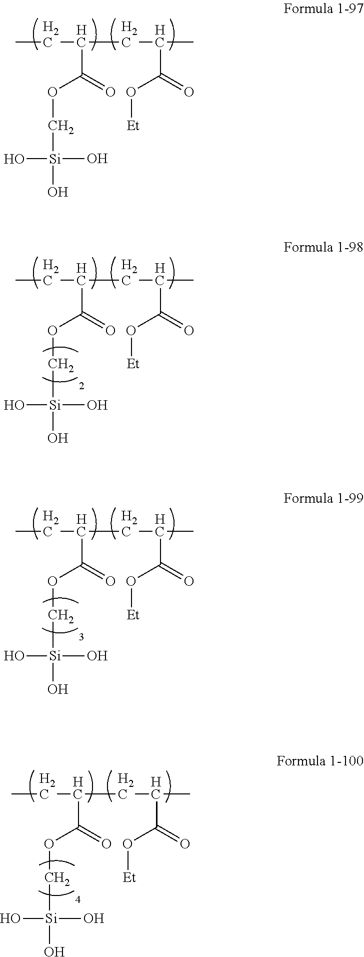

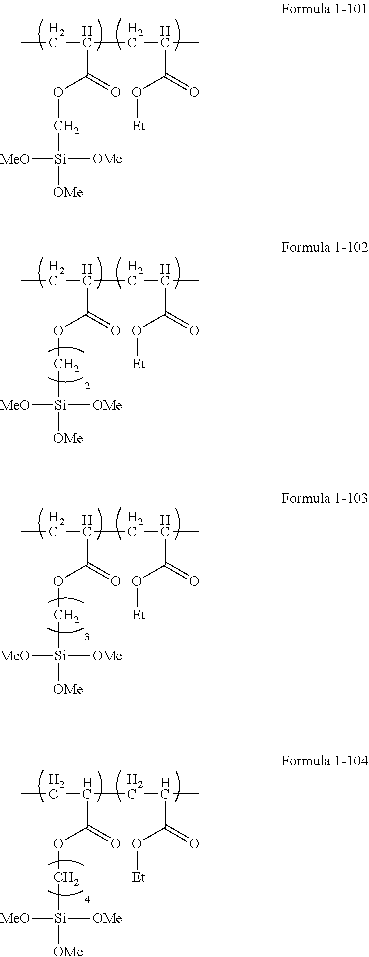

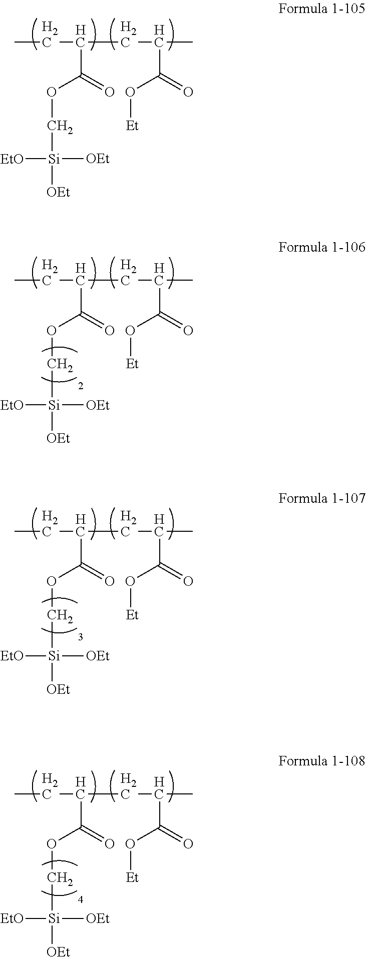

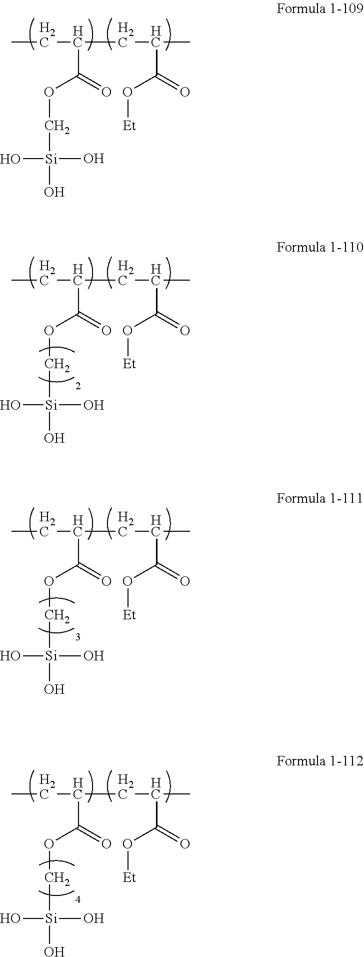

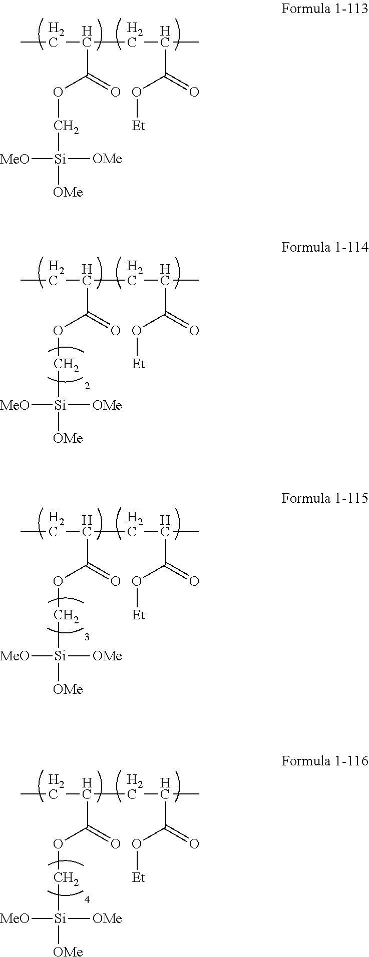

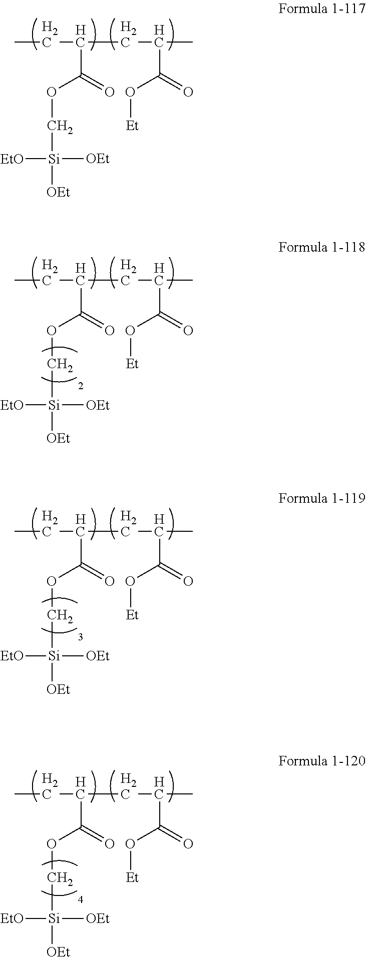

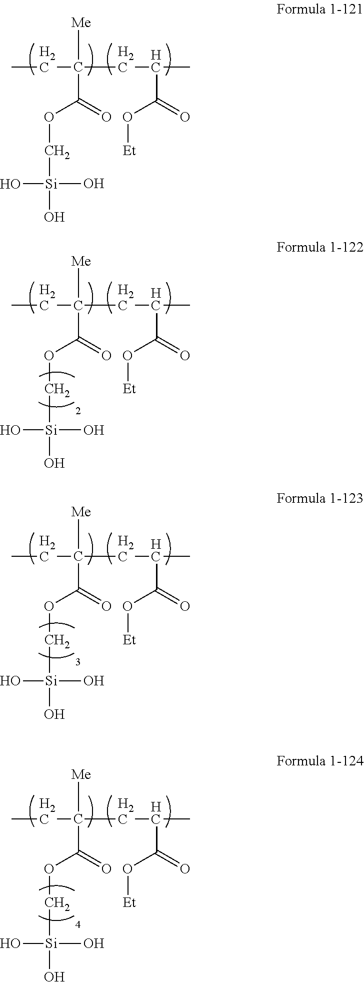

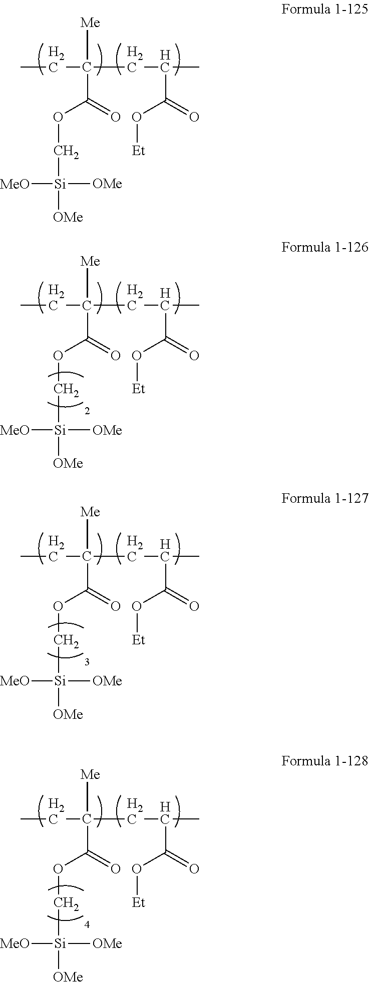

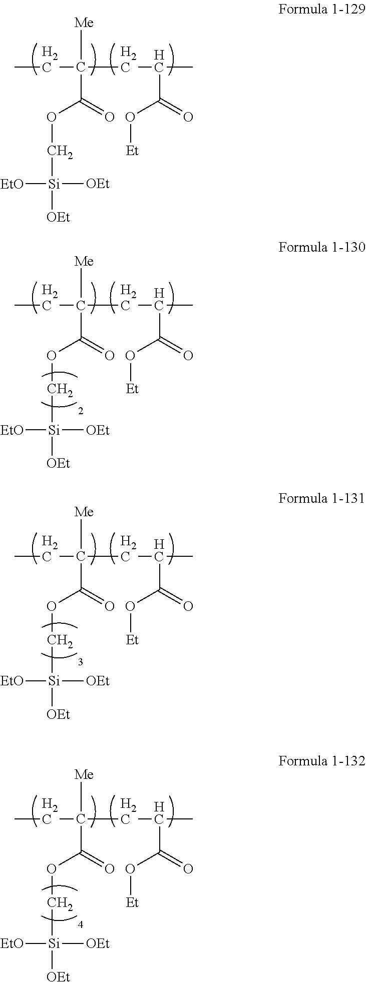

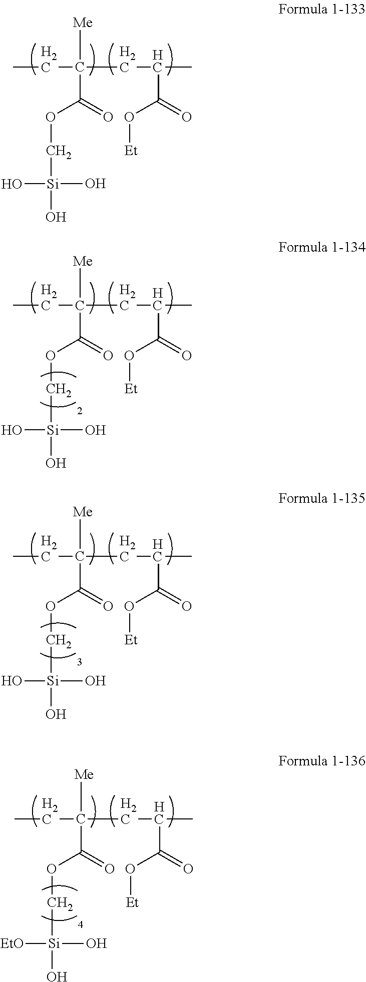

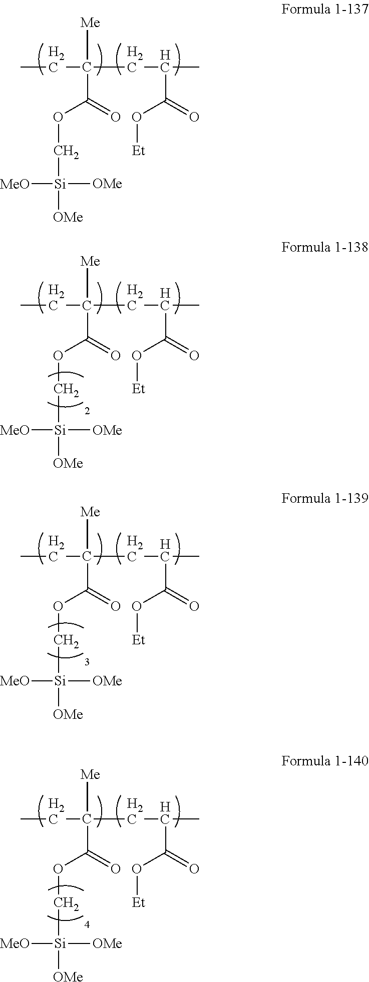

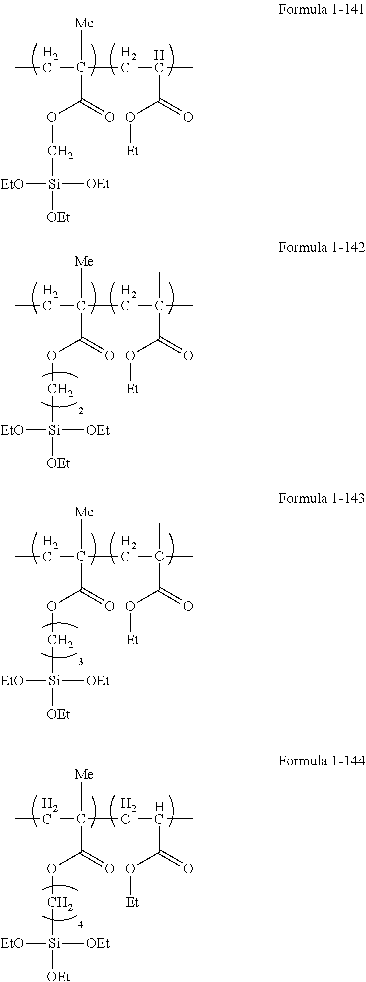

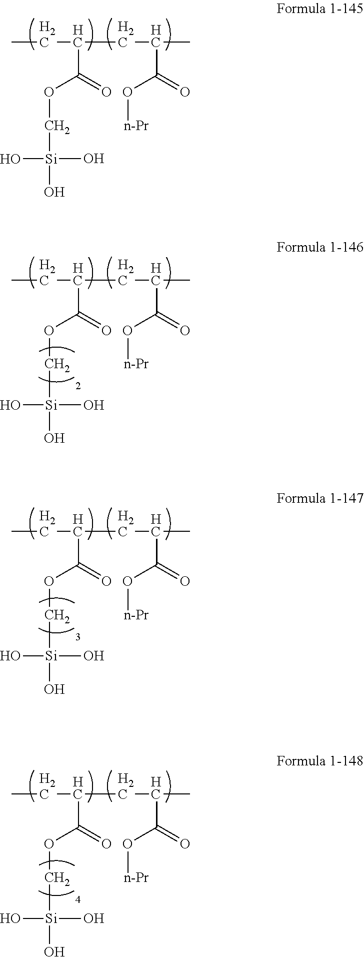

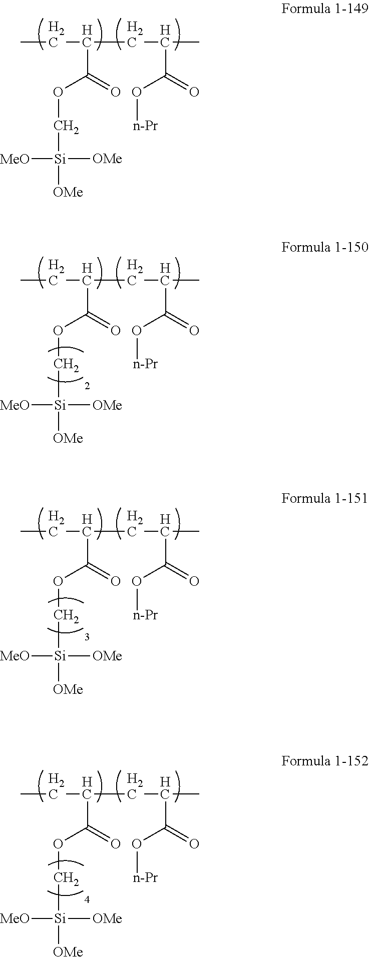

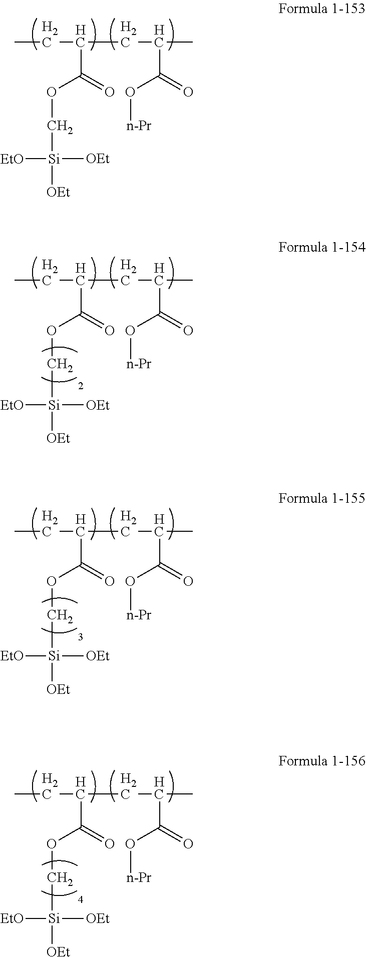

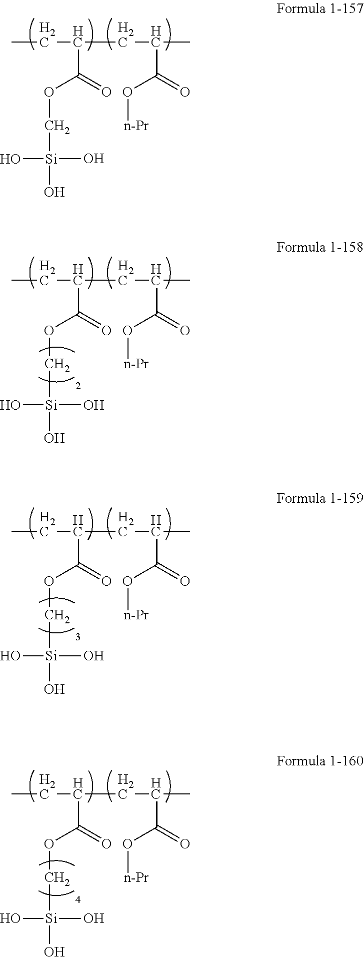

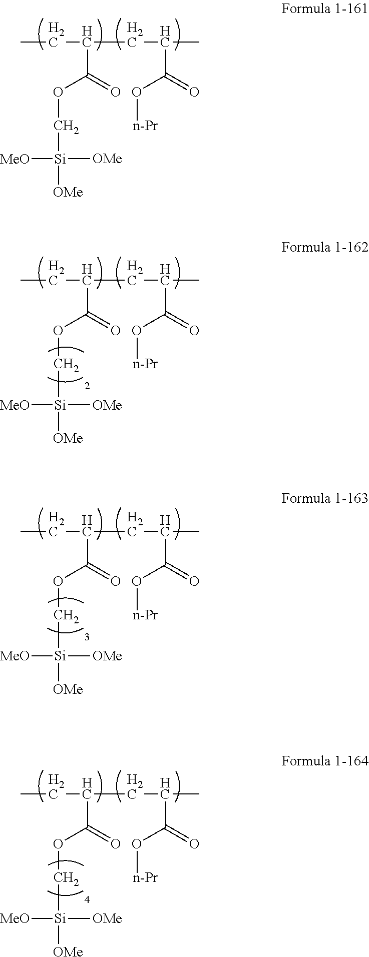

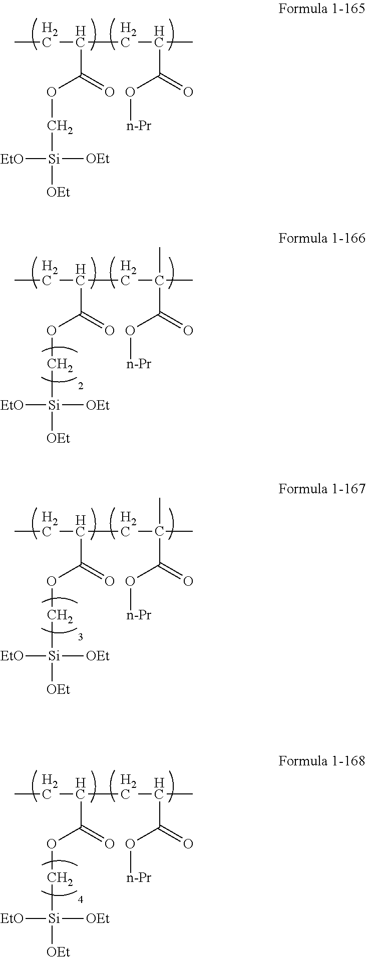

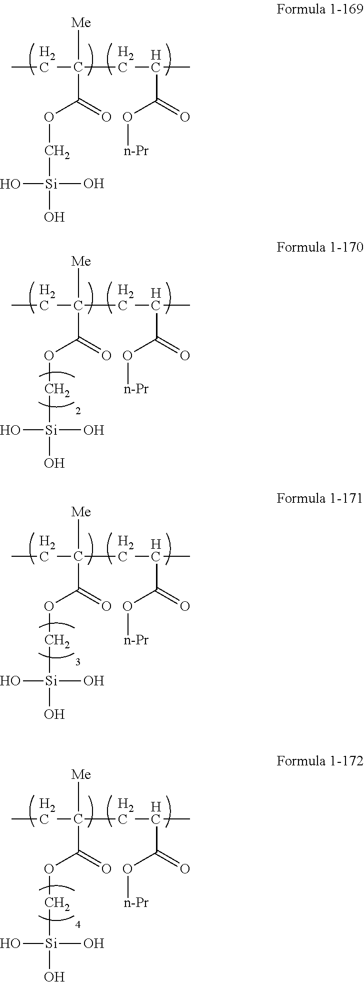

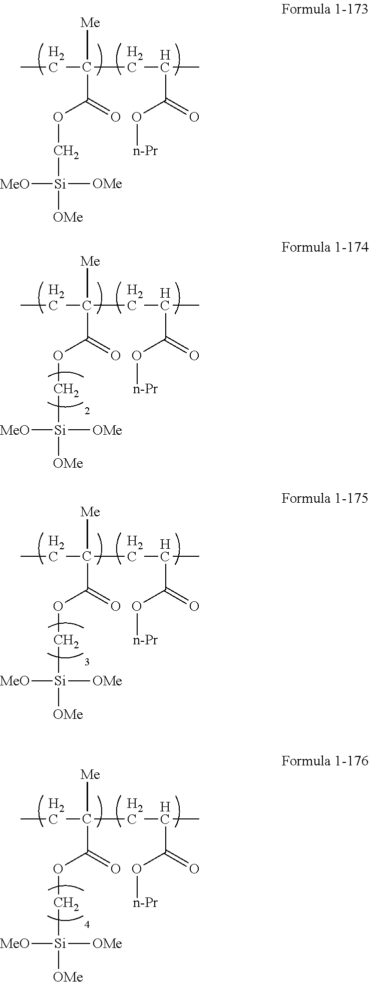

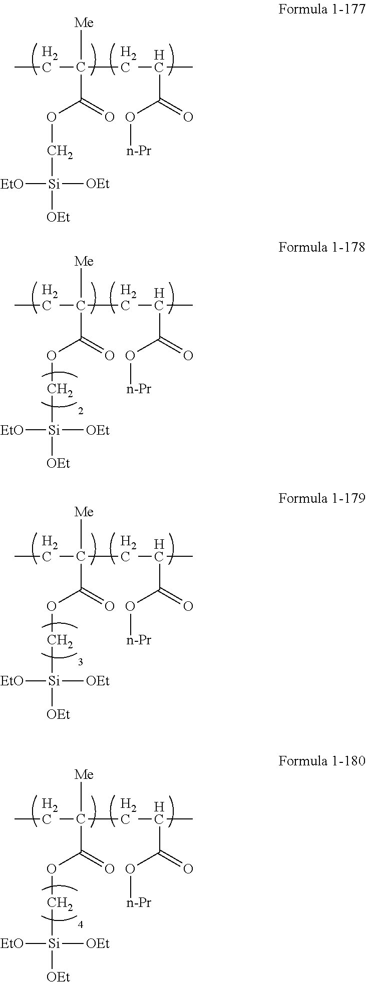

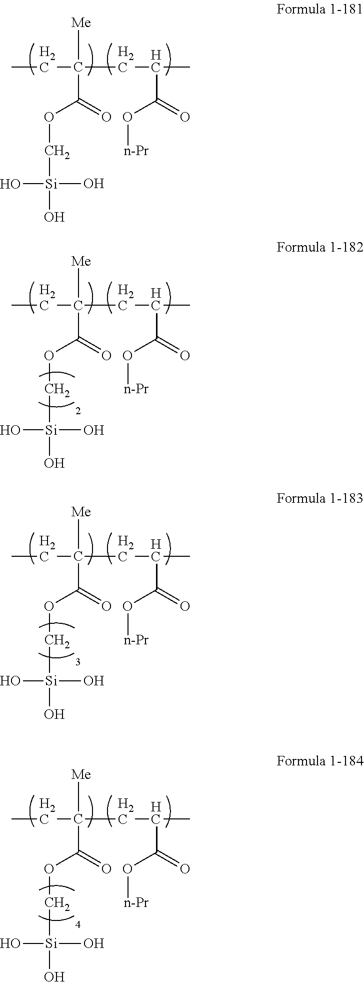

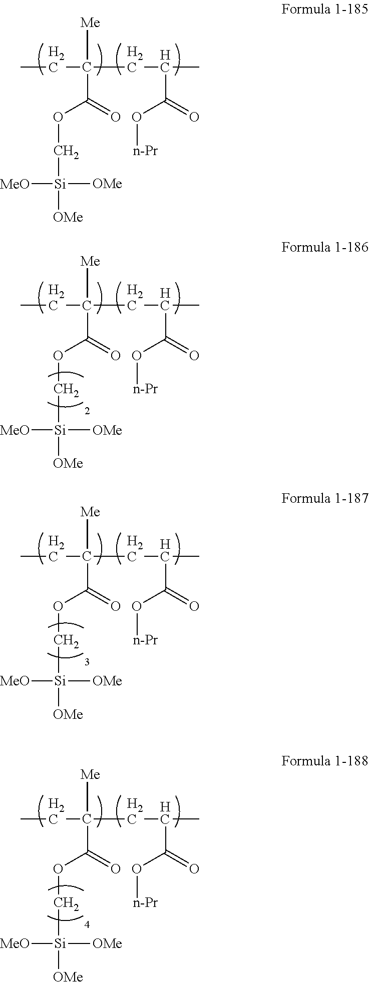

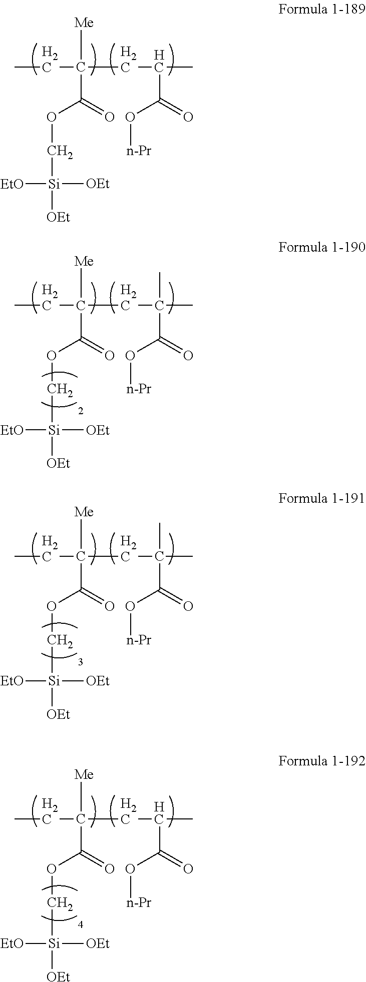

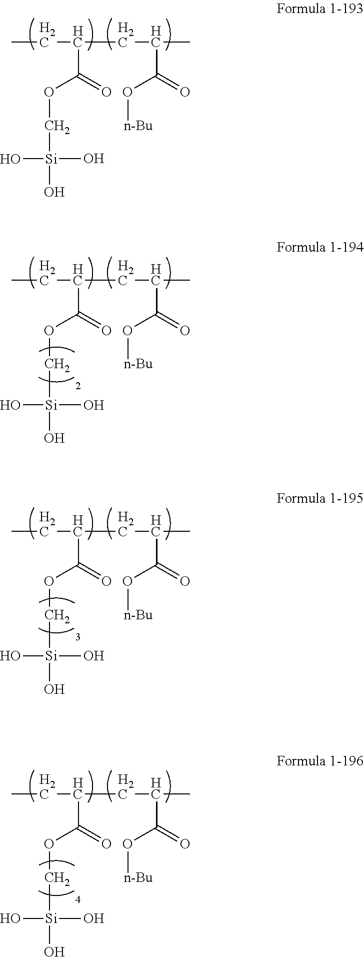

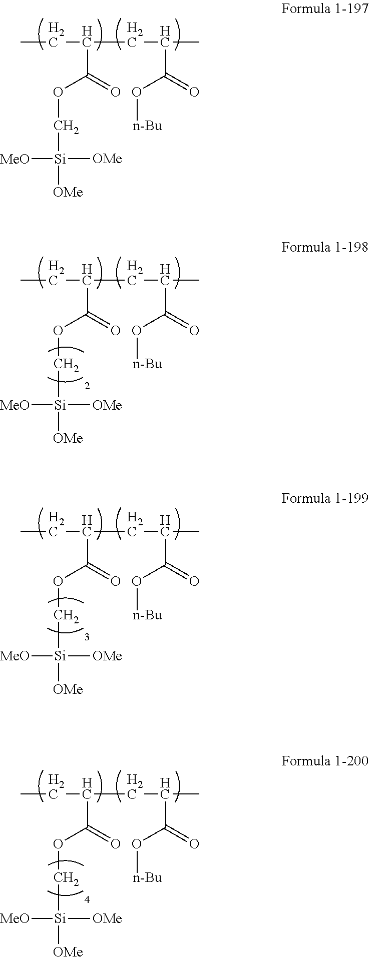

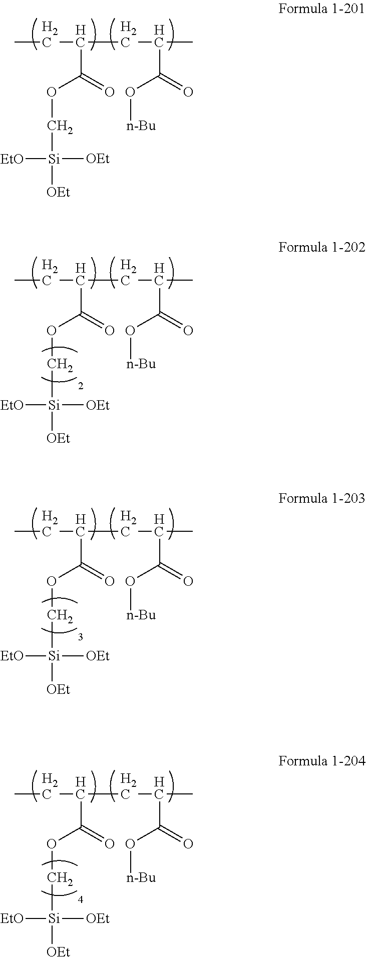

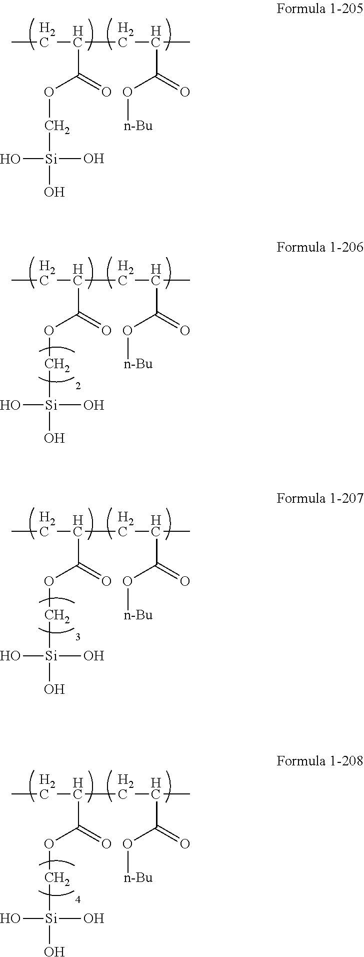

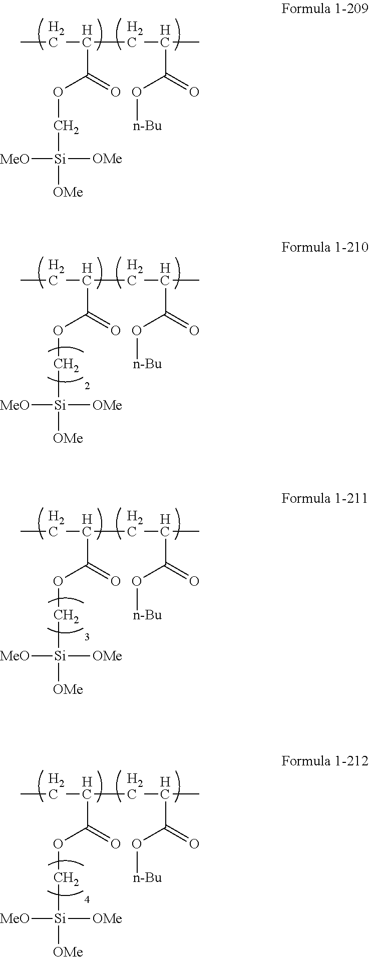

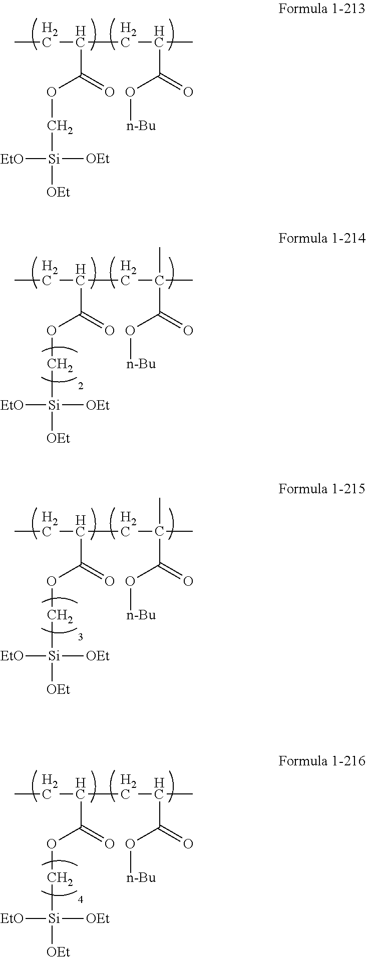

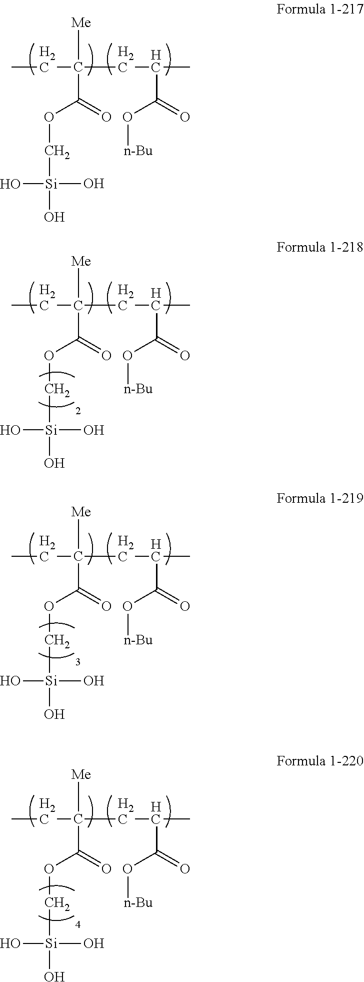

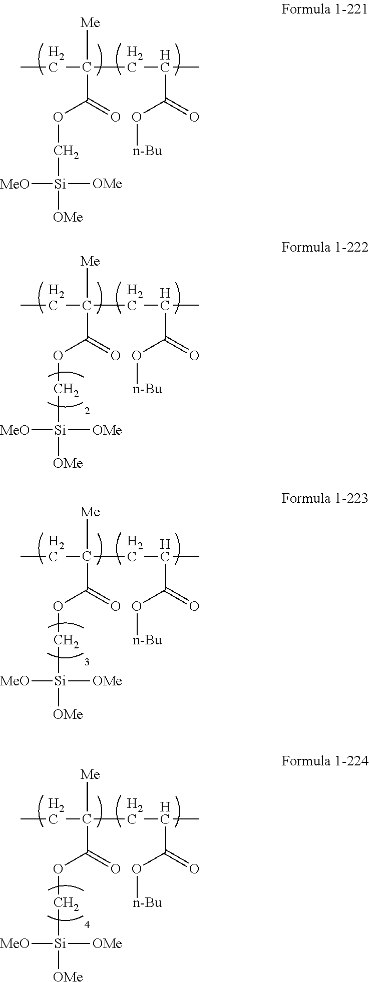

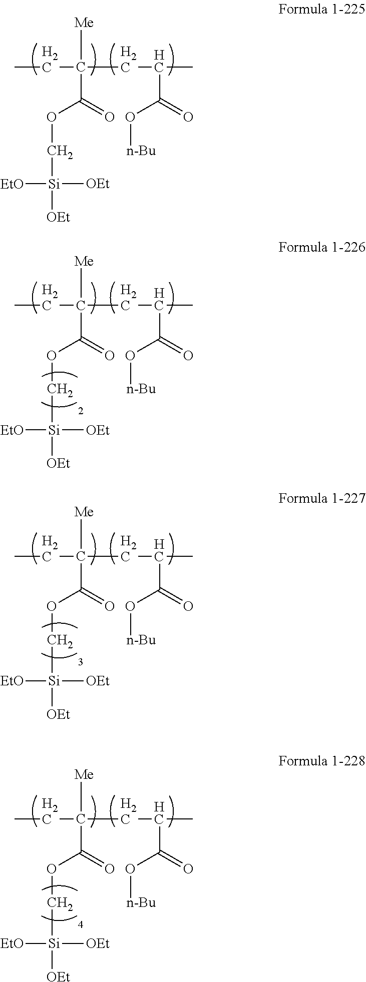

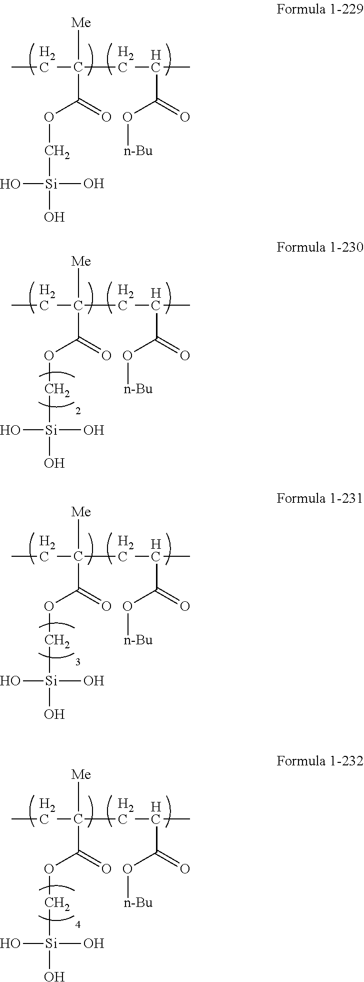

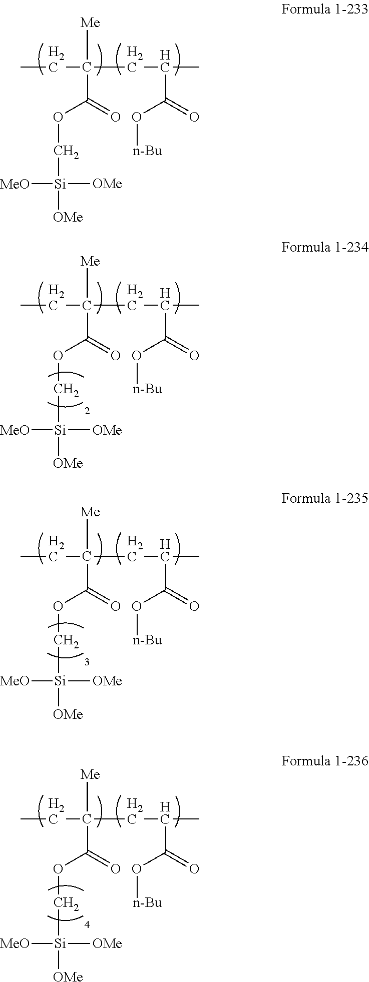

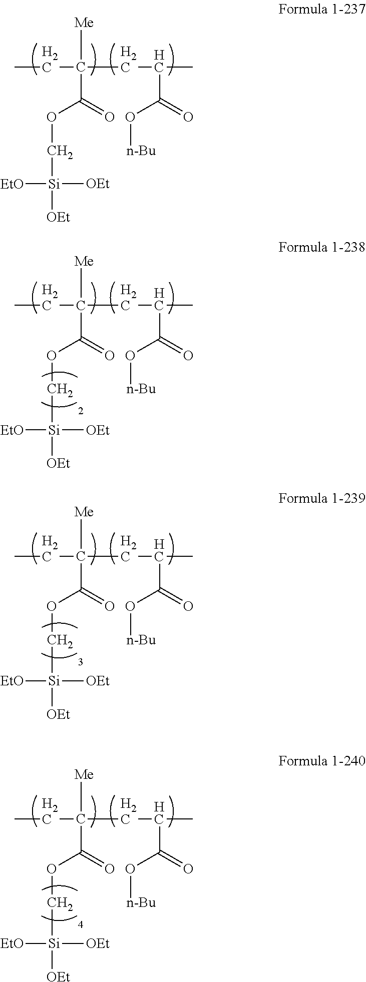

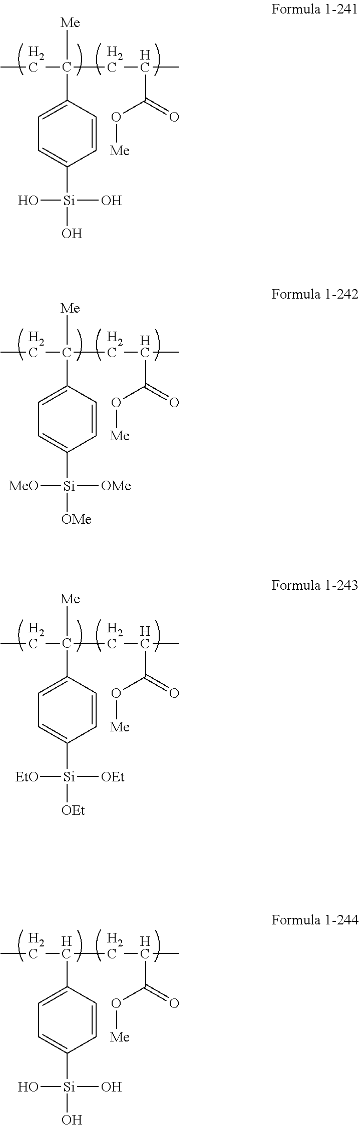

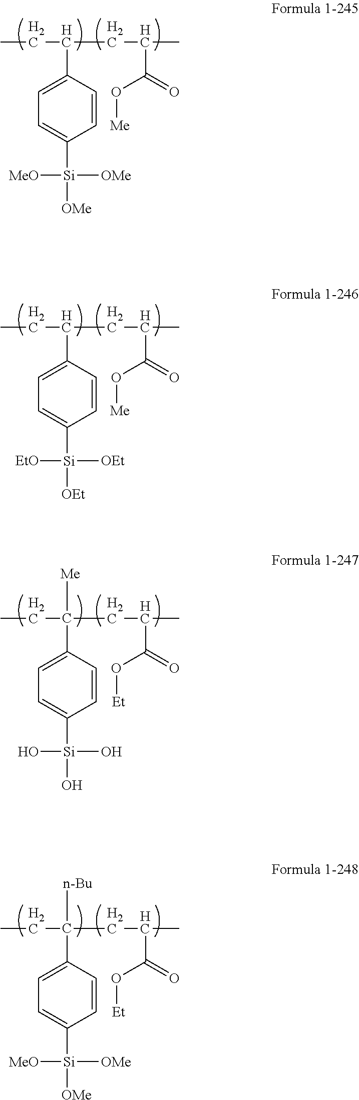

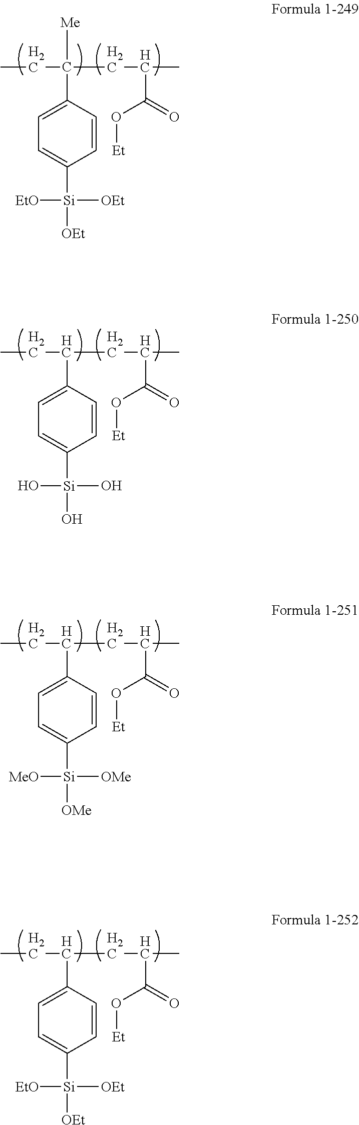

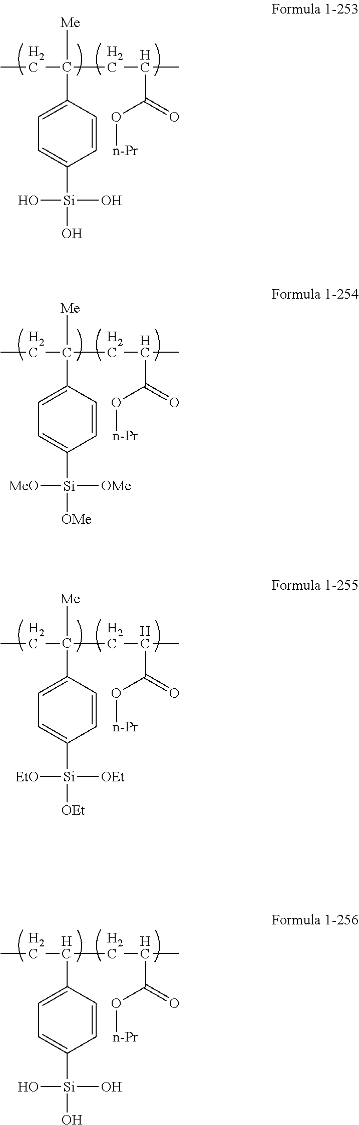

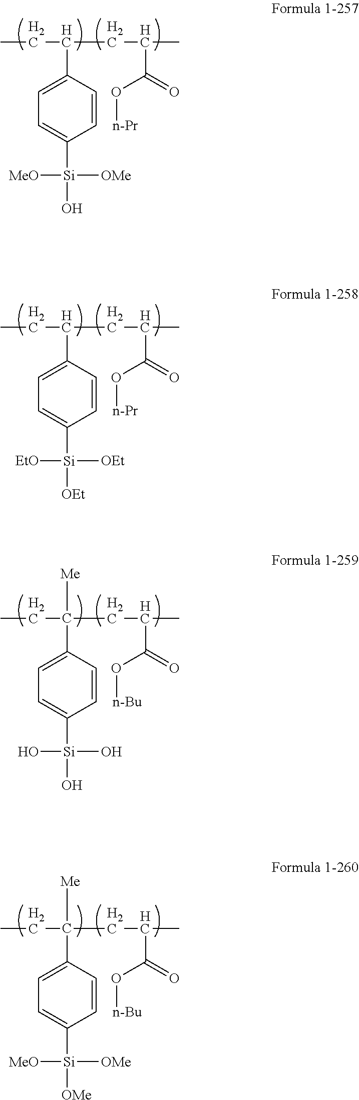

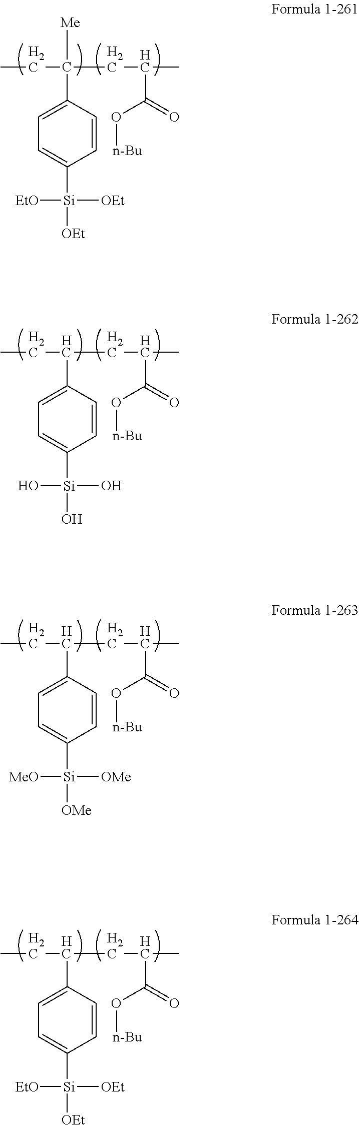

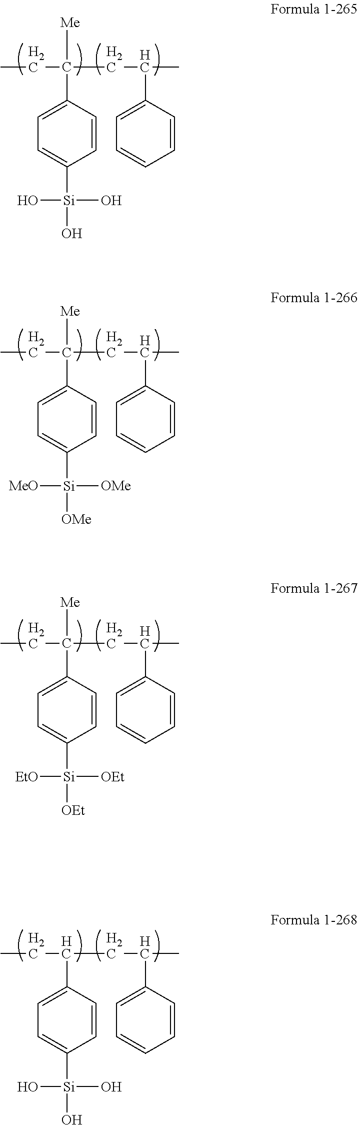

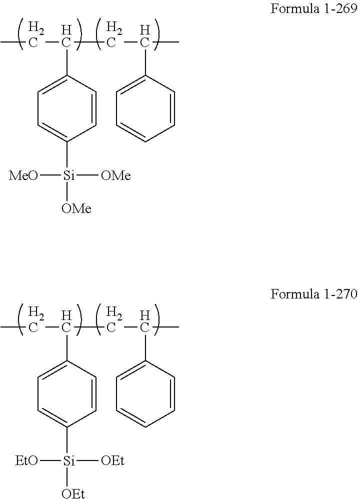

The inorganic infrared absorbent particle subjected to the surface treatment with the copolymer can be produced by a method including the following steps (Steps S11 to S13):

Step S11: a step of obtaining an infrared absorbent particle having a vinyl group by a coupling reaction of a compound having a structure represented by the following Formula 6 with an inorganic infrared absorbent particle;
Step S12: a step of mixing the infrared absorbent particle having the vinyl group with a styrene monomer or a monomer having a structure represented by the following Formula 7 to obtain a mixture; and
Step S13: a step of polymerizing the mixture.

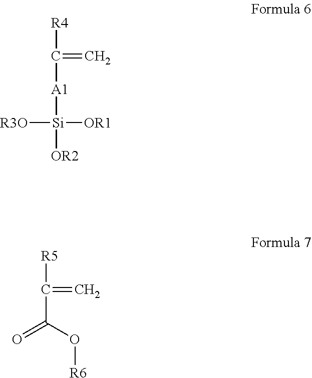

### (In Formulas 6 and 7,

R1 to R3 each independently represent a hydrogen atom or an aliphatic straight chain hydrocarbon having 1 to 4 carbon atoms,
R4 and R5 each independently represent a hydrogen atom or a methyl group,
R6 represents an aliphatic straight chain hydrocarbon group having 1 to 4 carbon atoms, and
A1 represents a structure of the following Formula 4 or 5,

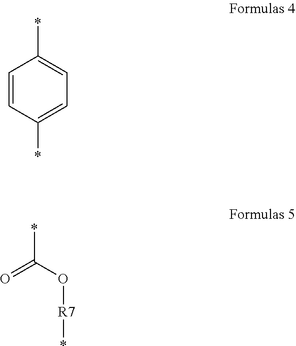

### in Formulas 4 and 5,

R7 represents an aliphatic straight chain hydrocarbon group having 1 to 4 carbon atoms, and
* represents a binding site.)

Each of R1 to R3 in Formula 6 is preferably a methyl group from the viewpoint of reactivity. In addition, in a case where A1 in Formula 6 represents the structure of Formula 4, R4 is preferably a hydrogen atom from the viewpoint of enhancing stability of a main chain structure.

The coupling reaction in Step S11 refers to a coupling reaction in which an oxygen atom on a surface of the inorganic infrared absorbent particle and a silane coupling agent are bonded to each other. The bonding may be covalent bonding, or so-called supramolecular bonding such as hydrogen bonding, coordination bonding, or ionic bonding. Specific examples of the silane coupling agent that can be used are shown below.

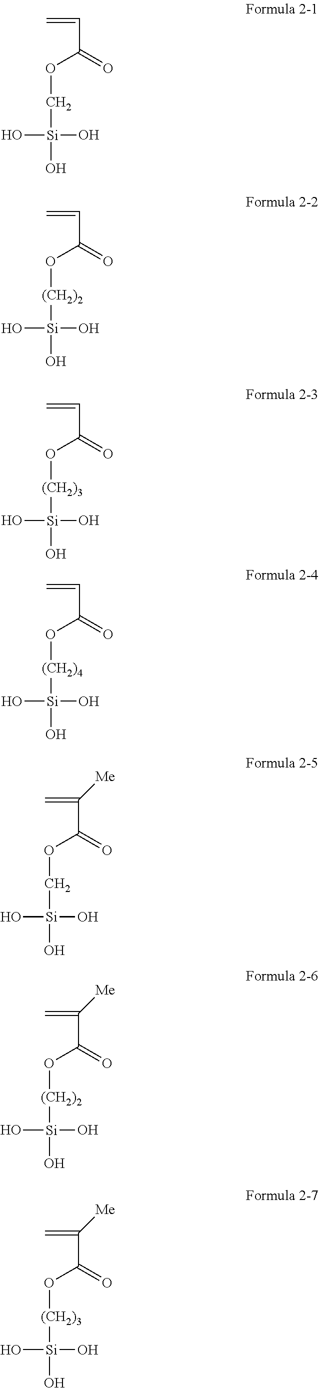

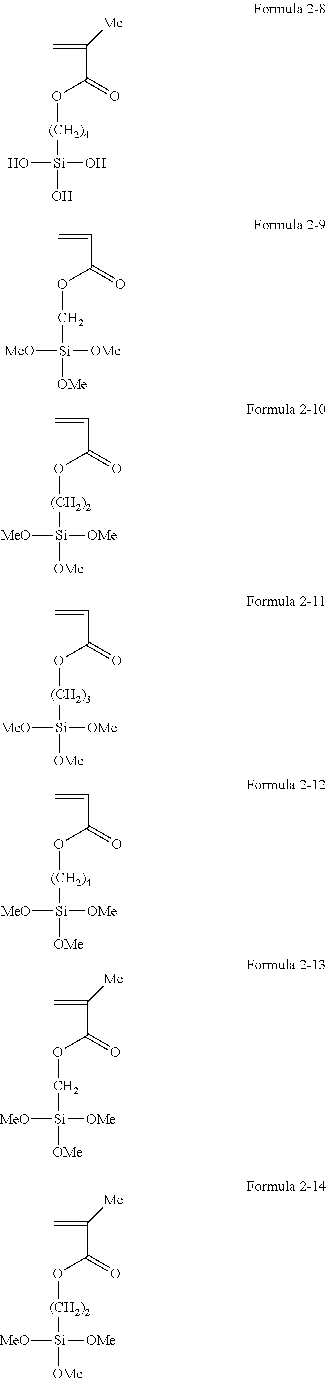

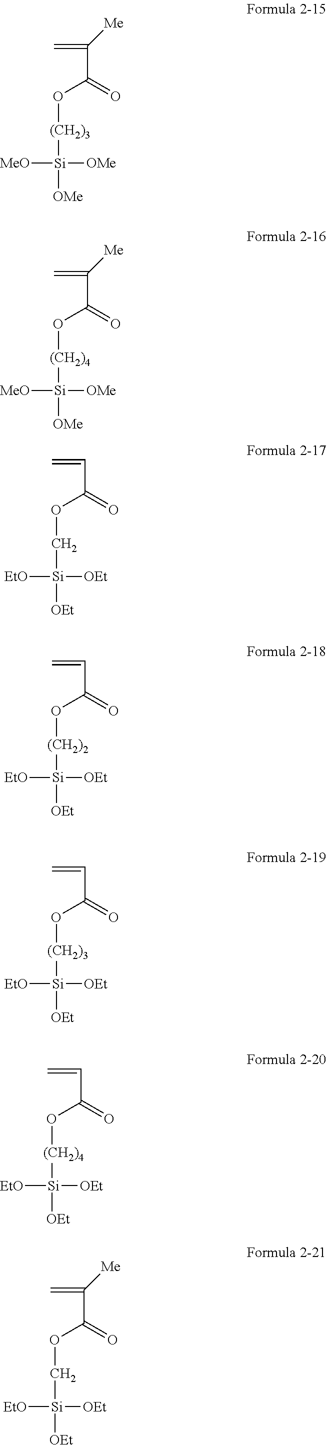

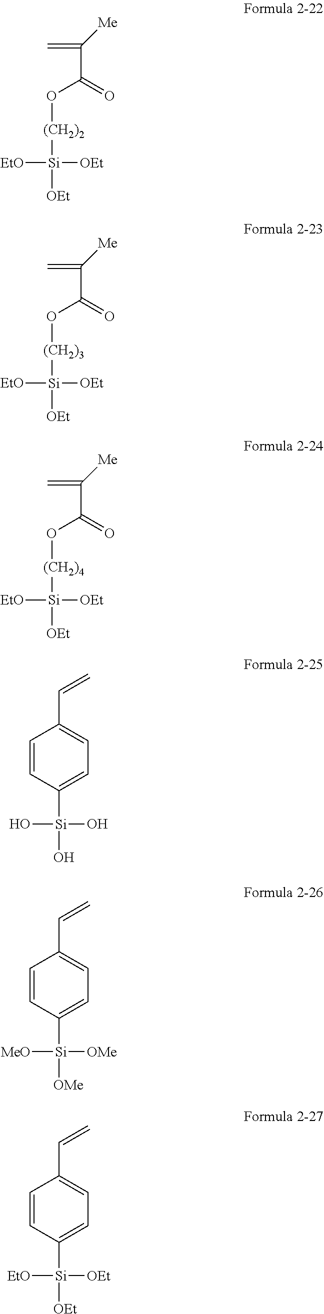

As the silane coupling agent, an acrylic, methacrylic, or styryl-based silane coupling agent is mainly used, and the styryl-based silane coupling agent can be preferably used in consideration of avoidance of generation of coarse particles and the like.

A used amount of the silane coupling agent is preferably 5 to 40 mass %, and more preferably 10 to 30 mass %, with respect to the inorganic infrared absorbent particle, from the viewpoints of adsorption to the resin and hydrophilicity.

A molar ratio of the silane coupling agent to the monomer in Step S12 is preferably 0.1:10.0 to 10.0:10.0, and more preferably 2.0:10.0 to 4.0:10.0, from the viewpoints of adsorption to the resin and hydrophilicity.

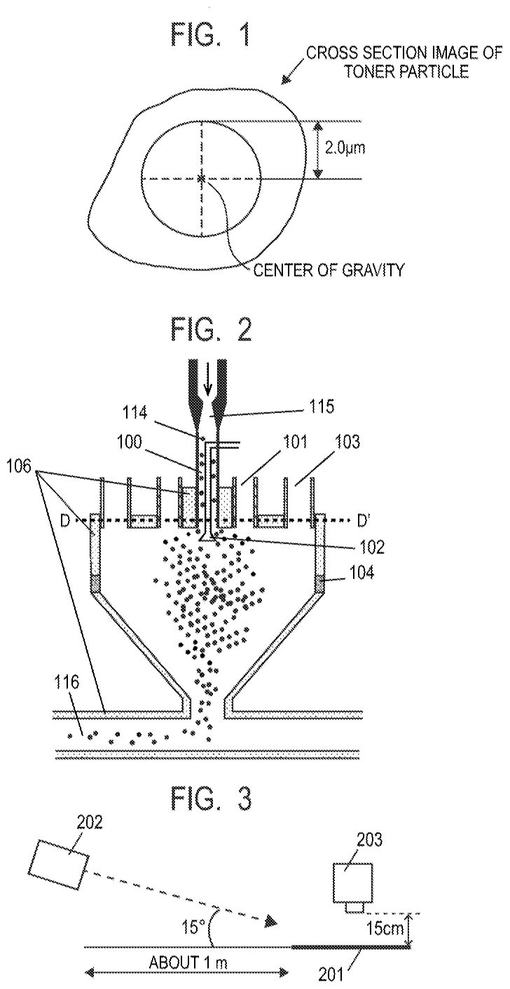

A coupling treatment is based on mixing of the silane coupling agent and an infrared absorption pigment. In general, in the silane coupling reaction, it is recommended that a base material and the silane coupling agent are mixed with each other and then a high temperature treatment is performed at 100′C or higher for a certain period of time. However, the high temperature treatment is performed, such that infrared absorption pigment particles may re-aggregate to form particles having a particle diameter equal to or larger than a desired particle diameter, which are so-called coarse particles. Therefore, in the present invention, it is preferable that a mixture is obtained by mixing the coupling agent (Step S12 of FIG. 1), and then a polymerization treatment is immediately performed (Step S13).

In the mixing in Step S12, a magnetic type stirrer, a combination of a stirring blade and a mechanical stirrer, a shaker, a high-speed shearing type disperser, a multi-shaft roller type kneader, a bead mill disperser, a ring mill disperser, a high-pressure disperser, or the like can be optionally used. When considering a rapid progress to a polymerization step which is a next step, a preferred mixing method is a method using the combination of the stirring blade and the mechanical stirrer. In addition, the bead mill disperser is preferably used to suppress the re-aggregation and reduce the particle diameter.

A polymerization reaction in Step S13 mainly refers to radical polymerization. Ina polymerization initiation reaction, as alight, heat, or electron beam polymerization initiator, an azo-based or peroxide-based radical generator can be used, or high temperature polymerization using no polymerization initiator or an electron beam can be optionally selected.

In the polymerization reaction, a solvent can be used, but bulk polymerization which is a solventless reaction is preferable from the viewpoint of increasing a particle diameter by aggregation of coated infrared absorption pigments. Examples of the solvent can include toluene, xylene, mesitylene, chloroform, NN-dimethylformamide, and NN-dimethyl sulfoxide. Details of a mechanism in which dispersion stability is improved by the bulk polymerization are unclear. In the case of the bulk polymerization, it is considered that the re-aggregation of the infrared absorption pigments is controlled by a mechanical reason due to an increase in viscosity of a reaction system in accordance with the progress of the polymerization and a continuous increase in shearing force accompanied by the increase in viscosity of the reaction system, and a chemical reason of improving dispersibility as the polymerization proceeds.

A number average particle diameter (D1) of primary particles of the inorganic infrared absorbent particles used in the present invention is preferably 0.5 μm or less and more preferably 0.1 μm or less. Within these ranges of the number average particle diameter, the infrared absorption capacity is likely to be sufficiently exhibited when the particles are finely dispersed in the toner. A lower limit value of the number average particle diameter is about 0.01 μm and more preferably about 0.02 μm.

A number average particle diameter of a dispersion diameter of the inorganic infrared absorbent particles contained in the toner according to the present invention is preferably 0.5 μm or less, more preferably 0.3 μm or less, and particularly preferably 0.2 nm or less. When the number average particle diameter of the dispersion diameter is 0.5 μm or less, the infrared absorption capacity is likely to be sufficiently exhibited. The “dispersion diameter of the inorganic infrared absorbent particles” refers to the longest diameter of the inorganic infrared absorbent particles dispersed in the toner. In a case where the inorganic infrared absorbent particles aggregate in the toner to form an aggregate, the longest diameter of the aggregate is defined as a dispersion diameter. A lower limit value of the dispersion diameter is about 0.02 μm and more preferably 0.04 μm.

A means for setting the number average particle diameter of the dispersion diameter of the inorganic infrared absorbent particles to 0.5 μm or less is not particularly limited, and examples of the means can include the following means (1) and (2). When the inorganic infrared absorbent particle having a small particle diameter of the primary particle is used, the dispersion diameter tends to be small. Therefore, an inorganic infrared absorbent particle having a small diameter of the primary particle is preferably used with the following means.

(1) A method including a step of dispersing inorganic infrared absorbent particles in a binder resin in a series of steps of producing a toner.

(2) A method of suppressing an aggregation of the inorganic infrared absorbent particles in the toner production. These means may be used alone or in combination.

In spectrometry of an image formed by using the toner according to the present invention in a loading amount of 0.30 mg/cm², a maximum value of a light absorbance in a wavelength range of 400 nm or more and 800 nm or less is 10% or less. The wavelength range is a wavelength region corresponding to a visible region, and when the light absorbance is 10% or less, recognition with the naked eye is substantially difficult, which is preferable in terms of security or an aesthetic appearance. When the light absorbance in this range is 5% or less, it is more preferable in terms of security or an aesthetic appearance.

In cross section observation of the toner particle according to the present invention using a transmission electron microscope, a circle having the center of gravity of a cross section image of the toner particle as the center thereof and having a radius of 2.0 μm is drawn, and the circle is divided into four to form four quadrants. In this case, a coefficient of variation in number of the inorganic infrared absorbent particles observed in each quadrant is 0.50 or less and preferably 0.40 or less. The infrared absorption capacity of the toner can be sufficiently exhibited by controlling the coefficient of variation to 0.50 or less. The coefficient of variation is calculated according to a method described below.

A means for obtaining a toner in which a coefficient of variation is 0.50 or less is not particularly limited, and examples of a method of reducing a coefficient of variation can include the following means (1) and (2). When the inorganic infrared absorbent particle having a small particle diameter of the primary particle is used, the coefficient of variation tends to be reduced. Therefore, the particle diameter of the inorganic infrared absorbent particle is preferably adjusted with the following means.

(1) A step of dispersing inorganic infrared absorbent particles in a binder resin in a series of steps of producing a toner is provided.

(2) A method of suppressing an aggregation of the inorganic infrared absorbent particles in the toner production. These means may be used alone or in combination.

An example of a method of dispersing the inorganic infrared absorbent particles in the binder resin can include a method of using a masterbatch in the step of producing the toner. That is, the inorganic infrared absorbent particles are mixed with a part of the binder resin so that the inorganic infrared absorbent particle has a high concentration, and melting and kneading are performed while applying high shear, thereby producing a masterbatch in which the inorganic infrared absorbent particles are finely dispersed. The method also includes performing melting and kneading after the production of the masterbatch while diluting the masterbatch with the remaining binder resin. Examples of a melting and kneading apparatus suitably used in the production of the masterbatch can include a kneader, a Banbury mixer, two rolls, and a three-roll mill, and these apparatuses can be used alone or in combination. An example of the melting and kneading apparatus used in the diluting and kneading can include a twin-screw kneader.

In addition, it is also an effective method in performing a surface treatment of the inorganic infrared absorbent particle so that the inorganic infrared absorbent particles are easily dispersed in the binder resin. In a case where the toner according to the present invention is produced by a suspension polymerization method, it is effective to perform a hydrophobic treatment on the surface of the inorganic infrared absorbent particle in order to easily disperse the inorganic infrared absorbent particles in styrene.

An example of a method of suppressing the aggregation of the inorganic infrared absorbent particles during the toner production can include a method of rapidly performing cooling after the melting and kneading step. For example, a melt-kneaded material can be cooled in an instant by spreading the melt-kneaded material onto a water-cooled metal belt into a sheet shape. The aggregation of the inorganic infrared absorbent particles generated during the cooling can be significantly suppressed by rapidly performing such cooling. Examples of a cooling apparatus suitably used for the rapid cooling can include an “NR double belt cooler for high viscosity” (manufactured by Nippon Belting Co., Ltd.), a “cooling and solidification equipment, belt drum flaker” (manufactured by Nippon Coke and Engineering Co., Ltd.), and a cooling and solidification device (drum flaker) (manufactured by KATSURAGI INDUSTRY CO., LTD.).

In the cross section observation of the toner particle using the transmission electron microscope, it is preferable that the toner particles in which the inorganic infrared absorbent particles are absent in a region from a surface of the toner particle to a depth of 50 nm from the surface of the toner particle are 60 number % or more of all the toner particles. The toner particles are more preferably 80 number % or more. An inorganic infrared absorbent is generally a substance having an extremely low volume resistivity, and when the inorganic infrared absorbent is present in the vicinity of the surface of the toner particle, resistance of the toner particle is lowered.

Therefore, when a ratio of the toner particles in which the inorganic infrared absorbent particles are present in the vicinity of the surface of the toner particle is large, it is difficult to preferably maintain charge of the toner, developability or transferability is deteriorated, and it is difficult to form a high-definition image. According to studies conducted by the present inventors, it was found that when the toner particles in which the inorganic infrared absorbent particles are absent in the region from the surface of the toner particle to the depth of 50 nm from the surface of the toner particle is 60 number % or more of all the toner particles, an adverse effect caused by a decrease in the resistance of the toner particle can be suppressed.

A toner production method for setting the ratio of the toner particles in which the inorganic infrared absorbent particles are absent in the region from the surface of the toner particle to the depth of 50 nm from the surface of the toner particle to 60 number % or more of all the toner particles is not particularly limited, and examples thereof can include the following toner production methods (1) to (5).

(1) A method of producing a toner particle by sufficiently performing a hydrophobic treatment on a surface of an inorganic infrared absorbent particle which is a raw material, in advance, mixing and dispersing the inorganic infrared absorbent particle subjected to the hydrophobic treatment and a polymerizable monomer such as styrene, granulating the inorganic infrared absorbent particle in an aqueous medium, and then performing polymerization (suspension polymerization method). In a case where this production method is applied, the inorganic infrared absorbent particles subjected to the hydrophobic treatment are more likely to be contained inside the toner, and the inorganic infrared absorbent particles are hardly present in the region from the surface of the toner particle to the depth of 50 nm from the surface of the toner particle.

(2) The inorganic infrared absorbent particles and the binder resin are melted and kneaded, cooled, and then finely pulverized to a toner size. Thermoplastic resin fine particles having a number average particle diameter of about 30 to 300 nm are externally added to the finely pulverized material to obtain a toner particle precursor having a surface to which a thermoplastic resin is attached. The thermoplastic resin attached to the surface of the toner particle precursor is smoothed by applying a mechanical shear (shearing force) to the toner particle precursor to produce a toner particle having a surface coated with the thermoplastic resin (pulverization method/mechanochemical treatment). The toner particle precursor may be heated using hot air or the like when applying the mechanical shear to promote the smoothing, if necessary.

Examples of an apparatus for applying the mechanical shear can include a “Hybridization system (NHS)” (manufactured by NARA MACHINERY Co., Ltd.), a “Circulation-type mechanofusion (R)system AMS” (manufactured by Hosokawa Micron CORP.), and a “Faculty (R) S series F-S” (manufactured by Hosokawa Micron CORP.). In a case where this production method is applied, the surface of the toner particle is coated with the smoothed thermoplastic resin. Therefore, the inorganic infrared absorbent particles are hardly present in the region from the surface of the toner particle to the depth of 50 nm from the surface of the toner particle.

(3) The inorganic infrared absorbent particles and the binder resin are melted and kneaded, cooled, and then finely pulverized to a toner size. Thermoplastic resin fine particles having a number average particle diameter of about 30 to 300 nm are externally added to the finely pulverized material to obtain a toner particle precursor. The toner particle precursor is subjected to a hot air treatment by a heat spheroidizing apparatus. The externally added thermoplastic resin is melted by the hot air treatment to produce a toner particle having a surface with which the thermoplastic resin is coated (pulverization method/heat spheroidizing treatment). An example of the heat spheroidizing treatment apparatus can include a “Surface modifier, METEO RAINBOW MR Type” (manufactured by Nippon Pneumatic Mfg. Co., Ltd.). In a case where this production method is applied, the surface of the toner particle is coated with the melted thermoplastic resin. Therefore, the inorganic infrared absorbent particles are hardly present in the region from the surface of the toner particle to the depth of 50 nm from the surface.

In a case where the heat spheroidizing treatment is performed, an external addition step of the thermoplastic resin fine particles is unnecessary, and the inorganic infrared absorbent particles exposed to the surface can be shielded to some extent only by performing the heat spheroidizing treatment on the finely pulverized material itself: This is because the binder resin or wax contained in the finely pulverized material is melted by the hot air treatment and migrated to a surface of the finely pulverized material to coat the inorganic infrared absorbent particle.

(4) The inorganic infrared absorbent particles and the binder resin are melted and kneaded, cooled, and then finely pulverized to a toner size. The finely pulverized material is dispersed in an aqueous medium using a surfactant. Here, an aqueous dispersion of the thermoplastic resin fine particles having a number average particle diameter of about 30 to 300 nm is externally added to attach the thermoplastic resin fine particles to a surface of the finely pulverized material. Thereafter, the aqueous medium is heated at a temperature equal to or higher than a glass transition temperature of the thermoplastic resin to produce a toner particle having a surface coated with the thermoplastic resin (pulverization method/wet coating treatment). In a case where this production method is applied, the surface of the toner particle is coated with the melted thermoplastic resin. Therefore, the inorganic infrared absorbent particles are hardly present in the region from the surface of the toner particle to the depth of 50 nm from the surface.

(5) An aqueous dispersion of the inorganic infrared absorbent particles and the aqueous dispersion of the thermoplastic resin fine particles having the number average particle diameter of about 30 to 300 nm are mixed with each other to aggregate the inorganic infrared absorbent particles and the resin fine particles. Thereafter, the aqueous medium is heated at a temperature equal to or higher than the glass transition temperature of the thermoplastic resin to fuse the aggregate, thereby obtaining an aqueous dispersion of core particles. The aqueous dispersion of the thermoplastic resin fine particles having the number average particle diameter of about 30 to 150 nm is added to the aqueous dispersion of the core particles to form an aggregate in which the thermoplastic resin fine particles are attached to a surface of the core particle. Thereafter, the aqueous medium is heated at the temperature equal to or higher than the glass transition temperature of the thermoplastic resin to produce a toner particle having a surface coated with the thermoplastic resin (aggregation method). The thermoplastic resin fine particle used in the production of the core particle and the thermoplastic resin fine particle attached to the surface of the core particle may be the same resin or different resins. In a case where this production method is applied, the surface of the toner particle is coated with a layer of the thermoplastic resin. Therefore, the inorganic infrared absorbent particles are hardly present in the region from the surface of the toner particle to the depth of 50 nm from the surface.

The toner production method may be not only the above production method but also a suspension polymerization method or an emulsion aggregation method.

The suspension polymerization method includes the following steps:

Step S21: a step of mixing at least a polymerizable monomer constituting a binder resin and inorganic infrared absorbent particles with each other to prepare a polymerizable monomer composition;
Step S22: a step of dispersing the polymerizable monomer composition in an aqueous medium and granulating particles of the polymerizable monomer composition; and
Step S23: a step of polymerizing the polymerizable monomer in the particles of the polymerizable monomer composition to obtain toner particles.

The emulsion aggregation method includes the following steps:

Step S31: a step of preparing a resin particle dispersion liquid, a wax dispersion liquid, an inorganic infrared absorbent particle dispersion liquid, and if necessary, a dispersion liquid including other toner components, and mixing these dispersion liquids with each other to prepare a mixed liquid (mixing step);
Step S32: a step of adding and mixing a pH adjuster, an aggregation agent, a stabilizer, and the like in the mixed liquid after the preparation of the mixed liquid to form aggregate particles obtained by aggregation of the respective particles (aggregation step); and
Step S33: a step of heating and fusing the aggregate particles (fusion step).

Thereafter, toner particles are obtained through a filtering and cleaning step and a drying step.

A content of the inorganic infrared absorbent contained in the toner is preferably 0.3 mass % or more and 1.0 mass % or less, and more preferably 0.5 mass % or more and 1.0 mass % or less, based on a mass of the toner. In a case where the content of the inorganic infrared absorbent is 0.3 mass % or more, an invisible image is easily visualized when irradiated with infrared rays or ultraviolet rays, which is preferable. In addition, in a case where the content of the inorganic infrared absorbent is 1.0 mass % or less, the ratio of the toner particles in which the inorganic infrared absorbent particles are absent in the region from the surface of the toner particle to the depth of 50 nm from the surface of the toner particle is increased, and as a result, it is possible to form a high-definition image, which is preferable.

The following was found by studies conducted by the present inventors. That is, when the content of the inorganic infrared absorbent particles in the toner is 1.0 mass % or less with respect to the mass of the toner, it is easy to set the ratio of the toner particles in which the inorganic infrared absorbent particles are absent in the region from the surface of the toner particle to the depth of 50 nm from the surface of the toner particle to 60 number % or more. In general, when the toner is produced by a pulverization method, a large amount of the inorganic infrared absorbent particles are likely to be present on a pulverized interface, that is, the surface of the toner particle. However, the content of the inorganic infrared absorbent particle is 1.0 mass % or less, such that exposure of the inorganic infrared absorbent particles to the surface of the toner particle is suppressed to some extent even in a case where the toner is produced by the pulverization method.

Therefore, when the content of the inorganic infrared absorbent particle is 1.0 mass % or less, the heat spheroidizing treatment exemplified in (3) is also unnecessary even in a case where the toner is produced by the pulverization method. However, when the content of the inorganic infrared absorbent particle is 1.0 mass % or less, an infrared absorbance of the toner is relatively decreased. In the toner according to the present invention, the infrared absorbance of the toner is increased by controlling the coefficient of variation in number of the inorganic infrared absorbent particles (in a dispersion state in the toner), such that an adverse effect caused by a decrease in the infrared absorbance due to the low content is suppressed.

In spectrometry of a fixed image formed in a toner loading amount of 0.30 mg/cm, a maximum value of a light absorbance in a wavelength range of 900 nm or more and 1800 nm or less is preferably 25% or more. The wavelength range is a wavelength region corresponding to an infrared (near-infrared to short wavelength infrared) region. When the light absorbance is 25% or more, an invisible image can be clearly visualized when the invisible image is irradiated with infrared rays.

A means for setting the maximum value of the light absorbance of the toner in the wavelength range of 900 nm or more and 1800 nm or less to 25% or more is not particularly limited, and examples thereof can include the following means (1) to (3). (1) A method of using inorganic infrared absorbent particles having a number average particle diameter of primary particles of 0.5 μm or less as a raw material. (2) A method including a step of dispersing the inorganic infrared absorbent particles in a binder resin in a series of steps of producing a toner. (3) A method of suppressing an aggregation of the inorganic infrared absorbent particles in the toner production. These means may be used alone or in combination.

In spectrometry of an image formed by using the toner in a loading amount of 0.30 mg/cm², a maximum value of a light absorbance in a wavelength range of 200 nm or more and 350 nm or less is preferably 25% or more. The wavelength range is a wavelength region corresponding to an ultraviolet region. When the light absorbance is 25% or more, an invisible image can be clearly visualized when the invisible image is irradiated with ultraviolet rays.

A means for setting the maximum value of the light absorbance of the toner in the wavelength range of 200 nm or more and 350 nm or less to 25% or more is not particularly limited, and examples thereof can include the following means (1) to (3). (1) A method of using inorganic infrared absorbent particles having a number average particle diameter of primary particles of 0.5 μm or less as a raw material. (2) A method including a step of dispersing the inorganic infrared absorbent particles in a binder resin in a series of steps of producing a toner. (3) A method of suppressing an aggregation of the inorganic infrared absorbent particles in the toner production. These means may be used alone or in combination.

A volume resistivity of the toner is preferably 1.0×10¹² Ω·cm or more and 1.0×10¹⁷ Ω·cm or less. When the volume resistivity of the toner is within these ranges, charge is particularly preferably maintained, developability or transferability is excellent, and a high-definition image can be formed.

The toner can contain wax, if necessary, in a range in which the effects of the present invention are not impaired. The wax is not particularly limited, but colorless or light-colored wax is preferable. Known wax such as hydrocarbon wax, ester wax, amide wax, a higher aliphatic alcohol, or a higher fatty acid can be used as the wax. These waxes can be used alone or as a mixture.

The toner can contain a charge control agent, if necessary, in a range in which the effects of the present invention are not impaired. The charge control agent is not particularly limited, but a colorless or light-colored charge control agent is preferable. Examples of the charge control agent can include the following: known charge control agents such as aromatic oxycarboxylic acid, a metal compound of aromatic oxycarboxylic acid, a boron compound, a quaternary ammonium salt, calixarene, a resin having a sulfonic acid (salt) group, and a resin having a sulfonic acid ester group.

Various organic or inorganic fine powders may be externally added to the toner particle, if necessary. It is preferable that the organic or inorganic fine powder to be externally added has a particle diameter of 1/10 or less of a weight average particle diameter of the toner particles. The organic or inorganic fine powder is not particularly limited, but a known organic or inorganic fine powder such as silica, alumina, titanium oxide, strontium titanate, silicon nitride, polytetrafluoroethylene, or zinc stearate can be used. In addition, a surface of the organic or inorganic fine powder may be subjected to a hydrophobic treatment.

A weight average particle diameter (D4) of the toner is preferably 4.0 μm or more and 9.0 μm or less and more preferably 5.0 μm or more and 7.0 μm or less. Within these ranges, a high-definition image is easily formed.

A glass transition temperature of the toner is preferably 40° C. or higher and 80° C. or lower and more preferably 45° C. or higher and 65° C. or lower. Within these ranges, a balance between storage stability and fixability of the toner is excellent.

The toner can be used as a one-component developer, and the toner may be mixed with a carrier and used as a two-component developer.

For example, a magnetic particle formed of a known material such as a metal such as iron, ferrite, or magnetite, or an alloy of a metal such as aluminum or lead and the above metal can be used as the carrier. In addition, a coated carrier obtained by coating a surface of the carrier with a coating agent such as a resin or a resin dispersion type carrier in which magnetic particles are dispersed in a binder resin may be used. A volume average particle diameter of the carrier is preferably 15 μm or more and 100 μm or less and more preferably 25 μm or more and 80 μm or less.

Various physical properties are measured as follows.

<Method of Measuring Light Absorbance in Wavelength Range of 400 nm or More and 800 nm or Less>

A4 paper “Highly white paper GF-C081” (manufactured by Canon Inc.) is used as a recording material, and a 1 cm×10 cm rectangular unfixed image is formed on the paper so that the toner loading amount is 0.30 mg/cm². The unfixed image is allowed to stand in a natural convection type constant temperature dryer set at 110° C. for 3 minutes to fix the toner on the paper, thereby obtaining a sample image (fixed image).

The sample image is subjected to spectrometry measurement in a wavelength range of 400 nm or more and 800 nm or less using the following photometer.

Ultraviolet-visible near-infrared spectrophotometer “UV-3600” (manufactured by Shimadzu Corporation) equipped with an integrating sphere attachment “ISR-240A” (manufactured by Shimadzu Corporation).

A paper single body (paper on which an image is not formed) as blank is also subjected to the spectrometry measurement.

A value obtained by subtracting a measured value (light absorbance (%)) of the paper single body from a measured value (light absorbance (%)) of the sample image is defined as a light absorbance (%) for evaluating the toner in the present invention.

When the toner loading amount of the unfixed image formed on the paper is not exactly 0.30 mg/cm², the absorbance is calculated as follows.

An unfixed image having the toner loading amount in a range of 0.27 to 0.30 mg/cm² is formed and fixed to the paper by the above method to obtain a first sample image. In addition, an unfixed image is formed in the toner loading amount in a range of 0.30 to 0.33 mg/cm² and fixed to the paper by the above method to produce a second sample image. Then, each of the first sample image and the second sample image is subjected to the spectrometry measurement.

A value obtained by subtracting a measured value (light absorbance (%)) of the paper single body from a measured value (light absorbance (%)) of the first sample image is defined as a first light absorbance (%).

Similarly, a value obtained by subtracting a measured value (light absorbance (%)) of the paper single body from a measured value (light absorbance (%)) of the second sample image is defined as a second light absorbance (%).

The first light absorbance (%) and the second light absorbance (%) are plotted on an x-y plane with the toner loading amount on a horizontal axis and the light absorbance on a vertical axis. Then, these two points are connected by a straight line, and a value corresponding to 0.30 mg/cm² is defined as a light absorbance of an image having the toner loading amount of 0.30 mg/cm².

<Calculation Method of Coefficient of Variation in Number of Inorganic Infrared Absorbent Particles>

The toner is sufficiently dispersed in a photocurable adhesive “Aronix LCR series D-800 (visible light and ultraviolet curable type)”(manufactured by Toagosei Co., Ltd.) and then is irradiated with short wavelength ultraviolet rays to be cured. The obtained cured product is cut out with an ultramicrotome equipped with a diamond knife to produce a 250 nm thin-piece sample.

Next, the thin-piece sample is enlarged at a magnification of 40,000× using a transmission electron microscope “JEM-2800” equipped with an energy dispersive X-ray spectrometer (EDX) (manufactured by JEOL, Ltd.) to image a cross section of the toner particle. In addition, the inorganic infrared absorbent particle is identified by performing element mapping using the EDX.

The cross section image of the toner particle to be observed is selected as follows. First, a cross sectional area of the toner particle is calculated from the cross section image of the toner particle, and a diameter of a circle having the same area as the cross sectional area (equivalent circle diameter) is calculated. Only a cross section image of the toner particle whose absolute value of a difference between the equivalent circle diameter and the weight average particle diameter (D4) of the toner is within 1.0 μm is observed.

As for the cross section image of the toner particle to be targeted, as illustrated in FIG. 1, a cross section image of the toner particle is divided into four to obtain quadrants. That is, first, the center of gravity of the cross section image of the toner particle to be targeted is calculated, and a circle having the center of gravity as the center thereof and having a radius of 2.0 μm is drawn. Next, the circle is divided into four equal parts by diameters perpendicular to each other to obtain the quadrants.

Then, the number of the inorganic infrared absorbent particles observed in each quadrant is counted to calculate an average value (arithmetic average value) in each quadrant. In addition, a standard deviation of numbers of the inorganic infrared absorbent particles is calculated and the standard deviation is divided by the average value to calculate a coefficient of variation. In a case where the inorganic infrared absorbent particles aggregate, aggregate particles are counted as one particle.

This operation is performed on 100 toner particles to calculate 100 coefficients of variation, and an average value of the coefficients of variation is defined as a coefficient of variation in number of the inorganic infrared absorbent particles in the present invention.

<Method of Measuring Ratio of Toner Particles in which Inorganic Infrared Absorbent Particles are Absent in Region from Surface of Toner Particle to Depth of 50 nm from Surface of Toner Particle to all Toner Particles>

Whether or not the inorganic infrared absorbent particles are absent in the region from the surface of the toner particle to the depth of 50 nm from the surface of the toner particle in the cross section image of the toner particle used in the calculation of the coefficient of variation is observed over the entire perimeter. This operation is performed on 100 toner particles to calculate a ratio (number %) of the toner particles in which the inorganic infrared absorbent particles are absent in the region from the surface of the toner particle to the depth of 50 n from the surface of the toner particle. In a case where the inorganic infrared absorbent particles are present beyond a 50 nm boundary, it is considered that the particles are present in a region in which half or more than half of an area ratio is present.

<Method of Measuring Weight Average Particle Diameter (D4) of Toner Particles>

A weight average particle diameter (4) of the toner particles is calculated as follows.

As a measuring apparatus, a precise particle size distribution measuring apparatus “Coulter Counter Multisizer 3” (registered trademark, manufactured by Beckman Coulter, Inc.) equipped with a 100 μm aperture tube using a pore electrical resistance method is used. Attached dedicated software “Beckman Coulter Multisizer 3 Version 3.51” (manufactured by Beckman Coulter, Inc.) is used for setting of measurement conditions and analysis of measured data. The measurement is performed at 25,000 effective measuring channels.

As an electrolyte aqueous solution used for the measurement, an aqueous solution obtained by dissolving special grade sodium chloride in ion exchanged water so that a concentration thereof is about 1 mass %, for example, “ISOTON II” (manufactured by Beckman Coulter, Inc.) can be used.

Before the measurement and analysis, the dedicated software is set up as follows.

On a “Change standard measurement method (SOM)” screen of the dedicated software, a total count number of a control mode is set to 50,000 particles, the number of measurements is set to one time, and a Kd value is set to a value obtained by using “Standard particle of 10.0 μm” (manufactured by Beckman Coulter, Inc.). A threshold and a noise level are automatically set by pressing a “Threshold/noise level measurement button”. In addition, a check is entered at a “Flush of aperture tube after measurement” by setting a current, a gain, and an electrolyte solution to 1600 μA, 2, and ISOTON II, respectively.

On a “Conversion setting from pulse to particle diameter” screen of the dedicated software, a bin spacing is set to a logarithm particle diameter, a particle diameter bin is set to 256 particle diameter bin, and a particle diameter range is set to 2 μm to 60 μm.

A specific measurement method is as follows.

(1) About 200 mL of the electrolyte aqueous solution is placed into a 250 mL round-bottom glass beaker dedicated to Multisizer 3, the beaker is set in a sample stand, and stirring is performed with a stirrer rod counterclockwise at 24 rotations/sec. Then, dirt and air bubbles in the aperture tube are removed by a “Flush of aperture” function of the dedicated software.

(2) About 30 mL of the electrolyte aqueous solution is placed into a 100 mL flat-bottom glass beaker. About 0.3 mL of a diluted liquid obtained by diluting about 3 times by mass “Contaminon N” (10 mass % aqueous solution of pH 7 neutral detergent for cleaning a precision measurement instrument, the aqueous solution being formed of a nonionic surfactant, an anionic surfactant, and an organic builder, manufactured by Wako Pure Chemical Industries, Ltd.) with ion exchange water is added thereto as a dispersant.

(3) An ultrasonic dispersion machine “Ultrasonic Dispersion System Tetora 150” (manufactured by Nikkaki Bios Co., Ltd.) having an electric power of 120 W is prepared, the ultrasonic dispersion machine being equipped with two oscillators having an oscillation frequency of 50 kHz in a state in which a phase is shifted by 180 degrees. About 3.3 1 of ion exchange water is placed into a water bath of the ultrasonic dispersion machine, and about 2 mL of Contaminon N is added to the water bath.

(4) The beaker of (2) is set in a beaker fixing hole of the ultrasonic dispersion machine and the ultrasonic dispersion machine is operated. Then, a height position of the beaker is adjusted so that a resonance state of a liquid level of the electrolyte aqueous solution in the beaker is maximized.

(5) In a state in which the electrolyte aqueous solution in the beaker of (4) is irradiated with an ultrasonic wave, about 10 mg of the toner particles are added to little by little and dispersed in the electrolyte aqueous solution. Then, an ultrasonic dispersion process is further continued for 60 seconds. In the ultrasonic dispersion, a water temperature in the water bath is appropriately adjusted so that the temperature is 10° C. or higher and 40° C. or lower.

(6) The electrolyte aqueous solution of (5) in which the toner particles are dispersed is added dropwise using a pipette to the round-bottom beaker of (1) installed in the sample stand to adjust a measurement concentration to about 5%. Then, the measurement is performed until the number of measured particles reaches 50,000.

(7) Measured data are analyzed with the dedicated software attached to the apparatus to calculate the weight average particle diameter (D4). An “average diameter” on an “Analysis/volume statistical value (arithmetic average)” screen when graph/vol % is set with the dedicated software is the weight average particle diameter (D4).

<Method of Measuring Light Absorbance in Wavelength Range of 900 nm or More and 1800 nm or Less>

In the sample image obtained by using the method of measuring the light absorbance in the wavelength range of 400 nm or more and 800 nm or less, spectrometry measurement is performed in a wavelength range of 900 nm or more and 1800 nm or less using an ultraviolet-visible near-infrared spectrophotometer “MV-3300” (manufactured by JASCO Corporation). The paper single body is also subjected to the spectrometry measurement as a blank, and a reflectance (%) is calculated by subtracting a measured value of the paper single body from the measured value of the sample image. Then, a value obtained by subtracting the reflectance from 100 is defined as an absorbance (%).

<Method of Measuring Light Absorbance in Wavelength Range of 200 nm or More and 350 nm or Less>

In the sample image obtained by using the method of measuring the light absorbance in the wavelength range of 400 nm or more and 800 nm or less, spectrometry measurement is performed in a wavelength range of 200 nm or more and 350 nm or less using UV-3600 to which ISR-240A is attached. The paper single body is also subjected to the spectrometry measurement as a blank, and a value obtained by subtracting a measured value of the paper single body from the measured value of the sample image is defined as an absorbance (%).

<Method of Measuring Number Average Particle Diameter of Dispersion Diameter of Inorganic Infrared Absorbent Particles>

In the cross section image of the toner particle used in the calculation of the coefficient of variation, the longest diameter of all of the inorganic infrared absorbent particles in the toner is measured. This operation is performed on 100 toner particles to calculate a number average particle diameter. In a case where the inorganic infrared absorbent particles aggregate, the longest diameter of aggregate particles is measured and defined as a dispersion diameter.

<Method of Measuring Volume Resistivity of Toner>

A resistance measurement cell is filled with the toner, a lower electrode and an upper electrode are arranged to be in contact with the toner, a voltage is applied between these electrodes, and a current flowing at this time is measured, to calculate a volume resistivity (Ω·cm). Measurement conditions are as follows.

Contact area between filled toner and electrode: about 2.3 cm²
Thickness: about 0.5 mm
Load of upper electrode: 180 g
Applied voltage: 500 V

<Method of Measuring Content of Inorganic Infrared Absorbent Particle Contained in Toner>

A content (mass %) of the inorganic infrared absorbent particles contained in the toner is quantified by fluorescence X-ray analysis. The measurement is in accordance with JIS K 0119-1969, and specifically, is as follows.

As a measuring apparatus, a wavelength dispersion type fluorescence X-ray spectrometer “Axios” (manufactured by PANalytical B.V.) and attached dedicated software “SuperQ ver. 4.0 F” (manufactured by PANalytical B.V.) for measurement condition setting and measured data analysis are used. Rh is used as an anode for an X-ray tube bulb, a measurement atmosphere is vacuum, a measurement diameter (collimator mask diameter) is 27 mm, and a measurement time is 10 seconds. In addition, in a case where a light element is measured, detection is performed by a proportional counter (PC), and in a case where a heavy element is measured, detection is performed by a scintillation counter (SC).

Pellets molded into a thickness of 2 mm and a diameter of 39 mm are used as a measurement sample, the pellets being obtained by placing 4 g of a toner into a dedicated aluminum ring for pressing and leveling the toner and pressurizing the toner using a tablet molding compressor “BRE-32” (manufactured by Maekawa Testing Machine MFG. Co., LTD.) at 20 MPa for 60 seconds.

The measurement is performed under the above conditions, elements are identified based on peak positions of the obtained X-rays, and a counting rate (unit: kcps) which is the number of X-ray photons per unit time is measured.

Then, the content of the inorganic infrared absorbent particle contained in the toner is calculated by using a calibration curve separately created. When creating the calibration curve, a finely pulverized material of a styrene-based resin and a predetermine amount of the inorganic infrared absorbent particles are uniformly mixed with each other using a coffee mill, and pellets produced in the same manner as described above are used as a measurement sample.

According to the present invention, it is possible to provide a toner which is invisible under visible light and can form a high-definition image recognizable when irradiated with infrared rays.

### EXAMPLES

Hereinafter, the present invention will be described in more detail with reference to specific Production Examples, Examples, and Comparative Examples, and these Examples do not limit the technical scope of the present invention.

### Production Example 1 of Surface-Treated Tin-Doped Indium Oxide Particle

Styrene and tin-doped indium oxide particles (a molar ratio of indium to tin (In:Sn) 80:20, a number average particle diameter of primary particles: 40 nm) were stirred and mixed in amounts of 20.0 parts by mass and 10.0 parts by mass, respectively, to obtain a styrene dispersion of the tin-doped indium oxide particles. p-Styryltrimethoxysilane was added in an amount of 2.0 parts by mass while stirring the dispersion and stirring was performed at room temperature for 12 hours under a nitrogen atmosphere. Next, 0.1 parts by mass of 2,2′-azobisisobutyronitrile was added, and polymerization was performed at 90′C for 8 hours under a nitrogen atmosphere, thereby obtaining a mass A containing surface-treated tin-doped indium oxide particles. The obtained mass A was dissolved and dispersed in styrene over 6 hours using a desk-top type ultrasonic cleaner “W-113 SAMPA” (manufactured by HONDA ELECTRONICS Co., LTD.), and D50 was measured using a particle size analyzer “UPA-150EX” (manufactured by NIKKISO CO., LTD.). As a result, D50 was 312 nm. As measurement conditions of D50 (volume-based median diameter), SetZero was 30 s, the number of measurements was three times, a measurement time was 120 s, and a refractive index was 1.85.

### Production Example 2 of Surface-Treated Tin-Doped Indium Oxide Particle

A mass B containing surface-treated tin-doped indium oxide particles was obtained in the same manner as that of Production Example 1, except that tin-doped indium oxide particles in which the molar ratio of indium to tin (In:Sn) was 90:10 were used. As a result of measuring D50 (volume-based median diameter) after the treatment as in Production Example 1, D50 was 303 nm. Note that a number average particle diameter of primary particles of tin-doped indium oxide used in the production example before the treatment is 40 nm.

### Production Example 3 of Surface-Treated Tin-Doped Indium Oxide Particle

A mass C containing surface-treated tin-doped indium oxide particles was obtained in the same manner as that of Production Example 1, except that tin-doped indium oxide particles in which the molar ratio of indium to tin (In:Sn) was 70:30 were used. As a result of measuring D50 after the treatment as in Production Example 1, DSO was 314 nm. Note that a number average particle diameter of primary particles of tin-doped indium oxide used in the production example before the treatment is 40 nm.

### Example 1

### Production Example of Toner According to the Present Invention by Suspension Polymerization Method

<Step of Preparing Aqueous Medium>

Ion exchange water and sodium phosphate dodecahydrate were added to a reaction vessel in amounts of 1000.0 parts by mass and 14.0 parts by mass, respectively, and the mixture was kept warm at 65° C. for 1 hour while purging with nitrogen.

The mixture was stirred at 12000 rpm using a high speed stirrer “T.K. Homo Mixer” (manufactured by Tokushu Kika Kogyo Co., Ltd.). A calcium chloride aqueous solution obtained by dissolving 9.2 parts by mass of calcium chloride dihydrate in 20.0 parts by mass of ion exchange water was collectively added thereto, thereby preparing an aqueous medium containing a fine dispersion stabilizer.

<Step of Preparing Polymerizable Monomer Composition>

A mixture of 7.0 parts by mass of the mass A produced in Production Example 1 of the surface-treated tin-doped indium oxide particles and 123.0 parts by mass of styrene was added to a medium stirring type wet disperser “Attritor” (manufactured by Mitsui Miike Chemical Engineering Machinery, Co., Ltd.). Next, dispersion was performed at 220 rpm for 5 hours using zirconia beads having a diameter of 2 mm to obtain a dispersion liquid.

The following materials were added to a styrene dispersion liquid of the tin-doped indium oxide particles to obtain a mixture.

| | | |
|---|---|---|
| Styrene | 46.0 | parts by mass |
| n-Butyl acrylate | 34.0 | parts by mass |
| Aluminum salicylate compound | 1.0 | parts by mass |
| (BONTRON E-88, manufactured by Orient | | |
| Chemical Industries Co., Ltd.) | | |
| Saturated polyester | 5.0 | parts by mass |
| (Polycondensate of propylene oxide-moddied | | |
| bisphenol A and isophthalie acid, glass | | |
| transition temperature: 65° C., weight average | | |
| molecular weight: 10000, number average | | |
| molecular weight: 6000) | | |
| Ester wax | 10.0 | parts by mass |
| (Melting point: 73° C.) | | |
| Divinylbenzene: | 0.1 | parts by mass |

The mixture was kept warm at 65° C. and was uniformly dissolved and dispersed at 500 rpm using the T.K. Homo Mixer, thereby preparing a polymerizable monomer composition.

<Granulation Step>

A temperature of the aqueous medium containing the dispersion stabilizer was set to 70° C., the polymerizable monomer composition was added into the aqueous medium while keeping a rotation speed of the T.K. Homo Mixer at 12000 rpm, and 10.0 parts by mass of t-butyl peroxypivalate as a polymerization initiator was added. Thereafter, the resultant was granulated for 10 minutes while keeping the rotation speed at 12000 rpm.

<Polymerization Step>

After the granulation step, the stirrer was replaced with a propeller stirring blade, polymerization was performed for 5 hours while performing stirring at 150 rpm and maintaining the temperature at 70° C. the temperature was raised to 85° C., and heating was performed for 2 hours, thereby completing a polymerization reaction.

<Cleaning and Drying Step>

After completion of the polymerization step, a liquid temperature was cooled to room temperature, diluted hydrochloric acid was added to adjust a pH to 1.5. and then stirring was performed for 3 hours. Thereafter, filtering and cleaning were repeated to obtain a toner cake.

The obtained toner cake was pulverized and then dried with an airflow drier, and a fine powder was cut using a multi-division classifier using a Coanda effect, thereby obtaining toner particles 1 having a weight average particle diameter (D4) of 6.3 μm.

<External Addition Step>

The obtained toner particles 1 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using a high speed mixer “FM Mixer” (manufactured by Nippon Coke and Engineering Co., Ltd.), thereby obtaining a toner 1.

Analysis results of the toner 1 are shown in Table 1.

### Example 21

A toner 2 was obtained in the same manner as that of Example 1, except that the addition amount of the mass A produced in Production Example 1 of the surface-treated tin-doped indium oxide particles was 3.5 parts by mass.

### Example 3

A toner 3 was obtained in the same manner as that of Example 1, except that the addition amount of the mass A produced in Production Example 1 of the surface-treated tin-doped indium oxide particles was 21.0 parts by mass.

### Example 4

A toner 4 was obtained in the same manner as that of Example 1, except that the mass B produced in Production Example 2 of the surface-treated tin-doped indium oxide particles was used instead of the mass A produced in Production Example 1 of the surface-treated tin-doped indium oxide particles.

### Example 5

A toner 5 was obtained in the same manner as that of Example 1, except that the mass C produced in Production Example 3 of the surface-treated tin-doped indium oxide particles was used instead of the mass A produced in Production Example 1 of the surface-treated tin-doped indium oxide particles.

### Example 6

### Production Example of Toner According to the Present Invention by Pulverization Method/Heat Spheroidizing Treatment

<Step of Producing Masterbatch>

| | |
|---|---|
| Tin-doped indium oxide particle (untreated product) | 25.0 parts by mass |
| (Molar ratio of indium to tin (In:Sn) = 80:20, number | |
| average particle diameter of primary particles: 40 nm) | |
| Saturated polyester | 75.0 parts by mass |
| (Polycondensate of ethylene oxide-modified bisphenol | |
| A and terephthalic acid, glass transition | |
| temperature: 60° C.,weight average molecular weight: | |
| 29000, number average molecular weight: 6000) | |

The above materials were placed in a kneader, the temperature was raised to 120° C. while performing mixing, and the mixing was continued for 20 minutes. Thereafter, the mixture was kneaded with a two-roll mill heated to 110° C. for 30 minutes, a melt-kneaded material was spread on a water-cooled metal belt into a sheet shape and quenched, and the melt-kneaded material was coarsely pulverized to 1 mm or less with a hammermill, thereby obtaining a masterbatch.

<Step of Producing Toner Particle Precursor>

| | |
|---|---|
| The above masterbateh | 12.0 parts by mass |
| The above saturated polyester | 83.0 parts by mass |
| Ester wax | 5.0 parts by mass |

(Melting point: 7° C.)

The above materials were sufficiently mixed with each other using the FM Mixer (manufactured by Nippon Coke and Engineering Co., Ltd.), and then the mixture was melted and kneaded using a twin-screw kneader “PCM-30 type” (manufactured by Ikegai Corp.) of which a temperature was set to 130° C., thereby obtaining a kneaded material. The obtained kneaded material was spread on a water-cooled metal belt into a sheet shape and quenched, and then the kneaded material was coarsely pulverized to 1 mm or less with a hammermill, thereby obtaining a coarsely pulverized material. The obtained coarsely pulverized material was finely pulverized with a mechanical pulverizer “T-250” (manufactured by Freund-Turbo Corporation). Furthermore, classification was performed using a rotation type classifier “200TSP” (manufactured by HOSOKAWA MICRON CORP.), thereby obtaining a toner particle precursor 6 having a weight average particle diameter of 6.5 μm.

<Heat Spheroidizing Treatment Step>

Styrene acrylic resin fine particles (glass transition temperature: 60° C., number average particle diameter of primary particles: 70 nm) were added in an amount of 3.0 parts by mass to 100.0 parts by mass of the obtained toner particle precursor 6, and the styrene acrylic resin fine particles and the toner particle precursor 6 were sufficiently mixed with each other using the FM Mixer (manufactured by Nippon Coke and Engineering Co., Ltd.). Thereafter, a heat treatment was performed at a hot air temperature of 220° C. using a heat spheroidizing treatment apparatus illustrated in FIG. 2, thereby obtaining toner particles 6 having a weight average particle diameter of 6.7 μm.

<External Addition Step>

The obtained toner particles 6 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a toner 6.

### Example 7

A toner 7 was obtained in the same manner as that of Example 6, except that the addition amount of the styrene acrylic resin fine particles was 1.0 part by mass.

### Example 8

A toner 8 was obtained in the same manner as that of Example 6, except that the styrene acrylic resin fine particles were not added.

### Example 91

### Production Example of Toner According to the Present Invention by Pulverization Method without Performing Heat Spheroidizing Treatment

<Step of Producing Masterbatch>

| | |
|---|---|
| Tin-doped indium oxide particle (untreated product) | 25.0 parts by mass |
| (Molar ratio of indium to tin (In:Sn) = 80:20, number | |
| average particle diameter of primary panicles: 40 nm) | |
| Saturated polyester | 75.0 parts by mass |
| (Polycondensate of ethylene oxide-modified | |
| bisphenol A and terephtbalic acid, glass transition | |
| temperature: 60° C., weight average molecular weight: | |
| 29000, number average molecular weight: 6000) | |

The above materials were placed in a kneader, the temperature was raised to 120° C. while performing mixing, and the mixing was continued for 20 minutes. Thereafter, the mixture was kneaded with a two-roll mill heated to 110° C. for 30 minutes, a melt-kneaded material was spread on a water-cooled metal belt into a sheet shape and quenched, and the melt-kneaded material was coarsely pulverized to 1 mm or less with a hammermill, thereby obtaining a masterbatch.

<Step of Producing Toner Particle>

| | |
|---|---|
| The above masterbateh | 4.0 parts by mass |
| The above saturated polyester | 91.0 parts by mass |
| Ester wax | 5.0 parts by mass |

(Melting point: 73° C.)

The above materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was spread on a water-cooled metal belt into a sheet shape and quenched, and then the kneaded material was coarsely pulverized to 1 mm or less with a hammermill, thereby obtaining a coarsely pulverized material. The obtained coarsely pulverized material was finely pulverized with the T-250 (manufactured by Freund-Turbo Corporation). Furthermore, classification was performed using the 200TSP (manufactured by HOSOKAWA MICRON CORP.), thereby obtaining toner particles 9 having a weight average particle diameter of 6.3 μm.

<External Addition Step>

The obtained toner particles 9 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a toner 9.

### Example 10

A toner 10 was obtained in the same manner as that of Example 9, except that the addition amount of the masterbatch and the addition amount of the saturated polyester in the step of producing the toner particle were 8.0 parts by mass and 87.0 parts by mass, respectively.

### Comparative Example 1

| | |
|---|---|
| Tin-doped indium oxide particle (untreated product) | 40.0 parts by mass |
| (Molar ratio of indium to tin (In:Sn) = 80:20, number | |
| average particle diameter of primary particles: | |
| 1.2 um) | |
| Saturated polyester | 55.0 parts by mass |
| (Polycondensate of ethylene oxide-modified | |
| bisphenol A and terephthalic acid, glass transition | |
| temperature: 60° C., weight average molecular | |
| weight: 29000, number average molecular | |
| weight: 6000) | |
| Ester wax | 5.0 parts by pass |
| (Melting point: 73 C.) | |

The above raw materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was allowed to stand at room temperature and cooled, and the cooled kneaded material was coarsely pulverized to 1 mm or less with a hammermill, thereby obtaining a coarsely pulverized material. The obtained coarsely pulverized material was finely pulverized with a collision type airflow pulverizer. Furthermore, classification was performed using the 200TSP (manufactured by HOSOKAWA MICRON CORP.), thereby obtaining comparative toner particles 1 having a weight average particle diameter of 6.5 μm.

The obtained comparative toner particles 1 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a comparative toner 1.

### Comparative Example 2

A comparative toner 2 was obtained in the same manner as that of Comparative Example 1 except that the following raw materials were used.

| | |
|---|---|
| Tin-doped iridium oxide particle (untreated product) | 3.0 parts by |
| (Molar ratio of indium to tin (In:Sn) = 80:20, number | mass |
| average particle diameter of primary particles: 40 nm) | |
| Saturated polyester | 92.0 parts by |
| (Polyeondensate of ethylene oxide-modified bisphenol A | mass |
| and terephthalic acid, glass transition temperature: 60° C., | |
| weight average molecular weight: 29000, number average | |
| molecular weight: 6000) | |
| Ester wax | 5.0 parts by |
| (Melting point: 73° C.) | mass |

Physical properties of each of the toners 1 to 10 and the comparative toners 1 and 2 are shown in Table 1.

TABLE 1

| | A | B | C | D | E | F | G | H |
|---|---|---|---|---|---|---|---|---|
| Toner 1 | 5 | 0.33 | 100 | 38 | 65 | 0.12 | 7.2 × 10¹³ | 1.0 |
| Toner 2 | 3 | 0.26 | 100 | 25 | 55 | 0.12 | 5.0 × 10¹⁴ | 0.5 |
| Toner 3 | 7 | 0.28 | 90 | 60 | 75 | 0.12 | 4.6 × 10¹² | 3.0 |
| Toner 4 | 5 | 0.32 | 100 | 40 | 66 | 0.12 | 7.5 × 10¹³ | 1.0 |
| Toner 5 | 5 | 0.30 | 100 | 40 | 65 | 0.12 | 7.8 × 10¹³ | 1.0 |
| Toner 6 | 7 | 0.23 | 90 | 60 | 70 | 0.09 | 8.8 × 10¹² | 3.0 |
| Toner 7 | 7 | 0.23 | 70 | 58 | 75 | 0.09 | 4.3 × 10¹² | 3.0 |
| Toner 8 | 7 | 0.23 | 60 | 60 | 75 | 0.09 | 2.6 × 10¹² | 3.0 |
| Toner 9 | 5 | 0.21 | 70 | 42 | 67 | 0.07 | 1.0 × 10¹⁴ | 1.0 |
| Toner 10 | 6 | 0.21 | 55 | 52 | 70 | 0.07 | 1.2 × 10¹² | 2.0 |
| Comparative | 10 | 0.93 | 20 | 10 | 15 | 1.2 | 3.0 × 10¹⁰ | 40 |
| Toner 1 | | | | | | | | |
| Comparative | 7 | 0.65 | 40 | 20 | 20 | 0.51 | 6.2 × 10¹⁰ | 3.0 |
| Toner 2 | | | | | | | | |

A: Maximum value %) of light absorbance in wavelength range of 400 nm or more and 800 nm or less in spectrometry of image formed by using toner in loading amount of 0.30 mg/cm²

B: Coefficient of variation in number of inorganic infrared absorbent particles observed in region obtained by dividing circle having center of gravity of cross section image of toner particle as center thereof and having radius of 2.0 μm into four in cross section observation of toner particle

C: Ratio (number %) of toner particles in which inorganic infrared absorbent particles are absent from surface of toner particle to depth of 50 nm from surface of toner particle

D: Maximum value (%) of light absorbance in wavelength range of 900 nm or more and 1800 nm or less in spectrometry of image formed by using toner in loading amount of 0.30 mg/cm²

E: Maximum value (%) of light absorbance in wavelength range of 200 nm or more and 350 nm or less in spectrometry of image formed by using toner in loading amount of 0.30 mg/cm²

F: Number average particle diameter (μm) of dispersion diameter of inorganic infrared absorbent particles

G: Volume resistivity (Ω·cm) of toner

H: Content of inorganic infrared absorbent particles contained in toner (mass % based on mass of toner)

[Evaluation of Toners 1 to 10 and Comparative Toners 1 and 2 According to the Present Invention]

### Evaluation Example 1

A color printer “LBP652C” (manufactured by Canon Inc.) modified so that a development contrast can be freely changed was used as an image forming apparatus. A toner in a black developer of the LBP652C was replaced with the toner 1 and the toner was evaluated. A4 paper “Highly white paper GF-C081” (manufactured by Canon Inc.) was used as printing paper, and an image was printed under an environment of a temperature of 25° C. and a relative humidity of 60%.

A thin line image (the number of lines: 20, line width: 100 μm, interval: 500 μm, line length: 20 mm) was formed in the central portion of the A4 paper using the black developer. Next, a yellow solid image was formed to shield the thin line image using the A4 paper on which the thin line image was formed and a yellow developer, thereby obtaining an evaluation image 1.

The central portion of the obtained evaluation image 1 was observed with a loupe at a magnification of 15×. As a result, the presence of the thin line image formed by using the toner 1 was not recognized.

Next, a light source 202 and a camera 203 were installed as illustrated in FIG. 3, and the evaluation image 1 (201 of FIG. 3) was observed. That is, the evaluation image 1 was placed on a desk, and the evaluation image 1 was irradiated with infrared rays using a halogen lamp (light source 202) at a position distant from the evaluation image 1 by about 1 m at an angle of 15°. A halogen lamp light source “PCS-UHX-150” (manufactured by NIPPON P⋅I CO., LTD.) to which a visible light cut filter unit was attached was used as the halogen lamp.

A near-infrared camera was installed at a position corresponding to 15 cm directly above the evaluation image 1, and the evaluation image 1 was captured. A near-infrared camera “NVU3VD” (manufactured by IRspec Corporation) having a lens part equipped with a filter that cuts a wavelength component of 800 nm or less was used as the near-infrared camera. A spectral sensitivity wavelength region of the NVU3VD was 970 to 1650 nm. The captured image was displayed on a display and evaluated based on the following evaluation criteria. As a result, image quality of the evaluation image 1 was A rank.

The toners 2 to 10 and the comparative toners 1 and 2 were also evaluated in the same manner as that of Evaluation Example 1. The evaluation results are shown in Table 2.

<Evaluation Criteria>

For 20 thin lines formed on the central portion of the evaluation image 1, the number of the thin lines that can be clearly visualized without disconnection over the entire length were counted and evaluated based on the following criteria.

A: 20 lines (the evaluation image is an extremely high-definition image and can sufficiently correspond to security purposes)
B: 16 to 19 lines (the evaluation image is a high-definition image and can correspond to security purposes)
C: 13 to 15 lines (the evaluation image has high image quality, but may not correspond to security purposes)
D: 12 lines or less (the evaluation image is unsuitable for security purposes)

### Evaluation Example 2

A text image (a sentence consisting of about 100 characters of Hiragana) with a font size of 10 points was formed on A4 paper “Highly white paper GF-C081” (manufactured by Canon Inc.) using the image forming apparatus and the black developer that were used in Evaluation Example 1, thereby obtaining an evaluation image 2.

The obtained evaluation image 2 was visually observed. As a result, the presence of the text image formed by using the toner 1 was not recognized.

Next, as a result of irradiating the evaluation image 2 with ultraviolet rays using an ultraviolet lamp, the text image was clearly recognized, and thus, the sentence was deciphered. An ultraviolet lamp “Handy UV lamp SUV-4” (manufactured by AS ONE Corporation) that can perform irradiation with ultraviolet rays with a wavelength of 254 nm was used as the ultraviolet lamp.

The toners 2 to 10 and the comparative toners 1 and 2 were also evaluated in the same manner as that of Evaluation Example 2. The evaluation results are shown in Table 3.

In Table 3, “Characters cannot be recognized” means that “the lines constituting the characters cannot be seen at all”, and “Characters can be clearly recognized” means that “all 100 characters out of the 100 characters can be easily recognized”. In addition, in Table 3, “Characters cannot be determined” means that “none of the 100 characters can be recognized”. Furthermore, “Some of characters cannot be determined” means that “some of the 100 characters can be recognized, but the rest of the characters cannot be recognized”.

### Evaluation Example 3

The evaluation images 1 and 2 were allowed to stand at a sunny window for one month. Thereafter, the images were evaluated in the same manner as those of Evaluation Examples 1 and 2. As a result, in all of the toners 1 to 10 and the comparative toners 1 and 2, no change in visibility of the image or the like was observed as compared with one month ago.

TABLE 2

| | | Image quality rank |
|---|---|---|
| | | (number of thin lines) |
| | Observation using loupe | of thin line image |
| Toner 1 | Thin line image cannot be | A (20 lines) |
| | recognized | |
| Toner 2 | Thin line image cannot be | B (18 lines) |
| | recognized | |
| Toner 3 | Thin line image cannot be | A (20 lines) |
| | recognized | |
| Toner 4 | Thin line image cannot be | A (20 lines) |
| | recognized | |
| Toner 5 | Thin line image cannot be | A (20 lines) |
| | recognized | |
| Toner 6 | Thin line image cannot be | A (20 lines) |
| | recognized | |
| Toner 7 | Thin line image cannot be | B (18 lines) |
| | recognized | |
| Toner 8 | Thin line image cannot be | B (17 lines) |
| | recognized | |
| Toner 9 | Thin line image cannot be | B (19 lines) |
| | recognized | |
| Toner 10 | Thin line image cannot be | B (16 lines) |
| | recognized | |
| Comparative Toner 1 | Thin line image cannot be | D (8 lines) |
| | recognized | |
| Comparative Toner 2 | Thin line image cannot be | D (12 lines) |
| | recognized | |

TABLE 3

| | Visual observation | Observation in ultraviolet irradiation |
|---|---|---|
| Toner 1 | Characters cannot be | Characters can be clearly recognized |
| | recognized | |
| Toner 2 | Characters cannot be | Characters can be clearly recognized |
| | recognized | |
| Toner 3 | Characters cannot be | Characters can be clearly recognized |
| | recognized | |
| Toner 4 | Characters cannot be | Characters can be clearly recognized |
| | recognized | |
| Toner 5 | Characters cannot be | Characters can be clearly recognized |
| | recognized | |
| Toner 6 | Characters cannot be | Characters can be clearly recognized |
| | recognized | |
| Toner 7 | Characters cannot be | Characters can be clearly recognized |
| | recognized | |
| Toner 8 | Characters cannot be | Characters can be clearly recognized |
| | recognized | |
| Toner 9 | Characters cannot be | Characters can be clearly recognized |
| | recognized | |
| Toner 10 | Characters cannot be | Characters can be clearly recognized |
| | recognized | |
| Comparative | Characters cannot be | Characters can be clearly recognized |
| Toner 1 | recognized | |
| Comparative | Characters cannot be | Some of characters cannot be |
| Toner 2 | recognized | determined |

### Example 11

### Production Example of Toner According to the Present Invention by Pulverization Method/Heat Spheroidizing Treatment

<Step of Producing Masterbatch>

| | |
|---|---|
| Antimony-doped tin oxide particle (untreated product) | 30.0 parts by |
| | mass |

(Molar ratio of tin to antimony (Sn:Sb) = 90:10 number average
particle diameter of primary particles: 50 nm)

| | |
|---|---|
| Saturated polyester | 70.0 parts by |
| | mass |

(Polycondensate of ethylene oxide-modified bisphenol A and terephthalic
acid, glass transition temperature: 60° C., weight average molecular weight,
29000, number average molecular weight: 6000)

The above materials were placed in a kneader, the temperature was raised to 110° C. while performing mixing, and the mixing was continued for 20 minutes. Thereafter, the mixture was kneaded with a two-roll mill heated to 10° C. for 30 minutes, a melt-kneaded material was spread on a water-cooled metal belt into a sheet shape and quenched, and the melt-kneaded material was coarsely pulverized to 1 mm or less with a hammermill, thereby obtaining a masterbatch.

<Step of Producing Toner Particle Precursor>

| | |
|---|---|
| The above masterbatch | 3.0 parts by mass |
| The above saturated polyester | 92.0 parts by mass |
| Ester wax | 5.0 parts by mass |
| (Melting point: 73° C.) | |

The above materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was spread on a water-cooled metal belt into a sheet shape and quenched, and then the kneaded material was coarsely pulverized to 1 mm or less with a hammermill, thereby obtaining a coarsely pulverized material. The obtained coarsely pulverized material was finely pulverized with the T-250 (manufactured by Freund-Turbo Corporation). Furthermore, classification was performed using the 200TSP (manufactured by HOSOKAWA MICRON CORP.), thereby obtaining a toner particle precursor 11 having a weight average particle diameter of 5.8 μm.

<Heat Spheroidizing Treatment Step>

Styrene acrylic resin fine particles (glass transition temperature: 60° C., number average particle diameter of primary particles: 70 nm) were added in an amount of 3.0 parts by mass to 100.0 parts by mass of the obtained toner particle precursor 11, and the styrene acrylic resin fine particles and the toner particle precursor 11 were sufficiently mixed with each other using the FM Mixer (manufactured by Nippon Coke and Engineering Co., Ltd.). Thereafter, a heat treatment was performed at a hot air temperature of 220° C. using a heat spheroidizing treatment apparatus illustrated in FIG. 2, thereby obtaining toner particles 11 having a weight average particle diameter of 5.9 μm.

<External Addition Step>

The obtained toner particles 11 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a toner 11.

### Example 12

A toner 12 was obtained in the same manner as that of Example 11, except that the addition amount of the masterbatch and the addition amount of the saturated polyester in the step of producing the toner particle precursor were 1.5 parts by mass and 93.5 parts by mass, respectively.

### Example 13

A toner 13 was obtained in the same manner as that of Example 11, except that the addition amount of the masterbatch and the addition amount of the saturated polyester in the step of producing the toner particle precursor were 9.0 parts by mass and 86.0 parts by mass, respectively.

### Example 141

A toner 14 was obtained in the same manner as that of Example 11, except that the addition amount of the styrene acrylic resin fine particles was 1.0 part by mass.

### Example 151

A toner 15 was obtained in the same manner as that of Example 11, except that the styrene acrylic resin fine particles were not added.

### Example 161

### Production Example of Toner According to the Present Invention by Pulverization Method without Performing Heat Spheroidizing Treatment

<Step of Producing Masterbatch>

| Antimony-doped tin oxide particle | 30.0 parts by |
|---|---|
| (untreated product) | mass |
| (Molar ratio of tin to antimony (Sn:Sb) = 90:10, number average | |
| particle diameter of primary particles: 50 nm) | |
| Saturated polyester | 70.0 parts by |
| | mass |

(Polycondensate of ethylene oxide-modified bisphenol A and
terephthalic acid, glass transition temperature: 60° C., weight average
molecular weight: 29000, number average molecular weight: 6000)

The above materials were placed in a kneader, the temperature was raised to 110° C. while performing mixing, and the mixing was continued for 20 minutes. Thereafter, the mixture was kneaded with a two-roll mill heated to 110° C. for 30 minutes, a melt-kneaded material was spread on a water-cooled metal belt into a sheet shape and quenched, and the melt-kneaded material was coarsely pulverized to 1 mm or less with a hammermill, thereby obtaining a masterbatch.

<Step of Producing Toner Particle>

| | |
|---|---|
| The above masterbatch | 3.0 parts by mass |
| The above saturated polyester | 92.0 parts by mass |
| Ester wax | 5.0 parts by mass |
| (Melting point 73° C.) | |

The above materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was spread on a water-cooled metal belt into a sheet shape and quenched, and then the kneaded material was coarsely pulverized to 1 mm or less with a hammermill, thereby obtaining a coarsely pulverized material. The obtained coarsely pulverized material was finely pulverized with the T-250 (manufactured by Freund-Turbo Corporation). Furthermore, classification was performed using the 200TSP (manufactured by HOSOKAWA MICRON CORP.), thereby obtaining toner particles 16 having a weight average particle diameter of 5.9 μm.

<External Addition Step>

The obtained toner particles 16 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a toner 16.

### Example 17

A toner 17 was obtained in the same manner as that of Example 16, except that the addition amount of the masterbatch and the addition amount of the saturated polyester in the step of producing the toner particle were 6.0 parts by mass and 89.0 parts by mass, respectively.

### Example 18

A toner 18 was obtained in the same manner as that of Example 16, except that a kneading time with a two-roll mill in the step of producing the masterbatch was set to 3 minutes.

### Comparative Example 3

| | |
|---|---|
| Antimony-doped tin oxide particle (untreated product) | 3.0 parts by mass |

(Molar ratio of tin to antimony (Sn:Sb) = 90:10, number
average particle diameter of primary particles: 50 nm)

| | |
|---|---|
| Saturated polyester | 92.0 parts by mass |

(Polycondensate of ethylene oxide-modified bisphenol A
and terephthalic acid, glass transition temperature; 60° C., weight average
molecular weight: 29000, number average molecular weight: 6000)

| | |
|---|---|
| Ester wax | 5.0 parts by mass |
| Melting point: 73° C.) | |

The above raw materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was allowed to stand at room temperature and cooled, and the cooled kneaded material was coarsely pulverized to 1 mm or less with a hammermill, thereby obtaining a coarsely pulverized material. The obtained coarsely pulverized material was finely pulverized with a collision type airflow pulverizer. Furthermore, classification was performed using the 200TSP (manufactured by HOSOKAWA MICRON CORP.), thereby obtaining comparative toner particles 3 having a weight average particle diameter of 6.0 μm.

The obtained comparative toner particles 3 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a comparative toner 3.

TABLE 4

| | A | B | C | D | E | F | G | H |
|---|---|---|---|---|---|---|---|---|
| Toner 11 | 5 | 0.22 | 90 | 40 | 65 | 0.07 | 9.5 × 10¹³ | 0.9 |
| Toner 12 | 3 | 0.23 | 90 | 25 | 55 | 0.07 | 8.5 × 10¹⁴ | 0.5 |
| Toner 13 | 7 | 0.24 | 90 | 60 | 75 | 0.07 | 1.1 × 10¹³ | 2.7 |
| Toner 14 | 5 | 0.22 | 85 | 42 | 65 | 0.07 | 6.5 × 10¹³ | 0.9 |
| Toner 15 | 5 | 0.22 | 80 | 42 | 65 | 0.07 | 3.7 × 10¹³ | 0.9 |
| Toner 16 | 5 | 0.22 | 70 | 42 | 65 | 0.07 | 9.3 × 10¹² | 0.9 |
| Toner 17 | 7 | 0.24 | 55 | 53 | 72 | 0.07 | 2.6 × 10¹² | 1.8 |
| Toner 18 | 5 | 0.41 | 50 | 25 | 42 | 0.23 | 7.2 × 10¹¹ | 0.9 |
| Comparative | 7 | 0.64 | 40 | 19 | 22 | 0.61 | 9.5 × 10¹⁰ | 3.0 |
| Toner 3 | | | | | | | | |

A: Maximum value (%) of light absorbance in wavelength range of 400 nm or more and 800 nm or less in spectrometry of image formed by using toner in loading amount of 0.30 mg/cm²

B: Coefficient of variation in number of inorganic infrared absorbent particles observed in region obtained by dividing circle having center of gravity of cross section image of toner particle as center thereof and having radius of 2.0 μm into four in cross section observation of toner particle

C: Ratio (number %) of toner particles in which inorganic infrared absorbent particles are absent from surface of toner particle to depth of 50 nm from surface of toner particle

D: Maximum value (%) of light absorbance in wavelength range of 900 nm or more and 1800 nm or less in spectrometry of image formed by using toner in loading amount of 0.30 mg/cm²

E: Maximum value (%) of light absorbance in wavelength range of 200 nm or more and 350 nm or less in spectrometry of image formed by using toner in loading amount of 0.30 mg/cm²

F: Number average particle diameter (μm) of dispersion diameter of inorganic infrared absorbent particles

G: Volume resistivity (Ω·cm) of toner

H: Content of inorganic infrared absorbent particles contained in toner (mass % based on mass of toner)

[Evaluation of Toners 11 to 18 and Comparative Toner 3 According to the Present Invention]

### Evaluation Example 4

The toners 11 to 18 and the comparative toner 3 were evaluated in the same manner as that of Evaluation Example 1. The evaluation results are shown in Table S.

### Evaluation Example 5

The toners 11 to 18 and the comparative toner 3 were evaluated in the same manner as that of Evaluation Example 2. The evaluation results are shown in Table 6.

### Evaluation Example 6

The toners 11 to 18 and the comparative toner 3 were evaluated in the same manner as that of Evaluation Example 3. As a result, in all of the toners 11 to 18 and the comparative toner 3, no change in visibility of the image or the like was observed as compared with one month ago.

TABLE 5

| | | Image quality rank (number of |
|---|---|---|
| | Observation using loupe | thin lines) of thin line image |
| Toner 11 | Thin line image cannot be recognized | A (20 lines) |
| Toner 12 | Thin line image cannot be recognized | B (18 lines) |
| Toner 13 | Thin line image cannot be recognized | A (20 lines) |
| Toner 14 | Thin line image cannot be recognized | A (20 lines) |
| Toner 15 | Thin line image cannot be recognized | B (19 lines) |
| Toner 16 | Thin line image cannot be recognized | B (18 lines) |
| Toner 17 | Thin line image cannot be recognized | B (17 lines) |
| Toner 18 | Thin line image cannot be recognized | B (16 lines) |
| Comparative Toner 3 | Thin line image cannot be recognized | D (10 lines) |

TABLE 6

| | Visual observation | Observation in ultraviolet irradiation |
|---|---|---|
| Toner 11 | Characters cannot be | Characters can be clearly recognized |
| | recognized | |
| Toner 12 | Characters cannot be | Characters can be clearly recognized |
| | recognized | |
| Toner 13 | Characters cannot be | Characters can be clearly recognized |
| | recognized | |
| Toner 14 | Characters cannot be | Characters can be clearly recognized |
| | recognized | |
| Toner 15 | Characters cannot be | Characters can be clearly recognized |
| | recognized | |
| Toner 16 | Characters cannot be | Characters can be clearly recognized |
| | recognized | |
| Toner 17 | Characters cannot be | Characters can be clearly recognized |
| | recognized | |
| Toner 18 | Characters cannot be | Characters can be clearly recognized |
| | recognized | |
| Comparative | Characters cannot be | Some of characters cannot be |
| Toner 3 | recognized | determined |

### Example 191

### Production Example of Toner According to the Present Invention by Pulverization Method/Heat Spheroidizing Treatment

<Step of Producing Masterbatch>

| | |
|---|---|
| Cesium-doped tungsten oxide particle | 20.0 parts by mass |
| (untreated product) | |

(Molar ratio of tungsten to cesium (W:Cs) = 75:25,
number average particle diameter of primary particles: 50 nm)

| | |
|---|---|
| Saturated polyester | 80.0 parts by mass |

(Polycondensate of ethylene oxide-modified bisphenol A
and terephthalic acid, glass transition temperature: 60° C., weight average
molecular weight: 29000, number average molecular weight: 6000)

The above materials were placed in a kneader, the temperature was raised to 110° C. while performing mixing, and the mixing was continued for 20 minutes. Thereafter, the mixture was kneaded with a two-roll mill heated to 110° C. for 30 minutes, a melt-kneaded material was spread on a water-cooled metal belt into a sheet shape and quenched, and the melt-kneaded material was coarsely pulverized to 1 mm or less with a hammermill, thereby obtaining a masterbatch.

<Step of Producing Toner Particle Precursor>

| | |
|---|---|
| The above masterbatch | 3.0 parts by mass |
| The above saturated polyester | 92.0 parts by mass |
| Ester wax | 5.0 parts by mass |
| (Melting point: 73° C.) | |

The above materials were sufficiently mixed with each other using the FM Mixer, and then the mixture was melted and kneaded using the PCM-30 type (manufactured by Ikegai Corp.) of which a temperature was set to 130° C., thereby obtaining a kneaded material. The obtained kneaded material was spread on a water-cooled metal belt into a sheet shape and quenched, and then the kneaded material was coarsely pulverized to 1 mm or less with a hammermill, thereby obtaining a coarsely pulverized material. The obtained coarsely pulverized material was finely pulverized with the T-250 (manufactured by Freund-Turbo Corporation). Furthermore, classification was performed using the 200TSP (manufactured by HOSOKAWA MICRON CORP.), thereby obtaining a toner particle precursor 19 having a weight average particle diameter of 6.2 μm.

<Heat Spheroidizing Treatment Step>

Styrene acrylic resin fine particles (glass transition temperature: 60° C., number average particle diameter of primary particles: 70 nm) were added in an amount of 3.0 parts by mass to 100.0 parts by mass of the obtained toner particle precursor 19, and the styrene acrylic resin fine particles and the toner particle precursor 19 were sufficiently mixed with each other using the FM Mixer (manufactured by Nippon Coke and Engineering Co., Ltd.). Thereafter, a heat treatment was performed at a hot air temperature of 220° C. using a heat spheroidizing treatment apparatus illustrated in FIG. 2, thereby obtaining toner particles 19 having a weight average particle diameter of 6.2 μm.

<External Addition Step>

The obtained toner particles 19 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a toner 19.

### Example 20

A toner 20 was obtained in the same manner as that of Example 19, except that the addition amount of the masterbatch and the addition amount of the saturated polyester in the step of producing the toner particle precursor were 1.5 parts by mass and 93.5 parts by mass, respectively.

### Example 21

A toner 21 was obtained in the same manner as that of Example 19, except that the addition amount of the masterbatch and the addition amount of the saturated polyester in the step of producing the toner particle precursor were 6.0 parts by mass and 89.0 parts by mass, respectively.

### Example 22

A toner 22 was obtained in the same manner as that of Example 19, except that the addition amount of the styrene acrylic resin fine particles was 1.0 part by mass.

### Example 23

A toner 23 was obtained in the same manner as that of Example 19, except that the styrene acrylic resin fine particles were not added.

### Example 24

### Production Example of Toner According to the Present Invention by Pulverization Method without Performing Heat Spheroidizing Treatment

<Step of Producing Masterbatch>

| | |
|---|---|
| Cesium-doped tungsten oxide particle | 20.0 parts by mass |
| (untreated product) | |

(Molar ratio of tungsten to cesium (W:Cs) = 75:25,
number average particle diameter of primary particles: 50 nm)

| | |
|---|---|
| Saturated polyester | 80.0 parts by mass |

(Polycondensate of ethylene oxide-modified bisphenol A and
terephthalic acid, glass transition temperature: 60° C., weight average
molecular weight: 29000, number average molecular weight: 6000)

The above materials were placed in a kneader, the temperature was raised to 110° C. while performing mixing, and the mixing was continued for 20 minutes. Thereafter, the mixture was kneaded with a two-roll mill heated to 110° C. for 30 minutes, a melt-kneaded material was spread on a water-cooled metal belt into a sheet shape and quenched, and the melt-kneaded material was coarsely pulverized to 1 mm or less with a hammermill, thereby obtaining a masterbatch.

<Step of Producing Toner Particle>

| | |
|---|---|
| The above masterbatch | 3.0 parts by mass |
| The above saturated polyester | 92.0 parts by mass |
| Ester wax | 5.0 parts by mass |
| (Melting point: 73° C.) | |

The above materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was spread on a water-cooled metal belt into a sheet shape and quenched, and then the kneaded material was coarsely pulverized to 1 mm or less with a hammermill, thereby obtaining a coarsely pulverized material. The obtained coarsely pulverized material was finely pulverized with the T-250 (manufactured by Freund-Turbo Corporation). Furthermore, classification was performed using the 200TSP (manufactured by HOSOKAWA MICRON CORP.), thereby obtaining toner particles 24 having a weight average particle diameter of 5.9 rm.

<External Addition Step>

The obtained toner particles 24 and a hydrophobic silica fine powder (number average particle diameter of primary particles: 7 nm) subjected to a surface treatment with hexamethyldisilazane were mixed with each other in amounts 100.0 parts by mass and 1.0 part by mass, respectively, using the FM Mixer (manufactured by Nippon Coke and Engineering Co., Ltd.), thereby obtaining a toner 24.

### Example 25

A toner 25 was obtained in the same manner as that of Example 19, except that a kneading time with a two-roll mill in the step of producing the masterbatch was set to 3 minutes.

### Comparative Example 4

A comparative toner 4 was obtained in the same manner as that of Example 19, except that the addition amount of the masterbatch and the addition amount of the saturated polyester in the step of producing the toner particle precursor were 12.0 parts by mass and 83.0 parts by mass, respectively.

### Comparative Example 51

| | |
|---|---|
| Cesium-doped tungsten oxide particle | 1.0 part by mass |

(untreated product)
(Molar ratio of tungsten to cesium (W:Cs) = 75:25,
number average particle diameter of primary particles: 50 nm)

| | |
|---|---|
| Saturated polyester | 94.0 parts by mass |

(Polycondensate of ethylene oxide-modified bisphenol A and
terephthalic acid, glass transition temperature: 60° C., weight average
molecular weight: 29000, number average molecular weight: 6000)

| | |
|---|---|
| Ester wax | 5.0 parts by mass |
| Melting point: 73° C.) | |

The above raw materials were sufficiently mixed with each other using the FM Mixer (manufactured by Nippon Coke and Engineering Co., Ltd.), and then the mixture was melted and kneaded using the PCM-30 type (manufactured by Ikegai Corp.) of which a temperature was set to 130° C., thereby obtaining a kneaded material. The obtained kneaded material was allowed to stand at room temperature and cooled, and the cooled kneaded material was coarsely pulverized to 1 mm or less with a hammermill, thereby obtaining a coarsely pulverized material. The obtained coarsely pulverized material was finely pulverized with a collision type airflow pulverizer. Furthermore, classification was performed using the 200TSP (manufactured by HOSOKAWA MICRON CORP.), thereby obtaining comparative toner particles 5 having a weight average particle diameter of 6.0 μm.

The obtained comparative toner particles 5 and a hydrophobic silica fine powder (number average particle diameter of primary particles: 7 nm) subjected to a surface treatment with hexamethyldisilazane were mixed with each other in amounts of 100.0 parts by mass and 1.0 part by mass, respectively, using the FM Mixer (manufactured by Nippon Coke and Engineering Co., Ltd.), thereby obtaining a comparative toner 5.

TABLE 7

| | A | B | C | D | E | F | G | H |
|---|---|---|---|---|---|---|---|---|
| Toner 19 | 5 | 0.22 | 90 | 40 | 65 | 0.07 | 5.5 × 10¹⁴ | 0.6 |
| Toner 20 | 3 | 0.23 | 90 | 25 | 45 | 0.07 | 9.2 × 10¹⁴ | 0.3 |
| Toner 21 | 9 | 0.23 | 90 | 55 | 75 | 0.07 | 7.5 × 10¹³ | 1.2 |
| Toner 22 | 5 | 0.24 | 85 | 40 | 65 | 0.07 | 9.8 × 10¹³ | 0.6 |
| Toner 23 | 5 | 0.22 | 80 | 40 | 65 | 0.07 | 2.3 × 10¹³ | 0.6 |
| Toner 24 | 5 | 0.22 | 70 | 40 | 65 | 0.07 | 7.3 × 10¹² | 0.6 |
| Toner 25 | 5 | 0.43 | 60 | 25 | 40 | 0.25 | 1.2 × 10¹² | 0.6 |
| Comparative | 12 | 0.26 | 85 | 65 | 75 | 0.08 | 1.8 × 10¹³ | 2.4 |
| Toner 4 | | | | | | | | |
| Comparative | 8 | 0.55 | 45 | 20 | 22 | 0.61 | 2.7 × 10¹¹ | 1.0 |
| Toner 5 | | | | | | | | |

A: Maximum value (%) of light absorbance in wavelength range of 400 nm or more and 800 nm or less in spectrometry of image formed by using toner in loading amount of 0.30 mg/cm²

B: Coefficient of variation in number of inorganic infrared absorbent particles observed in region obtained by dividing circle having center of gravity of cross section image of toner particle as center thereof and having radius of 2.0 μm into four in cross section observation of toner particle

C: Ratio (number %) of toner particles in which inorganic infrared absorbent particles are absent from surface of toner particle to depth of 50 nm from surface of toner particle

D: Maximum value (%) of light absorbance in wavelength range of 900 nm or more and 1800 nm or less in spectrometry of image formed by using toner in loading amount of 0.30 mg/cm²

E: Maximum value (%) of light absorbance in wavelength range of 200 nm or more and 350 nm or less in spectrometry of image formed by using toner in loading amount of 0.30 mg/cm²

F: Number average particle diameter (μm) of dispersion diameter of inorganic infrared absorbent particles

G: Volume resistivity (Ω·cm) of toner

H: Content of inorganic infrared absorbent particles contained in toner (mass % based on mass of toner)

[Evaluation of Toners 19 to 25 and Comparative Toners 4 and 5 According to the Present Invention]

### Evaluation Example 7

The toners 19 to 25 and the comparative toners 4 and 5 were evaluated in the same manner as that of Evaluation Example 1. The evaluation results are shown in Table 8.

### Evaluation Example 8

The toners 19 to 25 and the comparative toners 4 and 5 were evaluated in the same manner as that of Evaluation Example 2. The evaluation results are shown in Table 9.

### Evaluation Example 9

The toners 19 to 25 and the comparative toners 4 and 5 were evaluated in the same manner as that of Evaluation Example 3. As a result, in all of the toners 19 to 25 and the comparative toners 4 and 5, no change in visibility of the image or the like was observed as compared with one month ago.

TABLE 8

| | | Image quality rank (number of thin |
|---|---|---|
| | Observation using loupe | lines) of thin line image |
| Toner 19 | Thin line image cannot be | A (20 lines) |
| | recognized | |
| Toner 20 | Thin line image cannot be | B (18 lines) |
| | recognized | |
| Toner 21 | Thin line image cannot be | A (20 lines) |
| | recognized | |
| Toner 22 | Thin line image cannot be | A (20 lines) |
| | recognized | |
| Toner 23 | Thin line image cannot be | B (19 lines) |
| | recognized | |
| Toner 24 | Thin line image cannot be | B (18 lines) |
| | recognized | |
| Toner 25 | Thin line image cannot be | B (16 lines) |
| | recognized | |
| Comparative | Thin line image cannot be | A (20 lines) |
| Toner 4 | recognized | |
| Comparative | Thin line image cannot be | D (11 lines) |
| Toner 5 | recognized | |

TABLE 9

| | Visual observation | Observation in ultraviolet irradiation |
|---|---|---|
| Toner 19 | Characters cannot be | Characters can be clearly recognized |
| | recognized | |
| Toner 20 | Characters cannot be | Characters can be clearly recognized |
| | recognized | |
| Toner 21 | Characters cannot be | Characters can be clearly recognized |
| | recognized | |
| Toner 22 | Characters cannot be | Characters can be clearly recognized |
| | recognized | |
| Toner 23 | Characters cannot be | Characters can be clearly recognized |
| | recognized | |
| Toner 24 | Characters cannot be | Characters can be clearly recognized |
| | recognized | |
| Toner 25 | Characters cannot be | Characters can be clearly recognized |
| | recognized | |
| Comparative | Characters cannot be | Characters can be clearly recognized |
| Toner 4 | recognized | |
| Comparative | Characters cannot be | Some of characters cannot be |
| Toner 5 | recognized | determined |

### Production Example 4 of Surface-Treated Tin-Doped Indium Oxide Particle

The following materials were stirred at room temperature for 12 hours under a nitrogen atmosphere.

| | |
|---|---|
| ITO ( In:Sn = 9:1. manufactured by C.I. | 10 parts by mass |
| Kasei CO., LTD.) | |
| Silane coupling agent having a structure | 2 parts by mass |
| described as Formula 2-6 (manufactured | |
| by Shin-Etsu Chemical Co., Ltd.) | |
| Styrene monomer | 20 parts by mass |

Next, 0.1 parts by mass of 2,2′-azobis(isobutyronitrile) (manufactured by Tokyo Chemical Industry Co., Ltd.) was added, and stirring was performed at a temperature of 90° C. for 8 hours, thereby obtaining surface-treated tin-doped indium oxide particles.

The obtained sample was dispersed in a styrene monomer using an ultrasonic cleaner (W-133 SAMPA (manufactured by HONDA ELECTRONICS Co., LTD.)), and D50 was measured. As a result, DSO was 303 nm.

A particle diameter (D50) used in the present invention refers to a volume-based median diameter (D50) measured using an UPA-150EX (manufactured by NIKKISO CO., LTD.) under the following conditions.

SetZero: 30 s, the number of measurements: three times, a measurement time: 120 s, a refractive index: 1.85

### Production Examples 5 to 12 of Surface-Treated Tin-Doped Indium Oxide Particles

Differences (changes) between each of Production Examples 5 to 12 and Production Example 4 are shown in Table 10. As shown in Table 10, types of ITO are different in Production Examples 5 and 6, types of the silane coupling agent are different in Production Examples 7 and 8, and amounts of the silane coupling agent are different in Production Examples 9 to 12. A surface-treated infrared absorption pigment having a particle diameter shown in Table 10 was obtained in the same manner as that of Production Example 4 except for the changes shown in Table 10.

TABLE 10

| | | Silane coupling agent | | Primary |
|---|---|---|---|---|
| | Type | | Amount | particle |
| | of | | (parts by | diameter |
| | ITO | Type | mass) | (nm) |
| Production Example 4 of surface-treated tin-doped | 1 | Formula 2-6 | 2.0 | 303 |
| indium oxide particle | | | | |
| Production Example 5 of surface-treated tin-doped | 2 | Formula 2-6 | 2.0 | 312 |
| indium oxide particle | | | | |
| Production Example 6 of surface-treated tin-doped | 3 | Formula 2-6 | 2.0 | 314 |
| indium oxide particle | | | | |
| Production Example 7 of surface-treated tin-doped | 1 | Formula 2-11 | 2.0 | 289 |
| indium oxide particle | | | | |
| Production Example 8 of surface-treated tin-doped | 1 | Formula 2-15 | 2.0 | 289 |
| indium oxide particle | | | | |
| Production Example 9 of surface-treated tin-doped | 1 | Formula 2-6 | 0.1 | 520 |
| indium oxide particle | | | | |
| Production Example 10 of surface-treated tin-doped | 1 | Formula 2-6 | 0.5 | 330 |
| indium oxide particle | | | | |
| Production Example 11 of surface-treated tin-doped | 1 | Formula 2-6 | 1.5 | 307 |
| indium oxide particle | | | | |
| Production Example 12 of surface-treated tin-doped | 1 | Formula 2-6 | 2.0 | 323 |
| indium oxide particle | | | | |

In a column of the type of 1 TO in Table 10, 1 to 3 are the following particles.

1: ITO particle (In:Sn=9:1, manufactured by C.I. Kasei CO., LTD.)
2: ITO particle (In:Sn=8:2, manufactured by C.I. Kasei CO., LTD.)
3: ITO particle (In:Sn=7:3, manufactured by C.I. Kasei CO., LTD.)

### Production Example 13 of Surface-Treated Tin-Doped Indium Oxide Particle

| | |
|---|---|
| Silane coupling agent having a structure | 2 parts by mass |
| described as Formula 2-6 (manufactured | |
| by Shin-Etsu Chemical Co., Ltd.) | |
| Styrene monomer | 20 parts by mass |
| 2,2′-Azobis(isobutyronitrile) | 0.1 parts by mass |

The above materials were stirred in 100 parts by mass of toluene at a temperature of 90° C. for 8 hours under a nitrogen atmosphere, and a copolymer having a structure described as Formula 1-269 was polymerized.

Next, 10 parts by mass of ITO (In:Sn-9:1, manufactured by C.I. Kasei CO., LTD.) was added, stirring was performed at room temperature for 10 hours, and then the toluene was removed by distillation. The obtained sample was dispersed in a styrene monomer using the ultrasonic cleaner (W-133 SAMPA (manufactured by HONDA ELECTRONICS Co., LTD.)), and a particle diameter was measured. As a result, the particle diameter was 527 nm.

### Production Examples 14 to 17 of Surface-Treated Tin-Doped Indium Oxide Particles

Surface-treated tin-doped indium oxide particles having the following particle diameter were obtained in the same manner as that of Production Example 13, except that the amount of the styrene monomer was changed as follows.

TABLE 11

| | Styrene | Primary particle |
|---|---|---|
| | monomer | diameter |
| | (parts by mass) | (nm) |
| Production Example 13 of surface-treated tin-doped indium | 20 | 527 |
| oxide particle | | |
| Production Example 14 of surface-treated tin-doped indium | 100 | 302 |
| oxide particle | | |
| Production Example 15 of surface-treated tin-doped indium | 10 | 403 |
| oxide particle | | |
| Production Example 16 of surface-treated tin-doped indium | 2 | 527 |
| oxide particle | | |
| Production Example 17 of surface-treated tin-doped indium | 4 | 298 |
| oxide particle | | |

### Production Example 18 of Surface-Treated Tin-Doped Indium Oxide Particle

| | |
|---|---|
| ITO (In:Sn = 9:1, manufactured by | 10 parts by mass |
| C.I. Kasei CO., LTD.) | |
| Silane coupling agent having a structure | 2 parts by mass |
| described as Formula 2-6 (manufactured | |
| by Shin-Etsu Chemical Co., Ltd.) | |

The above materials were heated and refluxed in 100 parts by mass of toluene for 10 hours under a nitrogen atmosphere.

The toluene was removed by distillation, the following materials were added, and stirring was performed at a temperature of 90° C. for 8 hours under a nitrogen atmosphere, thereby obtaining surface-treated tin-doped indium oxide particles.

| | |
|---|---|
| Styrene monomer | 20 parts by mass |
| 2,2′-Azobis(isobutyronitrile) | 0.1 parts by mass |

The obtained sample was dispersed in a styrene monomer using the ultrasonic cleaner (W-133 SAMPA (manufactured by HONDA ELECTRONICS Co., LTD.)), and a particle diameter was measured. As a result, the particle diameter was 532 nm.

### Production Examples 19 and 20 of Surface-Treated Infrared Absorbent Particles

Surface-treated infrared absorbent particles having particle diameters shown in Table 12 were obtained in the same manner as that of Production Example 1, except that ITO was changed as shown in Table 12.

TABLE 12

| | | Primary |
|---|---|---|
| | | particle |
| | | diameter |
| | Material | (nm) |
| Production Example 19 of | Antinlony-doped tin oxide | 345 |
| surface-treated infrared | (manufactured by Sigma-Aldrich | |
| absorbent particle | Co. LLC) | |
| Production Example 20 of | Tungsten salt | 352 |
| surface-treated infrared | (FUJI EL MWO₃ 209, | |
| absorbent particle | manufactured by Fuji Pigment | |
| | Co., Ltd.) | |

### Production Example 21 of Surface-Treated Tin-Doped Indium Oxide Particle

| | |
|---|---|
| ITO (In:Sn = 9:1,manufactured by | 10 parts by mass |
| C.I. Kasei CO., LTD.) | |
| Silane coupling agent having a structure | 2 parts by mass |
| described as Formula 2-6 (manufactured | |
| by Shin-Etsu Chemical Co., Ltd.) | |
| Styrene monomer | 20 parts by mass |

The above materials were added to 32 parts by mass of toluene and stirring was performed at room temperature for 12 hours under a nitrogen atmosphere. After the completion of the stirring, 0.1 parts by mass of 2,2′-azobis(isobutyronitrile) was added, and stirring was performed at a temperature of 90′C for 8 hours under a nitrogen atmosphere, thereby obtaining surface-treated tin-doped indium oxide particles. The obtained sample was dispersed in a styrene monomer using the ultrasonic cleaner (W-133 SAMPA (manufactured by HONDA ELECTRONICS Co., LTD.)), and a particle diameter was measured. As a result, the particle diameter of the surface-treated tin-doped indium oxide particle was 362 nm.

### Production Example 22 of Surface-Treated Tin-Doped Indium Oxide Particle

| | |
|---|---|
| ITO (In:Sn = 9:1, manufactured by | 10 parts by mass |
| C.1. Kasei CO., LTD.) | |
| Silane coupling agent having a structure | 2 parts by mass |
| described as Formula 2-6 (manufactured | |
| by Shin-Etsu Chemical Co., Ltd.) | |
| Styrene monomer | 20 parts by mass |

The above materials were added to 6.4 parts by mass of toluene and stirring was performed at room temperature for 12 hours under a nitrogen atmosphere. After the completion of the stirring, 0.1 parts by mass of 2,2′-azobis(isobutyronitrile) (manufactured by Tokyo Chemical Industry Co., Ltd.) was added, and stirring was performed at a temperature of 90° C. for 8 hours under a nitrogen atmosphere, thereby obtaining surface-treated tin-doped indium oxide particles. The obtained sample was dispersed in a styrene monomer using the ultrasonic cleaner (W-133 SAMPA (manufactured by HONDA ELECTRONICS Co., LTD.)), and a particle diameter was measured. As a result, the particle diameter of the surface-treated tin-doped indium oxide particle was 387 nm.

### Production Example 23 of Surface-Treated Tin-Doped Indium Oxide Particle

Sodium dodecylbenzene sulfonate was dissolved in an amount of 1 part by mass in 50 parts by mass of ion exchange water, thereby obtaining a surfactant aqueous solution.

The surface-treated tin-doped indium oxide particles obtained in Production Example 4 were added in an amount of 10 parts by mass to 100 parts by mass of tetrahydrofuran, and a dispersion treatment was performed using the ultrasonic cleaner (W-133 SAMPA (manufactured by HONDA ELECTRONICS Co., LTD.)) for 2 hours. After the dispersion treatment, the surfactant aqueous solution was added dropwise to perform a dispersion treatment again using the ultrasonic cleaner (W-133 SAMPA (manufactured by HONDA ELECTRONICS Co., LTD.)) for 2 hours. Next, the tetrahydrofuran was removed by distillation, thereby obtaining an aqueous dispersion liquid of the surface-treated tin-doped indium oxide particles. A particle diameter of the surface-treated tin-doped indium oxide particle was 302 nm.

[Method of Producing Suspension Polymerization Toner Containing Surface-Treated Infrared Absorbent Particle]

### Example 26

To a 2 L four-neck flask equipped with a high speed stirrer (T.K. Homo Mixer (manufactured by PRIMIX Corporation)), 710 parts by mass of ion exchange water and 450 parts by mass of a 0.1 mol/L trisodium phosphate aqueous solution were added, a rotation speed was adjusted to 12000 rpm, and heating was performed at 60° C. Here, 68 parts by mass of a 1.0 mol/L calcium chloride aqueous solution was gradually added, thereby preparing an aqueous medium containing fine calcium phosphate.

A mixture of 10 parts by mass of the surface-treated tin-doped indium oxide particles produced in Production Example 4 and 120 parts by mass of styrene was dispersed by an attritor (manufactured by Mitsui Mining Company, Limited) for 3 hours, thereby obtaining a pigment dispersion 1.

The following materials were mixed with each other, the mixture was heated at 60° C. and uniformly dissolved and dispersed at 5000 μm using the T.K. Homo Mixer.

| | |
|---|---|
| Pigment dispersion 1 | 130.0 parts by mass |
| Styrene | 46.0 parts by mass |
| n-Butyl acrylate | 34.0 parts by mass |
| Aluminum salicylate compound | 2.0 parts by mass |
| (BONTRON E-88, manufactured by | |
| Orient Chemical Industries Co., Ltd.) | |
| Polar resin | 10.0 parts by mass |
| (Polycondensate of propylene oxide-modified | |
| bisphenol A and isophthaic acid, glass | |
| transition temperature (Tg) = 65° C. weight average | |
| molecular weight (Mw) = 10000. | |
| number average molecular weight (Mn) = 6000) | |
| Ester wax | 25.0 parts by mass |
| (Peak temperature of maximum endothermic | |
| peak in DSC measurement = 70° C. Mn = 704) | |
| Divinylbenzene | 0.10 parts by mass |

2,2′-Azobis(2,4-dimethylvaleronitrile) as a polymerization initiator was dissolved in an amount of 10 parts by mass in the obtained dispersion liquid, thereby preparing a polymerizable monomer composition.

The polymerizable monomer composition was added into the aqueous medium and granulated for 15 minutes while maintaining the rotation speed at 12000 rpm. Thereafter, the high speed stirrer was replaced with a propeller stirring blade, polymerization was continuously performed for 5 hours while maintaining the liquid temperature at 60° C., the liquid temperature was raised to 80° C., and polymerization was continuously performed for 8 hours while maintaining the temperature at 80° C. After the completion of the polymerization reaction, a residual monomer was distilled off at 80° C. under reduced pressure, and then the liquid temperature was cooled to 30° C., thereby obtaining a polymer fine particle dispersion.

Next, the polymer fine particle dispersion was transferred to a cleaning vessel, diluted hydrochloric acid was added to adjust a pH to 1.5 while stirring the polymer fine particle dispersion, and the polymer fine particle dispersion was stirred for 2 hours. Solid-liquid separation was performed with a filter to obtain polymer fine particles. Re-dispersion in water and solid-liquid separation of the polymer fine particles were repeatedly performed until the calcium phosphate compound was sufficiently removed. Thereafter finally, the polymer fine particles subjected to the solid-liquid separation was sufficiently dried with a drier to obtain toner particles.

The following materials were dry-mixed with 100 parts by mass of the obtained toner particles with the FM Mixer (manufactured by Nippon Coke and Engineering Co., Ltd.) for 5 minutes, thereby obtaining a toner 26.

| | |
|---|---|
| Hydrophobic silica fine powder (number | 1.00 part by mass |
| average particle diameter of primary particles: | |
| 7 nm) subjected to a surface treatment | |
| with hexamethyldisilazane | |
| Rutile type titanium oxide fine powder | 0.15 parts by mass |
| (number average particle diameter | |
| of primary particles: 45 nm) | |
| Rutile type titanium oxide fine | 0.50 parts by mass |
| powder (number average particle | |
| diameter of primary particles: 200 nm) | |

### Examples 27 and 28

Toners 27 and 28 were obtained in the same manner as that of Example 26, except that the amounts of the styrene and the surface-treated tin-doped indium oxide particles in the preparation of the pigment dispersion 1 were changed as shown in Table 13.

TABLE 13

| | Amount of surface-treated | |
|---|---|---|
| | tin-doped indium oxide particle | Amount of styrene |
| | (parts by mass) | (parts by mass) |
| Example 26 | 10 | 120 |
| Example 27 | 20 | 110 |
| Example 28 | 30 | 100 |

### Examples 29 to 46

Toners 29 to 46 were produced in the same manner as that of Example 28, except that the surface-treated infrared absorbent particles produced in Production Examples 5 to 22 were used instead of the surface-treated tin-doped indium oxide particles produced in Production Example 4.

[Method of Producing Emulsion Aggregation Toner Containing Surface-Treated Infrared Absorbent Particle]

### Example 47

| | |
|---|---|
| Styrene | 82.6 parts by mass |
| n-Butyl acrylate | 9.2 parts by mass |
| Acrylic acid | 1.3 parts by mass |
| Hexanediol acrylate | 0.4 parts by mass |
| n-Lauryl mercaptan | 3.2 parts by mass |

The above materials were mixed with each other and dissolved to obtain a solution. An aqueous solution having 150 parts by mass of ion exchange water containing 1.5 parts by mass of Neogen RK (manufactured by DKS Co. Ltd.) was added to and dispersed in the obtained solution. Furthermore, an aqueous solution having 10 parts by mass of ion exchange water containing 0.15 parts by mass of potassium persulfate was added while performing stirring slowly for 10 minutes. After nitrogen replacement, emulsion polymerization was performed at 70° C. for 6 hours. After the completion of the polymerization, a reaction liquid was cooled to room temperature and ion exchange water was added, thereby obtaining a resin particle dispersion liquid having a solid content concentration of 12.5 mass % and a volume-based median diameter of 0.2 μm.

| | |
|---|---|
| Ester wax (peak temperature of maximum endothermic | 100 parts by mass |
| peak in DSC measurement 70° C. Mn = 704) | |
| Neogen RK (manufactured by DKS Co. Ltd.) | 15 parts by mass |

The above materials were mixed with 385 parts by mass of ion exchange water, and the mixture was dispersed using a wet type jet mill JN100 (manufactured by JOKOH Co., Ltd.) for about 1 hour, thereby obtaining a wax particle dispersion liquid. A solid content concentration of the wax particle dispersion liquid was 20 mass %.

| | |
|---|---|
| Resin particle dispersion liquid | 160 parts by mass |
| Wax particle dispersion liquid | 10 parts by mass |
| Aqueous dispersion liquid of surface-treated | 10 parts by mass |
| tin-doped indium oxide particles produced | |
| in Production Example 23 | |
| Magnesium sulfate | 0.2 parts by mass |

The above materials were dispersed using a homogenizer (Ultra-Turrax T50, manufactured by IKA-Werke GmbH) and then heated to 65° C. while stirring the materials. The materials were stirred at 65° C. for 1 hour and observed with an optical microscope, and as a result, it was confirmed that aggregate particles having an average particle diameter of about 5.5 μm were formed. Neogen RK (manufactured by DKS Co. Ltd.) was added in an amount of 2.2 parts by mass, the temperature was raised to 80° C., and the mixture was stirred for 120 minutes, thereby obtaining fused spherical toner particles. Cooling and filtering were performed, and a filtered solid was stirred and washed with 720 parts by mass of ion exchange water for 60 minutes. After the washing, the solution was filtered, and similar washing was repeated until electroconductivity of the filtrate was 150 μS/cm or less. Drying was performed using a vacuum drier to obtain toner particles.

1.8 parts by mass of a hydrophobized silica fine powder having a specific surface area of 200 m²/g measured by a BET method was dry-mixed with 100 parts by mass of the obtained toner particles using the FM Mixer (manufactured by Nippon Coke and Engineering Co., Ltd.), thereby obtaining a toner 47.

[Evaluation of Image Sample Using Toner]

Solid images were printed using the above-described toners 26 to 47, and image characteristics described below were compared with each other and evaluated. When comparing the image characteristics, a modified machine of LBP-5300 (manufactured by Canon Inc.) was used as an image forming apparatus. As for the modification contents, a developing blade in a process cartridge was replaced with an SUS blade having a thickness of 8 μm. In addition, a blade bias of −200 [V] was designed to be applied with respect to a development bias applied to a development roller which was used as a toner carrier.

In addition, the obtained invisible image was irradiated with a halogen light source (PCS-UHX 150 W. halogen light source apparatus, manufactured by NIPPON P⋅I CO., LTD.) installed at a position distant from the invisible image by 100 cm at an angle of 15° and provided with a visible light cut filter unit.

In this state, an image formation surface was read by a camera having light receiving sensitivity at a wavelength of 1500 nm (NVU3VD, manufactured by IRspec Corporation) installed at a position corresponding to approximately 15 cm directly above the image formation surface. A lens part of the camera was equipped with a filter that cuts a wavelength component of 800 nm or less.

[Evaluation of Optical Density of Toner]

An optical density (OD (M)) of the read image was measured with a reflective densitometer (SpectroLino, manufactured by Gretag Macbeth GmbH). The obtained optical densities are shown in Table 14.

TABLE 14

| | Toner | Optical density |
|---|---|---|
| Example 26 | Toner 26 | 0.65 |
| Example 27 | Toner 27 | 1.23 |
| Example 28 | Toner 28 | 1.81 |
| Example 29 | Toner 29 | 1.79 |
| Example 30 | Toner 30 | 1.75 |
| Example 31 | Toner 31 | 1.8 |
| Example 32 | Toner 32 | 1.83 |
| Example 33 | Toner 33 | 0.93 |
| Example 34 | Toner 34 | 1.64 |
| Example 35 | Toner 35 | 1.82 |
| Example 36 | Toner 36 | 1.86 |
| Example 37 | Toner 37 | 1.21 |
| Example 38 | Toner 38 | 1.75 |
| Example 39 | Toner 39 | 1.52. |
| Example 40 | Toner 40 | 1.25 |
| Example 41 | Toner 41 | 1.82 |
| Example 42 | Toner 42 | 1.26 |
| Example 43 | Toner 43 | 1.75 |
| Example 44 | Toner 44 | 1.77 |
| Example 45 | Toner 45 | 1.65 |
| Example 46 | Toner 46 | 1.78 |
| Example 47 | Toner 47 | 1.83 |

The present invention is not limited to the embodiments, and various alterations and modifications may be made without departing from the spirit and the scope of the present invention. Accordingly, the following claims are attached to publicize the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A toner comprising a toner particle containing a binder resin and an inorganic infrared absorbent particle,
wherein (1) in spectrometry of a fixed image obtained by fixing an unfixed image formed on a recording material by using the toner in a loading amount of 0.30 mg/cm², a maximum value of a light absorbance in a wavelength range of 400 nm or more and 800 nm or less is 10% or less, and
(2) in cross section observation of the toner particle using a transmission electron microscope, when a circle having the center of gravity of a cross section image of the toner particle as the center thereof and having a radius of 2.0 μm is drawn and the circle is divided into four to form four quadrants, a coefficient of variation in number of the inorganic infrared absorbent particles observed in each quadrant is 0.50 or less.

2. The toner according to claim 1, wherein the inorganic infrared absorbent particle is one or more particles selected from the group consisting of an indium-based oxide particle, a tin-based oxide particle, and a tungsten-based oxide particle.

3. The toner according to claim 1, wherein the inorganic infrared absorbent particle is one or more particles selected from the group consisting of a tin-doped indium oxide particle, an antimony-doped tin oxide particle, and a cesium-doped tungsten oxide particle.

4. The toner according to claim 1, wherein in the cross section observation of the toner particle using the transmission electron microscope, the toner particles in which the inorganic infrared absorbent particles are absent in a region from a surface of the toner particle to a depth of 50 nm from the surface of the toner particle are 60 number % or more of all the toner particles.

5. The toner according to claim 1, wherein in the spectrometry of the fixed image obtained by fixing the unfixed image formed on the recording material by using the toner in the loading amount of 0.30 mg/cm², a maximum value of a light absorbance in a wavelength range of 900 nm or more and 1800 nm or less is 25% or more.

6. The toner according to claim 1, wherein in the spectrometry of the fixed image obtained by fixing the unfixed image formed on the recording material by using the toner in the loading amount of 0.30 mg/cm², a maximum value of a light absorbance in a wavelength range of 200 nm or more and 350 nm or less is 25% or more.

7. The toner according to claim 1, wherein a number average particle diameter (D1) of a dispersion diameter of the inorganic infrared absorbent particles measured in the cross section observation of the toner particle using the transmission electron microscope is 0.5 μm or less.

8. The toner according to claim 1, wherein a volume resistivity of the toner is 1.0′×10¹² Ω·cm or more and 1.0×10¹⁷ Ω·cm or less.

9. The toner according to claim 1, wherein a content of the inorganic infrared absorbent particle contained in the toner is 0.3 mass % or more and 1.0 mass % or less based on a mass of the toner.

10. A method of producing a surface-treated infrared absorbent particle, the method comprising at least:
a step of obtaining an infrared absorbent particle having a vinyl group by a coupling reaction of a compound having a structure represented by the following Formula 6 with at least one inorganic infrared absorbent particle selected from the group consisting of an indium-doped tin oxide particle, an antimony-doped tin oxide particle, a cesium-doped tungsten oxide particle, and a tungsten oxide salt particle;
a step of mixing the infrared absorbent particle having the vinyl group with a styrene monomer or a monomer having a structure represented by the following Formula 7 to obtain a mixture; and
a step of polymerizing the infrared absorbent particle having the vinyl group and the styrene monomer or the monomer having the structure represented by the following Formula 7 that are contained in the mixture, 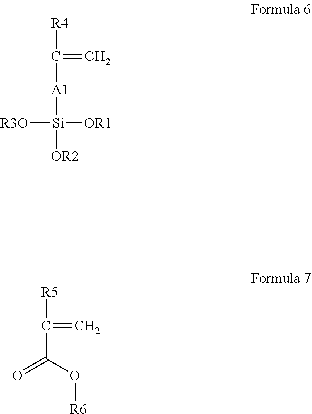
(In Formulas 6 and 7,
R1 to R3 each independently represent a hydrogen atom or an aliphatic straight chain hydrocarbon having 1 to 4 carbon atoms,
R4 and R5 each independently represent a hydrogen atom or a methyl group,
R6 represents an aliphatic straight chain hydrocarbon group having 1 to 4 carbon atoms, and
A1 represents a structure of the following Formula 4 or 5, 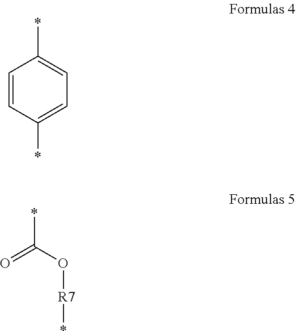
in Formulas 4 and 5,
R7 represents an aliphatic straight chain hydrocarbon group having 1 to 4 carbon atoms, and
* represents a binding site).

11. The method of producing a surface-treated infrared absorbent particle according to claim 10, wherein the polymerization step is bulk polymerization.

12. A toner comprising a toner particle containing a binder resin and a surface-treated infrared absorbent particle,
wherein the surface-treated infrared absorbent particle is a particle obtained by treating a surface of an inorganic infrared absorbent particle with a surface treatment agent, the inorganic infrared absorbent particle is a particle selected from the group consisting of an indium-doped tin oxide particle, an antimony-doped tin oxide particle, a cesium-doped tungsten oxide particle, and a tungsten oxide salt particle, and
the surface treatment agent is a copolymer having a repeating structural unit represented by the following Formula 1 and a repeating structural unit represented by the following Formula 2 or a repeating structural unit represented by the following Formula 3, 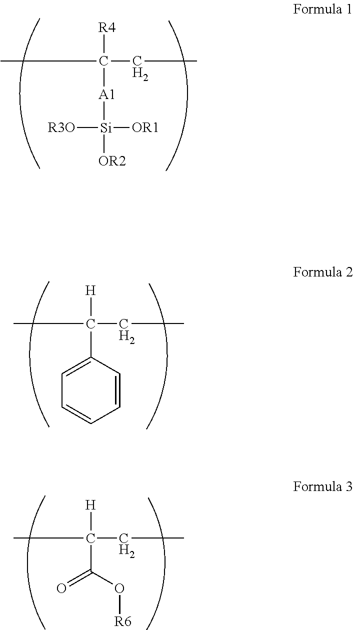
(in Formulas 1 and 3,
R1 to R3 each independently represent a hydrogen atom or an aliphatic straight chain hydrocarbon having 1 to 4 carbon atoms,
R4 and R5 each independently represent a hydrogen atom or a methyl group,
R6 represents an aliphatic straight chain hydrocarbon group having 1 to 4 carbon atoms, and
A1 represents a structure of the following Formula 4 or 5, 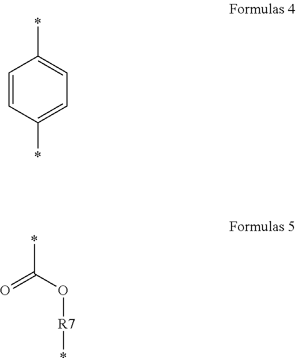
in Formulas 4 and 5,
R7 represents an aliphatic straight chain hydrocarbon group having 1 to 4 carbon atoms, and
* represents a binding site).
